(19) United States
(12) Patent Application Publication
(10) Pub. No.: US 2007/0154906 A1
(43) Pub. Date: Jul. 5, 2007

(54) Methods to identify therapeutic candidates

(75) Inventors: Christopher John Martin, London (GB); Philip Wilson Howard, London (GB); David Edwin Thurston, London (GB); John Anthony Hartley, London (GB); Francesca Elizabeth Crawford, London (GB)

Correspondence Address: MORRISON & FOERSTER LLP, 12531 HIGH BLUFF DRIVE, SUITE 100, SAN DIEGO, CA, 92130-2040, US

(73) Assignee: Spirogen Ltd., Ryde (GB)

(21) Appl. No.: 11/544,191

(22) Filed: Oct. 5, 2006

Related U.S. Application Data
(60) Provisional application No. 60/723,681, filed on Oct. 5, 2005.

(51) Int. Cl. C40B 30/02; C40B 40/04; C40B 40/08

(52) U.S. Cl. 435/6; 435/7.1

(57) ABSTRACT

The invention provides systematic methods for identification of candidate compounds useful in treatment of conditions initiated or modulated by genetic expression. The methods of the invention permit efficient identification of candidates suitable for verification testing by in vitro and/or in vivo models.

### CROSS-REFERENCE TO RELATED APPLICATION

This application claims the benefit of priority under 35 U.S.C. § 119(e) of U.S. Provisional Application No. 60/723,681, filed Oct. 5, 2006. The aforementioned application is explicitly incorporated herein by reference in its entirety and for all purposes.

### TECHNICAL FIELD

The invention relates to the fields of medicine, drug discovery and molecular biology. The invention provides systematic methods for identification of compounds that are viable therapeutic candidates for treating conditions that are a result of, or that are abetted by the expression of a target gene. The systems of the invention create a reproducible paradigm for obtaining successful candidate therapeutics.

### BACKGROUND

The search for successful drug candidates takes many forms. In one approach, enzymatic activities that abet diseases or symptoms, such as, for example, cyclooxygenases for their role in pain, are targeted by designing compounds similar to those known to react with these targets. Alternatively, by studying the three-dimensional conformation of the target, such as a protein, molecules that fit into critical portions of the protein are designed. Combinatorial libraries based on target structure are constructed and screened against the protein targets. In general, these drug discovery activities are conducted in a random manner, with only one or two prescribed steps prior to subjecting lead candidates to appropriate in vitro, in vivo, and other late-stage development for a desired compound.

### DISCLOSURE OF THE INVENTION

The present invention provides methods that are systematic approaches for obtaining compounds that can interfere with or block transcription of a gene of interest. In one aspect, the invention provides methods that are systematic approaches to identify therapeutic compounds. In one aspect, the invention provides methods that are systematic approaches to identify drug candidates that are sufficiently promising to warrant subjecting them to traditional in vitro, in vivo, and toxicity studies. Thus, in one aspect, the present invention provides a systematic alternative to random screening methodologies such as use of combinatorial libraries against protein targets.

In one aspect, the methods comprise systematic approaches for identifying compounds that can be a candidate therapeutic, or drug, that interfere with transcription, including complete or partial inhibition. In one aspect, the system identifies compounds that interfere with transcription of a gene that generates products deleterious to the subject. The methods of the invention provide alterative approaches to assure identification of useful candidates; and in one aspect, the alterative approaches provide identification sequences based on interaction with a target gene or other sequence of interest. Each of these sequences, alone or in combination, is an aspect of the present invention. Each sequence is an alternative method to identify a compound that is a candidate therapeutic for treating a condition regulated by a gene or other sequence of interest.

The first aspect, or sequence, of the invention comprises the steps of providing a library of compounds designed to interact with a portion of a transcriptional regulatory region, e.g., a promoter or enhancer nucleotide sequence, of a gene (or other sequence of interest) to be targeted, screening the library for members that interact with the nucleotide sequence to obtain a first subset of interacting compounds.

In an alternative aspect, the first subset compound(s) are assessed for cytotoxicity or its ability to modify the physiology of the cell, e.g., make the cell more sensitive to a compound, drug or environmental condition, e.g., make the cell temperature sensitive or convert the cell into an auxotroph, and discarding members that are not cytotoxic to obtain a second subset.

The selected compounds (member(s) of a first or a second subset, if a cytotoxicity step is included) are then assessed for their ability to bind to the nucleotide sequence of the transcriptional regulatory sequence, e.g., promoter, with sufficient affinity to obtain a second (or third, if a cytotoxicity step is included) subset, and assessing each member of the second (or third) subset for its ability to inhibit transcription to obtain a candidate therapeutic.

Another aspect, or sequence, of the invention comprises the steps of providing a library of compounds designed to interact with a portion of the transcriptional regulatory region, e.g., promoter or enhancer nucleotide sequence, of the gene to be targeted, screening the library for members that interact with the nucleotide sequence to obtain a first subset of interacting compounds.

In an alternative aspect, the first subset compound(s) are assessed for cytotoxicity or their ability to modify the physiology of the cell, e.g., make the cell more sensitive to a compound, drug or environmental condition, e.g., make the cell temperature sensitive or convert the cell into an auxotroph.

The members of the first subset (or second subset, if a cytotoxicity step is included) are the assessed for their ability to bind to the nucleotide sequence of the transcriptional regulatory sequence, e.g., promoter, with sufficient affinity to obtain a second subset (or third subset, if a cytotoxicity step is included), and assessing each member of the second (or third) subset for their ability to inhibit transcription to obtain a candidate therapeutic.

Another aspect, or sequence, of the invention also targets a transcriptional regulatory region, e.g., a promoter or enhancer, but rather than providing a library of compounds, a single compound is designed. In the next step (after design of the compound), the ability of the compound to cross-link the nucleotide sequences of a transcriptional regulatory region, e.g., a promoter or enhancer, is confirmed in a series of alternative tests, which can be increasingly rigorous tests. A compound successfully passing these tests is thus identified as a viable candidate. If a compound is unsuccessful in these tests, the sequence may be repeated with another compound. Alternatively, in one aspect if the compound is not a cross-linking agent, it is nevertheless tested for its ability to inhibit transcription using a footprinting assay and is subjected to the series of analysis steps applied to the library of compounds.

In an alternative aspect, the cytotoxicity of the designed compound is tested (cytotoxicity including the compound's ability to modify the physiology of the cell, e.g., make the cell more sensitive to a compound, drug or environmental condition, e.g., make the cell temperature sensitive or convert the cell into an auxotroph). The cytotoxicity can be alternatively tested before or after, or before and after, the cross-linking test, and/or before or after, or before and after, the footprinting assay.

Another aspect, or sequence, of the invention comprises the steps of providing a designed library of compounds for interaction with the coding nucleotide sequence of the target gene. The library is first screened to obtain a first subset of compounds verified to bind to the nucleotide sequence. The compound(s) are then tested for their ability to bind with sufficient affinity to the nucleotide sequence using a specified criterion, e.g., oligonucleotide retention assays. This results in a second subset of members that bind sufficiently, which are then tested for their ability to interfere with or block transcription to obtain a third subset from which a single compound is selected as a viable candidate.

In an alternative aspect, the cytotoxicity of the designed compound is tested (cytotoxicity including the compound's ability to modify the physiology of the cell, e.g., make the cell more sensitive to a compound, drug or environmental condition, e.g., make the cell temperature sensitive or convert the cell into an auxotroph). The cytotoxicity can be alternatively tested before or after, or before and after, testing for interaction with the coding nucleotide sequence of the target gene; and/or before or after, or before and after, testing for the compounds' ability to bind with sufficient affinity to the nucleotide sequence; and/or before or after, or before and after, testing for compounds' ability to interfere with or block transcription.

Another aspect, or sequence, of the invention comprises targeting the nucleotide sequence in the coding region as well, but begins with a single designed compound. The compound is tested for its ability to interact with the coding region in the nucleotide sequence. If the compound passes this test, it is assessed for its ability to interfere with or block or significantly modify (e.g., inhibit) transcription and, if successful, the selectivity of the compound for binding to a nucleotide sequence in the coding region is confirmed. This results in a successful candidate. Should the compound fail at any of these steps, a different compound is selected and the sequence of tests is repeated until a suitable compound is obtained.

In an alternative aspect, the compound is then tested for cytotoxicity or its ability to modify the physiology of the cell, e.g., make the cell more sensitive to a compound, drug or environmental condition, e.g., make the cell temperature sensitive or convert the cell into an auxotroph. The cytotoxicity can be alternatively tested before or after, or before and after, testing for ability to interfere with or block or significantly modify (e.g., inhibit) transcription; and/or before or after, or before and after, testing for the selectivity of the compound for binding to a nucleotide sequence in the coding region.

Regardless of the sequence of steps followed to provide a successful candidate, the successful candidate may be subjected to typical in vitro and in vivo models of the condition to be treated and its maximum tolerated dose obtained.

The invention provides methods to identify a compound as a therapeutic compound for treating a condition regulated or modulated by a target nucleic acid, e.g., a gene, including coding or non-coding sequence, which method comprises the steps of providing a library of compounds designed to interact with a portion of a transcriptional regulatory nucleotide sequence of the gene; screening the library for members that interact with the transcriptional regulatory nucleotide sequence to obtain a first subset of sequence-interacting compounds; assessing the ability of each member of the first subset to bind to the transcriptional regulatory nucleotide sequence with sufficient affinity, where the members that bind with sufficient affinity comprise a second subset; and assessing each member of the second subset for ability to interfere with or block transcription of the gene to identify a candidate therapeutic that interferes with transcription of the gene, whereby a member is identified as a candidate therapeutic by its ability to interfere with transcription of the gene. In one aspect, the target nucleic acid can also include an episomal nucleic acid, infectious agent nucleic acid, or a nucleic acid stably integrated into a chromosome, e.g., a retrovirus, such as an HIV. In one aspect, a compound is therapeutic for treating a condition regulated or modulated by a target nucleic acid if the compound ameliorates in any way the disease or condition, including abrogating, delaying the onset or decreasing symptoms or the severity of a disease or condition.

In one aspect, the methods of the invention further comprise assessing the cytotoxicity of a compound selected during any step or steps of the method, including assessing the cytotoxicity of each member of a selected subset (e.g., a first subset or a second subset). In one aspect, the methods of the invention further comprise assessing the cytotoxicity of a member is determined by a method comprising an in vitro assay, e.g., using a cancer cell line, or using an in vivo assay. In one aspect, the methods of the invention further comprise confirming identification of the member as a candidate compound using an in vitro model, an ex vivo model, an in vivo model, or an in vitro model and an in vivo model, or any combination thereof. In any aspect of the invention, assessing the cytotoxicity can comprise assessing its ability to modify the physiology of the cell, e.g., make the cell more sensitive to a compound, drug or environmental condition, e.g., make the cell temperature sensitive or convert the cell into an auxotroph

In one aspect, designing the library of compounds comprises employing heuristics, molecular modeling, virtual (in silico) screening or a combination thereof. The in silico or virtual screening can comprises using docking libraries of purchasable compounds into a rigid DNA “receptor” employing pharmacophore screening based on known ligands and interaction cites in the minor groove, de novo design by growing molecules from small fragments based on a DNA minor groove, (c) “MM-PBSA,” or, Molecular Mechanics Poisson-Boltzmann/surface area) approach, or any combination thereof.

In one aspect, the transcriptional regulatory sequence of the gene comprises a promoter or an enhancer nucleotide sequence of the target sequence, e.g., a gene.

In one aspect, the screening the library for (compound) members that interact with a transcriptional regulatory nucleotide sequence is performed using an intercalator displacement exclusion assay. In one aspect, assessing the ability of a compound (e.g., each member of a second subset) to bind to the transcriptional regulatory nucleotide sequence with sufficient affinity is performed by any appropriate method, e.g., a method comprising footprinting and/or automated analysis. Sufficient affinity is determined by the particular assay (it may vary depending on which assay and conditions are used), e.g., what one skilled in the art would consider sufficient binding in a footprinting analysis, which is well known in the art.

In one aspect, a compound (e.g., each member of a subset, e.g., a second subset) can be assessed by a method comprising a gel shift assay. The method can further comprise a selectivity assay.

The methods of the invention can further comprise reiterating any particular step, or set of steps. For example, in one aspect, the methods further comprise reiterating a process of the invention by returning to an initial step (e.g., a “step a)” or an intermediate step, and then preceding to subsequent steps in the event of failure of activity, or lack of sufficient or desired activity, or confirmation of observed activity, of a compound in any step in the process (e.g., in any of “steps b) to c)”, or “steps b) to d)”, and the like).

The invention provides methods to identify a compound as a candidate therapeutic for treatment of a condition modulated by a target gene, which method comprises the steps of: providing a library of compounds designed to bind to a nucleotide sequence in the coding region of said gene; screening the library to obtain a first subset of compounds verified to bind to said nucleotide sequence; assessing the ability of each member of said second subset to bind with sufficient affinity to said nucleotide sequence to obtain a third subset; assessing the members of the third subset for their ability to interfere with or block transcription sufficiently; to obtain to obtain a fourth subset; and assessing the specificity of each member of said fourth subset to select a candidate therapeutic that is selective.

In one aspect, the method further comprises assessing the cytotoxicity of said library to obtain compounds (e.g., members of a subset) that are cytotoxic. The cytotoxicity can determined by an in vitro assay on a cancer cell line. Cytotoxicity can be determined at any step in the process, e.g., after determining that a compound binds to a nucleotide target sequence (e.g., a coding region or transcriptional regulatory motif in a gene), after assessing that the compound binds with sufficient affinity, after assessing that the compound can interfere with or block transcription sufficiently, and/or after assessing that the compound is selective for a nucleotide target sequence (e.g., a coding region or transcriptional regulatory motif in a gene). The method can further comprise confirming acceptability of the candidate compound using in vitro and in vivo models.

In one aspect, the method further comprises employing a combination of heuristics, molecular modeling, and/or virtual screening to design a library.

In one aspect, the step of screening the library for members that interact with a transcriptional regulatory nucleotide sequence (e.g., in “step b)”) comprises using an intercalator displacement exclusion assay. In one aspect, the step of assessing the ability of each member of a subset (e.g., a first subset) to bind to the transcriptional regulatory nucleotide sequence with sufficient affinity, and/or the step of assessing each member of a subset (e.g., a second subset) for its ability to interfere with or block transcription of the gene (e.g., “step c) or step d)”) is performed by footprinting and/or automated analysis.

In one aspect, the method further comprises reiterating the method by returning to an initial step (e.g., “step a)”) or an intermediate step, and preceding to subsequent steps in the event of failure of activity, or lack of sufficient or desired activity, or just to confirm an observed activity, of a compound in any step in the process (e.g., in any of “steps b) to d)”, or “steps b) to e)”, and the like).

The invention provides methods to identify a compound that is a candidate therapeutic for treating a condition regulated by a gene, which method comprises the steps of: providing a compound designed to bind to a nucleotide sequence in the promoter region of said target gene; and confirming the ability of said compound to effect crosslinking of said promoter, whereby said candidate therapeutic is identified.

In one aspect, the method further comprises confirming the cytotoxicity of the compound, as discussed above. The cytotoxicity can be determined by an in vitro assay, e.g., on a cancer cell line, or an in vivo assay.

In one aspect, the method further comprises confirming acceptability of the candidate compound using in vitro, ex vivo and/or in vivo models. In one aspect, the method further comprises employing a combination of heuristics, molecular modeling, and/or virtual screening, or any combination thereof, to design a library of compounds.

As noted above, the methods of the invention can comprise reiterating any particular step, or set of steps. For example, in one aspect, the methods can comprise reiterating a step or set of steps by returning to an initial step (e.g., a “step a)” or an intermediate step, and then preceding to subsequent steps in the event of failure of activity, or lack of sufficient or desired activity, or confirmation of observed activity, of a compound in any step in the process (e.g., in any of “steps b) to c)”, or “steps b) to d)”, and the like).

The invention provides methods to identify a candidate compound as a therapeutic for treatment of a condition modulated by a target sequence, e.g., a gene, which method comprises the steps of: providing a compound designed to interact with a portion of the coding nucleotide sequence of said target sequence (e.g., gene), verifying the ability of the compound to interact with the nucleotide sequence that encodes the target sequence (e.g., gene); verifying the ability of the compound to interfere with or block or diminish transcription; and verifying selectivity of the compound as binding to the nucleotide sequence of the coding region.

As discussed, above, the method can further comprise verifying that the compound is cytotoxic. The cytotoxicity can determined by an in vitro assay, e.g., on a cancer cell line, or an in vivo assay.

Also as discussed above, in one aspect the method further comprises reiterating the method by returning to an initial step (e.g., “step a)”) or an intermediate step, and preceding to subsequent steps in the event of failure of activity, or lack of sufficient or desired activity, or just to confirm an observed activity, of a compound in any step in the process (e.g., in any of “steps b) to d)”, or “steps b) to e)”, and the like). The methods can further comprise confirming acceptability of the candidate compound using in vitro and/or in vivo models. The methods can further comprise employing a combination of heuristics, molecular modeling, and virtual screening to design a library of compounds.

The invention provides methods to identify a candidate compound as a therapeutic for treatment of a condition modulated by a target gene, which method comprises steps as set forth in FIG. 1 (showing four exemplary schemes), FIG. 2 or FIG. 11 (showing several exemplary schemes), or any combination thereof (either within a Figure, or between Figures).

In alternative aspects, methods of the invention can comprise identifying a compound therapeutic: for breast cancer, wherein optionally the target gene comprises BRCA and/or Her-2/neu; for Burkitt's Lymphoma, wherein optionally the target gene comprises Myc; for prostate cancer, wherein optionally the target gene comprises c-Myc; for colon cancer, wherein optionally the target gene comprises MSH; for lung cancer, wherein optionally the target gene comprises EGFR (ErbB-1), Her 2/neu (ErbB-2), Her 3 (ErbB-3) and/or Her 4 (ErbB-4); for Chronic Myeloid Leukemia (CML), wherein optionally the target gene comprises BCR-ABL; and/or, for malignant melanoma, wherein optionally the target gene comprises CDKN2 and/or BCL-2. In one aspect, methods of the invention can comprise identifying a compound therapeutic wherein the target gene comprises PKA, VEGFR, VEGFR2, PDGF and/or PGGFR.

In one aspect, the method comprises identifying a compound therapeutic for a disease or condition mediated by cellular proliferation, such as inflammation; or alternatively, for a disease or condition mediated or caused by inflammation, wherein a result or side effect of the inflammation is cellular proliferation. In one aspect, the disease or condition mediated by the inflammation and/or cellular proliferation comprises atherosclerosis. In one aspect, the disease or condition mediated by the inflammation and/or cellular proliferation comprises neovascularization or angiogenesis, or the migration, differentiation or structural organization of blood vessels. In one aspect, the disease or condition mediated by the inflammation and/or cellular proliferation comprises hemangiomas, solid tumors, leukemia, metastasis, telangiectasia psoriasis scleroderma, pyogenic granuloma, myocardial angiogenesis, plaque neovascularization, coronary collaterals, ischemic limb angiogenesis, corneal diseases, rubeosis, neovascular glaucoma, diabetic retinopathy, retrolental fibroplasia, arthritis, diabetic neovascularization, macular degeneration, wound healing, peptic ulcer, fractures, keloids, vasculogenesis, hematopoiesis, ovulation, menstruation or placentation.

In one aspect, the method comprises identifying a compound therapeutic for a disease or condition caused or initiated by an infectious disease, or for a disease or condition caused or exacerbated by a microorganism. In one aspect, the method comprises identifying a compound for treating, preventing or ameliorating the effects of an infectious disease or for a disease or condition caused or exacerbated by a microorganism. In one aspect, the method comprises identifying a compound therapeutic for an acute or chronic infectious disease, or identifying an anti-bacterial, anti-fungal, anti-protozoan, anti-yeast or an anti-viral agent.

The invention provides methods for identifying a compound, e.g., a small molecule compound, to up-regulate or down-regulate a target gene (on a transcriptional and/or translational level) for a therapeutic effect, the method comprising the steps of: (a) selecting a target gene to be up-regulated or down-regulated for a therapeutic effect, and identifying a primary target sequence and a secondary target sequence, wherein the primary target sequence and/or secondary target sequence comprises (i) a transcriptional regulatory nucleotide sequence of the gene, or (ii) a protein-coding sequence of the gene; (b) providing a library of compounds, e.g., small molecule compounds, proteins, etc; (c) screening the library for members that interact with the primary target sequence by measuring up-regulation or down-regulation of a transcript (message, mRNA) of the gene by quantitative PCR (QPCR) to obtain a first subset of sequence-interacting compounds, e.g., small molecule compounds; (d) assessing the cytotoxic effect of the up-regulation or down-regulation of the transcript on a cell expressing the gene by members of the first subset of sequence-interacting compounds, e.g., small molecule compounds, identified in (c) to identify a second subset of sequence-interacting compounds, e.g., small molecule compounds; and (e) screening the second subset of sequence-interacting compounds, e.g., small molecule compounds, identified in (d) to identify a third subset of sequence-interacting compounds, e.g., small molecule compounds, that up-regulates or down-regulates the transcript (message, mRNA) of the gene, wherein the up-regulation or down-regulation of the transcript is determined by quantitative polymerase chain reaction (PCR) (QPCR) targeting the secondary target sequence.

In one aspect, the methods of the invention further comprise screening for members of the third subset of sequence-interacting compounds, e.g., small molecule compounds, that bind to the transcriptional regulatory nucleotide sequence of the gene or the protein-coding sequence of the gene to identify a fourth subset of sequence-interacting compounds, e.g., small molecule compounds, wherein the binding is determined by a footprinting (DNase protection) assay, a gel shift assay or a combination thereof. In one aspect, the method further comprises screening for members of the fourth subset of sequence-interacting compounds, e.g., small molecule compounds, by determining the level of expression of a protein encoded by the gene. The binding can be determined by an antibody-based assay, such as an ELISA, an immunoblot, an immunoprecipitation or a Western blotting assay, and the like.

In one aspect, in the step of providing a library of compounds, a library of compounds, e.g., small molecule compounds, is designed to interact with the transcriptional regulatory nucleotide sequence and/or the protein-coding sequence of the gene. The designing of the library of compounds can comprise employing heuristics, molecular modeling, virtual (in silico) screening or a combination thereof.

In one aspect, the primary target sequence and/or secondary target sequence is between about 6 to 16 contiguous base pairs of the gene, or is about 5, 6, 7, 8, 9, 10, 11, 12, 13, 14, 15, 16, 17, 18, 19, or 20 or more contiguous base pairs of the gene.

The invention provides methods for identifying compounds, e.g., small molecule compounds, to up-regulate or down-regulate a target gene (e.g., its translational and/or transcriptional products) for a therapeutic effect, the method comprising the steps of: (a) selecting a target gene to be up-regulated or down-regulated for a therapeutic effect, and identifying at least one target sequence in the gene; (b) providing a library of compounds, e.g., small molecule compounds; (c) screening the library for members that interact with the at least one target sequence to obtain a first subset of gene sequence-interacting compounds, e.g., small molecule compounds; (d) assessing the cytotoxic effect on a cell expressing the gene by members of the first subset of gene sequence-interacting compounds, e.g., small molecule compounds, identified in (c) to identify a second subset of gene sequence-interacting compounds, e.g., small molecule compounds; and (e) screening the second subset of gene sequence-interacting compounds, e.g., small molecule compounds, identified in (d) to identify a third subset of gene sequence-interacting compounds, e.g., small molecule compounds, that interact with at least one target sequence in the gene using a footprinting assay, a gel shift assay, a ChiP (Chromatin Immunoprecipitation) assay, or any combination thereof. In one aspect, the screening of step (c) is performed using an intercalator displacement/exclusion assay. In one aspect, the screening of step (e) comprises a footprinting assay to identify the third subset of sequence-interacting small molecule compounds, followed by a gel shift assay to identify a fourth subset of sequence-interacting small molecule compounds. In one aspect, in step (b) the library of small molecule compounds is designed to interact with a transcriptional regulatory nucleotide sequence and/or a protein-coding sequence of the gene, e.g., the designing the library of compounds of step (b) can comprise employing heuristics, molecular modeling, virtual (in silico) screening or a combination thereof.

The method can further comprise screening the fourth subset of sequence-interacting compounds, e.g., small molecule compounds, using a ChiP (Chromatin Immunoprecipitation) assay to identify a fifth subset of sequence-interacting small molecule compounds.

The method can further comprise using an in vitro transcription assay to identify a further subset of gene sequence-interacting compounds, e.g., small molecule compounds, wherein an increase or a decrease in the levels of transcript (message, mRNA) encoded by the gene confirms a member of the library to be a gene sequence-interacting compounds, e.g., small molecule compounds. In one aspect, the in vitro transcription assay assesses a subset of gene sequence-interacting compounds, e.g., small molecule compounds, identified by a footprinting assay.

The method can further comprise using a quantitative polymerase chain reaction (PCR) (QPCR) after the in vitro transcription assay to identify a further subset of gene sequence-interacting small molecule compounds, wherein an increase or a decrease in the levels of transcript (message, mRNA) encoded by the gene confirms a member of the library to be a gene sequence-interacting small molecule compound.

The method can further comprise using a reporter assay to identify a further subset of gene sequence-interacting small molecule compounds.

In one aspect, the at least one target sequence is between about 6 to 16, or between about 6 to 18, contiguous base pairs of the gene, or is about 5, 6, 7, 8, 9, 10, 11, 12, 13, 14, 15, 16, 17, 18, 19, or 20 or more contiguous base pairs of the gene.

In alternative aspects of any of the methods of the invention, the at least one target sequence comprises (i) a transcriptional regulatory nucleotide sequence of the gene; (ii) a protein-coding sequence of the gene; or (iii) a combination thereof.

The invention provides methods for identify a compound to up-regulate or down-regulate a target gene for a therapeutic effect (including a prophylactic or palliative effect), which method comprises steps as set forth in FIG. 1 (showing four exemplary schemes), FIG. 2 or FIG. 11 (showing several exemplary schemes), or any of the methods of the invention, or any combination or subset thereof. In alternative aspects of any of the methods of the invention, the compound comprises a small molecule compound, a protein or an oligonucleotide, such as a single or double stranded oligonucleotide, or at least one synthetic nucleotide.

While each of the sequence of steps may be performed independently, it is also an aspect of the invention to perform such sequences concomitantly to assure maximum probability of obtaining a successful result. The details of one or more embodiments of the invention are set forth in the accompanying drawings and the description below. Other features, objects, and advantages of the invention will be apparent from the description and drawings, and from the claims.

All publications, patents and patent applications cited herein are hereby expressly incorporated by reference for all purposes.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow diagram showing exemplary sequential pathways of the invention for identification and their interrelationship. The squares indicate procedural steps and the diamonds indicate decision or design points.

FIG. 2 is a flow diagram showing an exemplary method of the invention. The squares indicate procedural steps and the diamonds indicate decision or design points.

FIG. 3 is an illustration of the results of a DNase I footprinting gel used in an exemplary method of the invention, as described in detail in Example 2, below.

FIG. 4 is an illustration of the results of a DNase I footprinting gels of an exemplary compound used in an exemplary method of the invention, a conjugate with high TM values, as described in detail in Example 2, below.

FIG. 5 is an illustration of the results of a DNAase footprinting used in an exemplary method of the invention, as described in detail in Example 2, below.

FIG. 6 is an illustration of the results of DNAase footprinting used in an exemplary method of the invention, as described in detail in Example 2, below.

FIG. 7 is an illustration of the results of an in vitro transcription as used in an exemplary method of the invention, as described in detail in Example 4, below.

FIG. 8 is an illustration of the results of an in vitro transcription assay as used in an exemplary method of the invention, as described in detail in Example 4, below.

FIG. 9 is an illustration of the results of an in vitro transcription used in an exemplary method of the invention, as described in detail in Example 4, below.

FIG. 10 is an illustration of the results of a cellular uptake and nuclear incorporation assay using exemplary compounds into MCF-7 human mammary cells, as visualized using confocal microscopy, as described in detail in Example 5, below.

FIG. 11 is a flow diagram showing exemplary sequential pathways of the invention for identification and their interrelationship. The squares indicate procedural steps and the diamonds indicate decision or design points. FIG. 11A illustrates the full schematic, and FIGS. 11B, 11C and 11D are selective views of the full scheme of FIG. 11A.

Like reference symbols in the various drawings indicate like elements.

Modes of Carrying Out the Invention

The invention provides systematic methods for identification of compounds that are viable therapeutic candidates for treating or preventing (ameliorating) conditions (including genetic conditions, diseases, infections) that are a result of, or that are abetted by the expression of a target gene. The systems of the invention create a reproducible paradigm for obtaining successful candidate therapeutics.

In one aspect, the selection of a target gene is based on the known properties of a particular condition (e.g., a genetic condition) or disease to be treated. For example, it is understood that certain oncogenes are important in cellular proliferation, while others generate receptors or enzymes that are mediators of undesirable conditions, such as the Her 2 receptor in breast cancer and the androgen receptors in prostate cancer. Table 1, below, summarizes a number of exemplary target genes used to practice the invention, these including genes that are known to be associated with various forms of cancer and whose down-regulation may inhibit tumor growth. However, other associations of genes with non-tumor diseases are also known, and of course additional correlations will be forthcoming as the field develops. Thus, any gene correlated to a disease, condition, infection, predisposition, drug side affect and the like can be used as a “target gene” to practice the invention. In one aspect, the selection of the target gene is made from the associations that are known at the time of selection. The repertoire will expand as time goes on. In order to design individual compounds or libraries, in alternative aspect the sequence of the target gene is either known or determined. Target gene sequences can be determined by standard and routine cloning and sequencing techniques.

TABLE 1
Genes Associated with Different Tumour Types

| Cancer Type | Associated Genes |
|---|---|
| Breast | BRCA, Her-2/neu |
| Burkitt's Lymphoma | Myc |
| Prostate | c-Myc |
| Colon | MSH |
| Lung | EGFR (ErbB-1), Her 2/neu (ErbB-2), |
| | Her 3 (ErbB-3) and Her 4 (ErbB-4) |
| Chronic Myeloid | BCR-ABL |
| Leukemia (CML) | |
| Malignant Melanoma | CDKN2, BCL-2 |
| endothelial | VEGFR, VEGFR2 |
| Various | PKA, VEGFR, VEGFR2, PDGF and PGGFR |

In one aspect, the selection of the target gene requires documented evidence in 435 appropriate pre-clinical or clinical models that the up or down regulation of the gene directly adds to the specific therapeutic effect, for example, the inhibition of tumor growth, or that up or down regulation of the gene results in the increased effectiveness of existing therapeutic agents.

In alternative aspects, a transcriptional activating sequence, e.g., a promoter and/or enhancer region, a coding region of a gene, or both the transcriptional activation sequence and 440 the coding sequence, are selected for targeting. In one aspect, a subsequence of base pairs is chosen, e.g., a particular subsequence of about 6 to 19 base pairs (or about 5, 6, 7, 8, 9, 10, 11, 12, 13, 14, 15, 16, 17, 18, 19, or 20 or more contiguous base pairs of the gene) is arbitrarily or specifically chosen, as the focus for transcription factor or inhibitor binding.

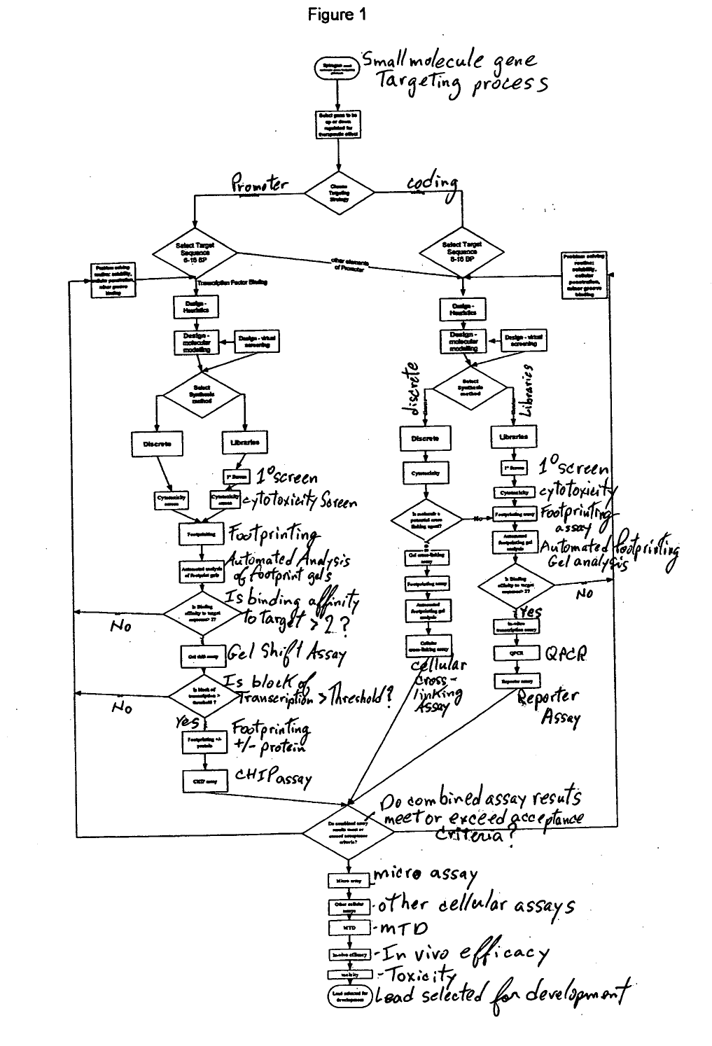

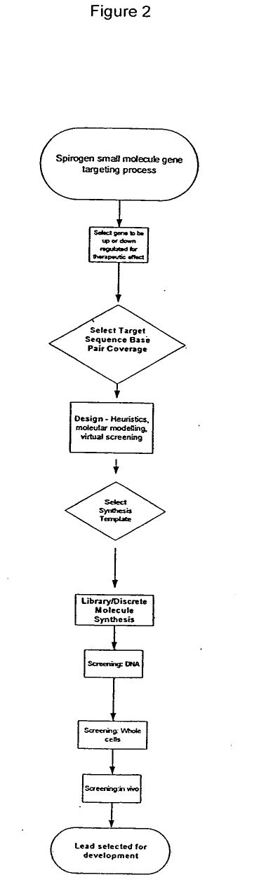

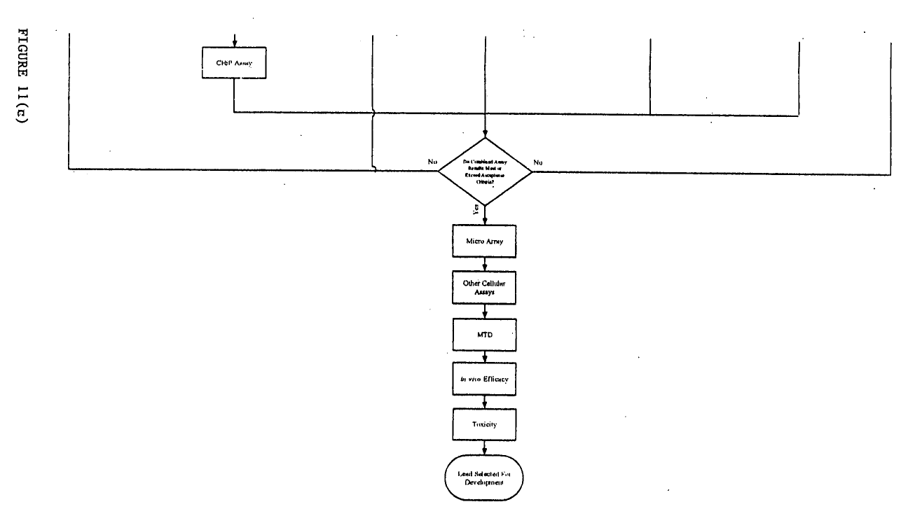

In one aspect, individual compounds or libraries of compounds are then designed 445 based initially on intuition and heuristics, but supplemented with molecular modeling and virtual screening, for example, for compounds that bind in the minor groove. These elements are interrelated, as shown in FIG. 1 (showing four exemplary schemes), FIG. 2 or FIG. 11 (showing several exemplary schemes). These steps are similar, regardless of whether the promoter or enhancer region or the coding region is selected as the target sequence. Synthesis methods for the individual compound or designed libraries can be selected from the literature or can be independently devised.

Once the compounds or libraries are obtained, a prescribed set of assays—including the exemplary methods of the invention—are practiced to obtain a candidate. These assays are described in detail herein. Alternative designs of the libraries or the individual compounds that will be subjected to the sequence of assays that represent the alternative methods of the invention are also described in detail herein.

Methods for Compound/Library Design

In one aspect, the methods comprise providing a library of compounds designed to interact with a portion of a transcriptional regulatory sequence and/or protein encoding sequence of a gene of interest. In one embodiment, for design of the libraries, in silico or virtual screening is conducted by using docking libraries of purchasable compounds into a rigid DNA “receptor” employing pharmacophore screening based on known ligands and interaction cites in the minor groove, and by de novo design by growing molecules from small fragments based on the DNA minor groove. Molecular modeling can also be performed using molecular dynamics and binding energy calculations using the MMPBSA (i.e., “MM-PBSA,” or, Molecular Mechanics Poisson-Boltzmann/surface area; see, e.g., Wang, J. Am. Chem. Soc. (2001) 123:5221-5230) approach and evaluating library templates. The binding site size and feasibility of cross-linking of pyrrolobenzodiazepine (PBD) dimers, for example, SG 2446 (octapyrrole) can also be employed along with binding energy calculations using free energy perturbation methods to assess new building blocks and sequence specificity.

In one aspect, as an initial approach, heuristics are used to provide a background for designing a library of compounds. Thus, a set of empirically derived heuristics can be used to inform the design and synthesis of DNA-interactive discrete molecules and libraries.

In one-aspect, the design of a library of compounds for interacting with a transcriptional regulatory nucleotide sequence of a gene is based on the structure of DNA-binding molecules, including DNA-binding molecules that bind covalently, e.g., pyrrolobenzodiazepines (PBDs), CC-1065 derivatives, mustards and related compounds, or DNA-binding molecules that bind non-covalently, e.g., heterocyclic polyamides and related compounds.

In one aspect, covalent, DNA-binding molecules such as pyrrolobenzodiazepines are used in the methods of the invention. Covalent, DNA-binding molecules exhibit preferences for particular bases, motifs and grooves. Pyrrolobenzodiazepines (PBDs) bind covalently to the N2 of guanine bases in the minor groove of DNA. The guanine base is preferentially flanked by other purine bases to establish a purine-guanine-purine motif. Naturally occurring PBDs have a further preference for a specific adenine-guanine-adenine (AGA) triplet. Thus, in one aspect pyrrolobenzodiazepines that prefer to orient themselves in such away that the pyrrolo C-ring points towards the 5′ end of the covalently linked strand are used.

In one aspect, CC-1065 derivatives such as CBI and CPIs (Cyclo propyl Benzo Indole and Cyclo propyl Pyrrolo Indole, respectively) that display a similar preference for the minor groove of DNA, but bind covalently to adenines in complementary fashion to pyrrolobenzodiazepines, are used. CBI and CPIs prefer to bind to adenines embedded in adenine rich sequences.

In one aspect, mustards such as chlorambucil that prefer to bind to guanine bases in the major groove of DNA are used; but this preference can be overcome when the mustard unit is conjugated to a heterocyclic polyamide moiety, directing the conjugate to the major groove.

In addition to covalent binders, heterocyclic polyamides based on the natural product distamycin bind non-covalently in the minor groove of DNA can be used. In one aspect, heterocyclic polyamides that can adopt a 2:1 or 1:1 stoichiometry with respect to DNA are used; this can have a profound influence on the recognition properties of the molecules.

In one aspect, short heterocyclic polyamides, e.g., with two polyamide arms, are used. Two or more polyamide arms can be linked via amino acid loops. Short heterocyclic polyamides that can readily adopt a 2:1 binding mode are used in one aspect. Longer molecules also can be used; these longer molecules can be constrained to adopt this stoichiometry by linking two polyamide arms via amino acid loops. If one linking loop is employed a hairpin polyamide is obtained but linking the polyamides at both sets of N and C termini results in a cyclic polyamides. Hairpin polyamides prefer to orientate themselves with the loop towards the 3′ end of the top DNA strand. Polyamides commonly comprise Pyrrole (Py), Imidazole (Im) and Hydroxypyrrole (Hp) building blocks. When the units appear opposite one another in a 2:1 binding template they can recognize specific base pair combinations in a predictable fashion.

| | |
|---|---|
| Py/Im | C:G |
| Im/Py | G:C |
| Py/Py | A/T:A/T |
| Hp/Py | T:A |
| Py/Hp | A:T |

Pyrroles can be replaced with β-alanine units in longer molecules, without loss of selectivity, allowing the polyamide to retain registration with the DNA base pairs. Polyamides contain obligatory functionality (such as the loops mentioned above and tails) which prefer to align themselves with adenine or thymine bases in a non-specific fashion. Hairpin polyamides normally start with a pyrrole or imidazole couple requiring the targeted sequence to commence (5′ end) with a G:C base pair as opposed to an A:T. Similarly runs of imidazoles in the same arm, and hence G-tracks in the DNA are avoided.

Hairpin and cyclic polyamides can also be used. Hairpin and cyclic polyamides are not compatible with targeting homopurine motifs due to the width of the minor groove encountered in these tracks. However these sequences are accessible through the 1:1 binding mode. In this case pyrroles favor adenines or thymines bases, hydroxypyrroles favor thymines but imidazoles do not discriminate between guanines and cytosines. When the molecules possess a charged tail this is oriented towards the 5′ end of the top strand.

Some embodiments of the invention take advantage of these heuristics, and templates may be designed. The nature of some template molecules is already known. For instance, pyrrolobenzodiazepine monomers and dimers are often employed as cytotoxic agents. The presence of electron donating groups in the A-ring, 2,3-endo unsaturation in the C-ring and a flat substituent (e.g., alkenyl or aryl) potentiates cytotoxic activity. Linking two pyrrolobenzodiazepines via their C8 positions allows the molecules to generate interstrand crosslinks that are extremely cytotoxic to dividing cells. These molecules have improved sequence selectivity (with respect to monomers) recognizing and cross-linking at puGATCpy motifs.

In some embodiments of the invention templates exploiting a 2:1 binding mode are used, and these are useful for targeting relatively short DNA sequences of up to about 9 to 10 base pairs. 2:1 Binding templates have the potential to recognize specific sequences, making them ideal for targeting transcription factor binding sites, or conserved mutations in the transcribed region of oncogenes, where the target DNA sequence is well known.

The 1:1 Binding Mode also can be used as target sequences of up to 16 base pairs potentially allowing unique selection of individual genes. As the heuristics governing the recognition of 1:1 binders are less prescriptive than for 2:1 templates, combinatorial methods are best employed to allow the synthesis of libraries of 1:1 binding compounds. These libraries may then be screened to identify molecules binding to the target DNA sequences.

In addition, molecular modeling techniques and virtual screening can be employed to supplement and complement design based on Heuristics and template selection.

The purpose of molecular modeling is to evaluate various templates to decide whether they can produce compounds which are likely to fit into the DNA minor groove. Molecular dynamics (MD) simulations of the proposed ligands bound to DNA duplexes are carried out, using the GROMACS simulation code.

In one aspect, the first stage is the parameterization of the ligand building blocks. This is done using a hierarchy of geometry optimizations (e.g., MMFF94, MMFF94s, OPLS/A or OPLS-AA molecular mechanics, PM3 semi-empirical potential, and/or HF-6-31G* ab initio calculations, quantum chemical methods including HF/6-31G* and B3LYP/6-31G*(see, e.g., Hwang, Biopolyiners (1998) 45:435-468; Ercanli, J. Chem. Inf Model. (2005) 45:591-601) of capped fragments such as PBD, pyrrole and imidazole. The dispersion and bonded parameters are assigned according to the gaff forcefield, and the charges calculated with a constrained RESP fit to HF-6-31G* electron distributions, using a modified procedure designed to maintain integer charge on each building block once the capping groups are removed. A library of building blocks is maintained and reused across different projects.

In one aspect, the DNA sequence to be modeled is then selected and assembled in canonical B-DNA form. The legend molecule is assembled in the minor groove by aligning the building blocks, using a graphical modeling package. The energy of the complex is then minimized using the AMBER99 force-field parameters for the DNA, and the ligand parameters as derived above, before adding water molecules and starting a 2-5 ns MD simulation. Typically the hydrogen bonding interactions between polyamide ligand and the DNA are restrained during the initial minimization based on well-known binding interactions of similar molecules (see, e.g., Urbach, J. Mol. Biol. (2002) 320:55; Zhang, Am. Chem Soc. (2004) 126:7958) in order to maximize the chance of the most relevant regions of configuration space being explored.

In one aspect, the MD trajectories are then analyzed. Deviations of the DNA structure from the usual helical form are indicative of poor binding. The binding interaction is also assessed quantitatively using the MM-PBSA methodology (see, e.g., Kollman, Acc. Chem. Res. (2000) 33:889; Spackova, J. Comp. Chem. (2004) 25:238), which estimates the binding energy of each ligand to the receptor, accounting for the effects of solvation via the Poisson-Boltzmann treatment of electrostatics.

Beta Alanine Position

In one aspect, a 64-member library is used, which may be designed based on polyamide experimental methodology for coupling polyamide building blocks together and with a PBD capping unit. However, the optimal layout of building blocks is unclear. It is thought based on previous work that long polyamide chains could only be expected to bind DNA if heterocycles are interspersed with β-alanine units in order to maintain the iso-helicity of the molecule with the minor groove. The modeling aims to ascertain the optimal spacing of β-alanine units. Six compounds of the same length as the ultimate 64-member library can be simulated bound to the same DNA sequence.

The results illustrate that 1 or 2-heterocycle units joined by β-alanine are likely to give the best results. The simulations of these compounds also demonstrate stable complex formation and predict the binding site size of the 64 member library compounds, which is useful in rationalizing experimental footprinting results.

Dimers

In one aspect, a compound identified by a screening method of the invention is confirmed to be a compound that interacts with a protein-encoding (gene) sequence or a transcriptional regulatory sequence of the gene by confirming the ability of the compound to effect cross-linking to any part of the gene sequence, e.g., a promoter, enhancer, or protein-encoding. In one aspect, a molecule AT242 is used as a DNA cross-linker. A series of MD simulations establish that it was likely to be able to bind covalently to two guanines on opposite strands without causing significant disruption to the DNA, and further that this mode would be energetically favorable when compared to intra-strand ligation. A range of base-pair spacings between the two covalently-bound guanines can be assessed, enabling the binding site size to be predicted. The compound can then be confirmed experimentally to cross-link DNA in whole cells.

In one aspect, a longer compound SG 2446 (“octapyrrole”) (an analogue of AT242 which spans more than 16 base pairs) is used in the methods of the invention. Simulations predicted the binding site size for this compound as 19 base pairs, and that cross-linking is energetically favorable to intra-strand binding. Further the binding mode is feasible without significant distortion of the DNA duplex. This compound was also later confirmed experimentally to cross-link DNA in whole cells.

Docking

One aspect of the invention comprises use of new binding motifs found by virtual screening; e.g., virtual screening of large libraries of compounds was carried out. The principle source of these libraries was the free internet resource ZINC. See, e.g., Irwin, J. Chem. Inf Model (2005) 45:177.

Given the structure of a receptor, it is possible to computationally dock potential ligands into the receptor binding site, and rank the ligands in accordance with a scoring function. In our case, DNA from a representative crystal structure of a DNA minor-groove bound complex was used as the receptor. In alternative aspects of the present invention, any known docking programs can be used; and for this invention docking programs have been evaluated according to their ability to predict the experimental binding modes of various ligands, and also their ability to select compounds known to bind DNA from a large set of random compounds. Well-validated programs can then be used to find new lead compounds, which may be modified or converted to convenient building blocks in the synthetic planning stage.

One aspect of the invention comprises creating pharmacophores from interaction sites in the minor groove. The interaction sites in the minor groove which lead to sequence-selective binding are relatively well-understood, as are the important functional groups in established minor-groove binders. Therefore, it is possible to create pharmacophores from these sites (either receptor or ligand-based), and use these to screen compound libraries. This approach can be considerably faster than structure-based docking, but takes into account less information about the receptor, thus is less reliable in ranking hits.

Preparation of Libraries and Compounds

As shown in the exemplary methods of the invention as illustrated in FIG. 1 (showing four exemplary schemes), FIG. 2, and FIG. 11 (showing several exemplary schemes), in alternative aspects, after design of the compounds or libraries, to determine whether a transcriptional activation sequence (e.g., a promoter, enhancer) or a coding sequence is targeted it is necessary to actually to prepare the compounds or libraries. Selection of which approach to use to prepare libraries in practicing this invention depends on the size of the library. Exemplary methodologies for preparing libraries to practice the methods of the invention are as follows:

In one aspect, very large libraries (in excess of 10⁴-10⁶ members) are prepared according to the split and mix (portioning-mixing) procedure introduced by Furka (see, e.g., Furka, Comb. Chem. High Throughput Screen. (1999) 2:105-122; Topiol, J Comb Chem. (2001) 3:20-27). The initial pool of resin is split into as many batches as there are individual building blocks and each batch is allowed to couple with only its designated building block. After completion of the coupling reaction the batches are pooled and thoroughly mixed, any common operations, such as deprotection, are performed at this stage. The pooled resin is then split into individual batches and each batch of resin coupled to its designated building block in the second coupling cycles and the process continues as described above. Once the required number of split and mix cycles has been performed the resin is pooled for a final time and the combined resin pool coupled to the PBD capping unit. Once the PBD capping unit has been detected the resin is incubated with the target DNA sequence. The DNA is labeled with rhodamine dye allowing beads which have bound to DNA to be physically isolated. The compound on the bead is then analyzed to reveal the identity of the compound binding to the target DNA sequence.

The method works best for peptide libraries based on proteinogenic amino acids, which can be easily identified by peptide sequencing. If non-proteinogenic amino acids are employed, then the resulting molecules must be identified through a coding strategy.

Intermediate size libraries of 10³-10⁴ members are best addressed using the TRANSORT™ system (Mimotopes, Raleigh N.C.). Libraries are prepared on a solid plastic support known as a crown. The crowns are grafted with chemically active handles allowing building blocks to be attached to the crown. Crowns are available with many different functional groups grafted to them, the Rink linker is particular appropriate for the formation of libraries as it can be cleaved with TFA to afford library members with amidic tail units.

The crowns can be attached to an encapsulated transponder, allowing the synthetic fate of the crown to be controlled by computer. The computer is programmed with the identity of the building blocks to be used and the number of coupling cycles required. The computer then generates all the possible library members and gives each one a unique transponder code. When each crown-transponder unit is placed on a reader the unit is directed to a specific reaction vessel containing the correct building block. In this way literally hundreds of crowns can be manipulated simultaneously and couplings performed in large conical flasks to generate 1,000 member libraries. Excess building blocks, coupling reagents and washing solvents are removed by filtration through a sinter funnel. At the end of the synthesis the identity of the compound on each crown is revealed by its transponder and the product can be cleaved in to a pre-designated position on a 96 deep well plate. Parallel evaporation under vacuum (e.g., Genevac) affords the crude library members ready for purification by preparative mass-directed liquid chromatography.

In one aspect, larger libraries (up to 10,000, or more) are generated using commercially available automated sorters.

In one aspect, parallel synthesis methods are used. Parallel synthesis methods are particularly appropriate for the synthesis of small focused libraries. Solution phase approaches have the advantage that the progress of individual coupling reactions can be monitored by LC-MS. The major challenge in solution phase library production is the purification of library intermediates. In solid phase approaches large excesses of reagents and building blocks can be employed to drive reactions to completion, as the products remain bound to the support (bead or crown) the excess chemical can simply be filtered away. However, facile intermediate purification in solution is necessarily not as easy to achieve. This issue is addressed by including dimethylamino tail units in library templates. These tail units not only mimic naturally occurring DNA binding units, but act as anchors allowing temporary immobilization of intermediates on acidic solid phase extraction cartridges. In this way excess reagents and building blocks can be washed away from the intermediate before it is eluted under basic conditions. The purification can be performed in parallel using commercially available vacuum manifolds and libraries containing up to 256 members can be readily obtained.

For preparation of compounds, the method is dependent, of course, on the nature of the compound selected. Often methods are available from the literature for analogous compounds so that standard means known in the art are used for the synthesis.

In one aspect, very limited numbers of molecules (less than 30) are synthesized in solution using traditional organic chemistry; see, e.g., Examples 1a to If.

Assay Method Sequence in the Invention's Discovery Paradigm

Referring now to the exemplary method of the invention illustrated in FIG. 1 or FIG. 11, it is seen that once libraries are synthesized, either in the exemplary path based on binding to the coding sequence or on the exemplary pathway based on binding to a transcriptional regulatory nucleotide sequence (e.g., a promoter, enhancer), a primary screen is performed to select a subset of compounds from the libraries in each case that actually bind to DNA. An exemplary primary screen is described in detail as follows:

In the primary screen, the library compounds are tested for their ability to intercalate duplex DNA. In this assay, complementary DNA sequences are annealed to produce an oligonucleotide duplex by combining equal volumes of 500 μM primer solutions in a screw cap vial and heating to 90° C. for five minutes on a heating block before allowing the mixture to passively cool back to room temperature. For the intercalator displacement assay, into each well of a black polystyrene 96 well plate, 10 μl of an 80 μM oligonucleotide duplex stock is incubated with 10 μl of test compound (100 μM stock in 10% DMSO) and 80 μl of assay buffer (69.6 mM Tris pH 8.0, 69.6 mM NaCl and 6 μM ethidium bromide final) to give a final volume of 100 μl per well. Control wells, used to determine total fluorescence of the DNA duplex in the absence of test compound, are prepared by substituting 10% DMSO in the place of compound to give a final 1% DMSO concentration in each well. The reaction mix is incubated at room temperature in the dark with gentle agitation for 24 hours prior to being read on an ENVISION™ fluorescent plate reader (Perkin Elmer) using 544 nm excitation and 595 nm emission filters. The relative capacity of the compound to displace fluorescent intercalator from a known sequence of DNA duplex is calculated as the percentage loss of fluorescence following compound addition compared to DMSO treated control wells. Error values are presented as the standard deviation of each sample replicate as a percentage of loss of fluorescence. The assay is run in the exclusion format using the same reagents as above but with a different order of addition of the reagents. In the exclusion format, the test compound is pre-incubated with the DNA duplex for 23 hours prior to the addition of the assay buffer, after which the plate is agitated for only one hour.

In more detail, in one aspect, the reagents used are 1 M Tris pH 8.0, 1 M NaCl, dH₂O DNase, RNase Free (Sigma W4502), oligonucleotide duplex (500 μM, produced at 1 μM scale), DMSO Biotech Grade (Sigma D2438), Ethidium Bromide 1% Solution in dH₂O (EtBr) (Fluka 46067 Florescence grade), and TOPSEAL-A™ adhesive sealing film (Perkin Elmer, 6005185). Lyophilized oligonucleotides are suspended in dH₂O at a final concentration of 500 μM. Equal quantities of the two oligonucleotides required for the duplex are mixed in a screw cap vial and incubate at 90° C. on a heated block (Grant) for 5 minutes before cooling to room temperature by switching off the block. Oligo duplex is stored at 4° C. (1 week) or −20° C. for long term. For use in assay, this is diluted to a final concentration of 80 μM in dH₂O (6.25×Dil).

In one aspect, a stock concentration of assay buffer is prepared composed of 0.087 M Tris pH 8.0, 0.087 M NaCl and 125 μM EtBr. From stocks of each of the components (1 M and 1% respectively) this equates to 87.561 μl per ml of assay buffer for Tris and NaCl respectively and 4.929 μl of 1% EtBr. The final concentrations of each of the components in the assay are 100 μM for EtBr and 0.0696 M for NaCl and Tris pH8.0 respectively. The final concentration of DMSO in the assay is 1%.

In one aspect, all assay points are set up as duplicates. Into each well of a 96 well black polypropylene Greiner plate, the following are added: 10 μl 80 μM oligonucleotide duplex, 10 μl of drug in 10% DMSO or 10% DMSO as control, and 80 μl assay buffer, to 100 μl total. The plate is sealed with a TOPSEAL-A™, placed on an orbital shaker, and incubated 24 hours in the dark with constant agitation at 100 rpm.

In one aspect, all assay points are set up as duplicates. Into each well of a 96 well black polypropylene Greiner plate, the following are added: 10 μl 80 μM oligonucleotide duplex and 10 μl of drug in 10% DMSO or 10% DMSO as control. The plate is sealed with a TOPSEAL-ATM and incubated in the dark at room temperature for 23 hours. The film is removed and 80 μl of assay buffer is added. Fresh TOPSEAL-A™ is applied and the plate is incubated for a further 1 hour in the dark with constant agitation at 100 rpm.

Where significant condensation has occurred on the TOPSEAL-A™ covering film, the plate it centrifuged at 2,000 rpm for 5 minutes and the topseal cover is replated with a fresh film. The plates are counted on an ENVISION™ (Perkin Elmer, Wellesley, Mass.) plate reader with the following parameters set:

| Excitation | 544 nM |
|---|---|
| Emission | 595 nM |
| Excitation light | 25% |
| Measurement Height | 7.3 mm |
| Detector Gain | 75 |
| Flashes per well | 5 |

Raw data are analyzed to represent the percentage loss of fluorescence caused by drug treatment in comparison to DMSO treated control wells. Errors are represented as the standard deviation of the sample wells as a percentage of total fluorescence.

Next Steps—Cytotoxicity

The methods of the invention can comprise assessing the cytotoxicity of a compound selected during any step or steps of the method, including assessing the cytotoxicity of each member of a selected subset (e.g., a first subset or a second subset), e.g., as in the exemplary methods illustrated in FIGS. 1, 2 or 11.

In this exemplary scheme (process) of the invention, after the primary screen as described above, with respect to libraries, a first subset of successful compounds is obtained. This subset, as well as the discrete compounds initially prepared, is then subjected to a test for cytotoxicity.

Referring again to the exemplary schemes of the invention illustrated in FIG. 1, each of the four exemplary sequences of tests of the invention comprises use of a cytotoxicity assay. In one aspect, this is done directly on compounds synthesized as discrete compounds and on the subset of the compounds contained in the libraries that have been verified to bind to DNA as described above. The cytotoxicity test will confirm the characteristics of the discrete or library compound.

In one aspect of this test, K562 human chronic myeloid leukemia cells are maintained in RPMI1640 medium supplemented with 10% fetal calf serum and 2 mM glutamine at 37° C. in a humidified atmosphere containing 5% CO₂ and are incubated with a specified dose of drug for one hour at 37° C. in the dark. The incubation is terminated by centrifugation (5 min, 300 g) and the cells are washed once with drug-free medium. Following the appropriate drug treatment, the cells are transferred to 96-well microtiter plates (10⁴ cells per well, 8 wells per sample). Plates are then kept in the dark at 37° C. in a humidified atmosphere containing 5% CO₂. The assay is based on the ability of viable cells to reduce a yellow soluble tetrazolium salt, 3-(4,5-dimethylthiazol-2-yl)-2,5-diphenyl-2H-tetrazolium bromide (MTT, Aldrich-Sigma), to an insoluble purple formazan precipitate. Following incubation of the plates for four days (to allow control cells to increase in number by approximately 10 fold), 20 μL of MTT solution (5 mg/ml in phosphate-buffered saline) is added to each well and the plates further incubated for five hours. The plates are then centrifuged for five minutes at 300 g and the bulk of the medium pipetted from the cell pellet leaving 10-20 μL per well. DMSO (200 μL) is added to each well and the samples agitated to ensure complete mixing. The optical density is then read at a wavelength of 550 nm on a MULTISCAN™ (Titertek Labsystems, Finland) ELISA plate reader, and a dose-response curve is constructed. For each curve, an IC₅₀ value is read as the dose required to reduce the final optical density to 50% of the control value.

Next Steps—Footprinting

Alternative aspects of the methods of the invention comprise assessing the ability of a compound (e.g., each member of a second subset) to bind to the transcriptional regulatory nucleotide sequence. Determining whether a compound binds to a transcriptional regulatory sequence motif with sufficient affinity can be performed by any appropriate method, e.g., a method comprising footprinting and/or automated analysis. Sufficient affinity is determined by the particular assay—it may vary depending on which assay and conditions are used, e.g., what one skilled in the art would consider sufficient binding in a footprinting analysis, which is well known in the art.

In this exemplary scheme, members of subset 1 are subjected to further assays, e.g., in one aspect, a footprinting assay, unless the discrete molecule in the coding sequence-targeting path is a potential cross-linking agent. If the discrete molecule is a potential cross-linking agent, it is subjected to a cross-linking assay, e.g., a gel cross-linking assay, before the footprinting assay; this is applicable to all aspects of the invention.

In an alternative aspect, members of the libraries are also subjected to a cytotoxicity assay either before or after, or before and after, the footprinting assay. In alternative aspects, members of the libraries are sufficiently cytotoxic if they kill at least about 5%, 10%, 20%, 30%, 40%, 50%, 60%, 70%, 80%, 90%, 91%, 92%, 93%, 94%, 95%, 96%, 97%, 98%, 99%, or more cells in any particular assay. In another aspect, molecules found to be cytotoxic are subjected to further assays, e.g., in one aspect, a footprinting assay, unless the discrete molecule in the coding sequence-targeting path is a potential cross-linking agent. If the discrete molecule is a potential cross-linking agent, it is subjected to a cross-linking assay, e.g., a gel cross-linking assay, before the footprinting assay; this is applicable to all aspects of the invention.

Referring again to FIGS. 1 and 11, in exemplary schemes, including those comprising promoter or enhancer targeting, footprinting immediately follows successful performance in the cytotoxicity testing, or alternatively footprinting can follow a gel shift assay. In one exemplary branch (of one of the illustrated schemes), footprinting immediately follows the cytotoxicity test and is performed on the subset of library members that is successful in that test. However, in one aspect, if the discrete molecule is a cross-linking agent, a preliminary gel cross-linking assay precedes the footprinting assay. In the exemplary scheme discussion below, the gel cross-linking assay is first described in detail as applicable only to the assay sequence with respect to discrete compounds designed to bind the coding sequence; footprinting assay and its automated interpretation is then described, as its features are applicable to all streams of testing (alternative schemes) of methods of the invention.

In one aspect, the gel cross-linking assay is performed as follows: Closed—Circular pUC18 Plasmid DNA (Sigma) is linearized with HindIII, then dephosphorylated, and 5′ end labeled with [γ32P]-ATP using Polynucleotide Kinase (Promega). Reactions containing 10 ng of DNA and drug are performed in 1×TEOA (25 mM Triethanolamine, 1 mM EDTA, pH 7.2) buffer at a final volume of 50 μl, at 37° C.

In one aspect, reactions are terminated by the addition of an equal volume of stop solution (0.6 M NaOAc, 20 mM EDTA and 100 μg/mL tRNA) followed by precipitation with Ethanol. Following centrifugation of the samples, the supernatant are discarded and the pellets are washed with a 70% ethanol solution, centrifuged and the supernatant discarded. The remaining pellets are dried under a vacuum. Samples are re-suspended in 10 μl of Alkaline denaturing buffer (4 mg Bromophenol blue, 600 mg Sucrose and 40 mg NaOH) and vortexed for three minutes at room temperature. The non-denatured controls are re-suspended in 10 μl of Standard Sucrose loading dye (2.5 mg Bromophenol blue, 2.5 mg Xylene Cyanol blue and 4 g Sucrose). Both samples and controls where loaded directly onto an agarose gel.

In one aspect, electrophoresis is performed on a 0.8% submerged horizontal agarose gel, 20 cm in length for 16 hours at 38-40 v in 1×TAE running buffer.

In one aspect, gels are dried under a vacuum for 80 minutes at 80° C. on a Savant SG20D SPEEDGEL™ gel dryer onto one layer of Whatman 3MM™ with a layer of DE81™ filter paper underneath.

The dried gel is exposed to a phosphor storage screen (GE Healthcare) to be read on a STORM 840™ Phosphorimager (GE Healthcare). The bands on the autoradiograph are quantitated using IMAGE QUANT TL™ analysis software (GE Healthcare).

The percentage of cross-linking can be calculated by measuring the total DNA in each lane (the sum of the densities for double stranded and single stranded bands) relative to the density of the double stranded band alone.

As noted above, the footprinting assay and its automatic readout can occur in all the alternative exemplary sequences (methods) of the invention, as illustrated in FIG. 1 or FIG. 11. Preparation for this assay in terms of cell culture and preparation of nuclear extracts is described initially as these procedures are employed as well in the gel shift assay that occurs subsequent to footprinting in the sequences, e.g., on the left hand stream (exemplary method) in FIG. 1, or the exemplary method illustrated as the center stream of FIG. 11.

In one aspect, NIH3T3 cells (obtained from CR-UK London Research Institute) are grown in Dulbecco's MEM High Glucose (DMEM) (Autogen Bioclear) supplemented with 10% new-born calf serum (NBCS), 1% glutamine and incubated at 37° C. in 5% CO₂. HCT116 cells are also obtained from CR-UK London Research Institute and grown in RPMI medium (Bioclear) supplemented with 10% fetal calf serum (FCS), 1% glutamine and incubated at 37° C. in 5% CO₂.

In one aspect, nuclear extracts are essentially prepared as described, e.g., by Firth, Proc. Natl. Acad Sci USA (1994) 91:6496-6500, and all steps are performed at 4° C. in the presence of a protease inhibitor mix (COMPLETE™, Boehringer). Briefly, cells are rinsed with ice-cold phosphate buffered saline (PBS), scraped from the surface and collected by centrifugation. The cells are washed with 5 equivolumes of hypotonic buffer containing 10 mM K-Hepes pH 7.9, 1.5 mM MgCl₂, 10 mM KCl, 0.5 mM dithiothreitol (DTT, Sigma). Subsequently, the cells are re-suspended in 3 equivolumes hypotonic buffer, incubated on ice for 10 min, subjected to 20 strokes of a Dounce homogenizer and the nuclei are collected by centrifugation. The nuclear pellet is re-suspended in 0.5 equivolumes low salt buffer containing 20 mM K-Hepes pH 7.9, 0.2 mM K-EDTA, 25% glycerol, 1.5 mM MgCl₂, 20 mM KCl, 0.5 mM DTT. While stirring, 0.5 equivolume high salt buffer (as low salt buffer but containing 1.4 M KCl) is added and the nuclei are extracted for 30 min. Subsequently, the mixture is centrifuged for 30 min at 14,000 rpm in an Eppendorf centrifuge and the supernatant is dialyzed in tubing with a 12 kDa cut off (Sigma) for 1 hr in a 100 times excess of dialysis buffer containing 20 mM K-Hepes pH 7.9, 0.2 mM K-EDTA, 20% glycerol, 100 mM KCl, 0.5 mM DTT. The dialyzed fraction is centrifuged for 30 min at 14,000 rpm in an Eppendorf centrifuge and the supernatant is snap frozen in an ethanol dry ice bath and stored at −80° C. The protein concentration of the nuclear extract is assayed using a BIO-RAD micro protein assay kit. The footprinting assay is described, e.g., in Martin, Biochemistry (2005) 44:4135-4147.

In the footprinting assay itself, a radiolabeled probe of 479 bp corresponding to positions −489 through −10 relative to the transcriptional start site of the top IIα promoter is generated as follows. 4 pmol Of the antisense oligonucleotide

5′-GTCGGTTAGGAGAGCTCCACTTG-3′ (SEQ ID NO:1) is 5′ end labeled with T4 kinase (NEB) using γ-³²P-ATP in a 10 μl reaction, followed by heat inactivation for 20 min at 65° C. Subsequently, 4 pmol sense oligonucleotide (5′-CTGTCCAGAAAGCCGGCACTCAG-3′) (SEQ ID NO:2), 2 μl 10 mM dNTPs (Promega), 1 U RED HOT™ DNA Polymerase (Abgene), 2 μl 25 mM MgCl₂ and 4.5 μl 10x reaction buffer IV (Abgene) are added (in a final volume of 50 μl) and a PCR reaction is performed consisting of: 3 min 95° C. and 1 min 95, 1 min 60° C. and 2 min 72° C. for 35 cycles. The product is purified on a Bio-Gel P-6 column (BIO-RAD). DNase I footprint reactions are performed with 30 μg nuclear extract in a 50 μl reaction in the same buffer as used for an electrophoretic mobility shift assay (EMSA). After pre-incubation for 30 min at 4° C. approximately 0.1 ng radio labeled probe is added and the mixture is incubated at room temperature for another 30 min. Subsequently, 1 U RQ1 DNase I (Promega) and up to 5 mM MgCl₂ and CaCl₂ are added. Following exactly 3 min of digestion at room temperature, 1 volume stop mix containing 30 mM K-EDTA pH 8.0, 200 mM NaCl and 1% SDS is added and samples are purified by phenol-chloroform treatment and alcohol precipitation. The resulting pellets are dried and re-suspended in loading buffer (95% formamide, 20 mM K-EDTA pH 8.0, 0.05% BFB and 0.05% xylene cyanol). The sample is heat denatured for 3 min at 95° C. and separated on a 6% denaturing polyacrylamide gel (Sequagel, National Diagnostics). A 10 bp ladder (Gibco) labeled with ³²P by T4 kinase is used as a molecular weight standard. The dried gels are exposed to Kodak X-OMAT-LS™ film with intensifying screens (Kodak) at −80° C.

In this example, in all cases the footprinting assay is interpreted by automated gel analysis. Footprinting assays identify areas of binding by determining areas that are immune to nuclease treatment. In the automated assay performed in the invention method, the results are analyzed as described below.

Infra-red intensity data collected by a Lycor sensor from a DNAse I footprinting experiment is converted by a series of steps into textual and graphical output of the location of footprints and the concentration at which they appear. The sequence of the DNA is input and aligned with the location of the footprints, meaning the base pairs to which a particular drug binds are known immediately. Whole gels, typically containing fifty lanes of several different concentrations for each of several drugs, can be analyzed simultaneously; equally, parameters can be adjusted on a drug-by-drug basis.

The process from the point of view of the operator is described below. The core of the process is a custom program “footprint2,” below.

1. Operator reads the gel image from the Lycor machine into Image Quant, which converts the intensities into numerical data, and also assigns the positions of the lanes.

2. Operator chooses a section of the gel to analyze, typically a few hundred base pairs in length.

3. Operator identifies the marker “G+A” lanes, generated by cleavage at purine bases, chooses one of these lanes to use, verifies the position of the peaks in this lane produced by Image Quant automated peak assignment, and identifies the sequence position at the start and end of the chosen section.

4. Operator outputs the intensity data, sequence, and pixel position of the G+A residues for the chosen section; this output as text files via Excel.

5. Operator reads these three files into custom program “footprint2,” and selects options for normalization of data.

6. footprint2 produces files:
intense_seq: data aligned to the sequence, i.e. one point for each base pair in each lane.
intense_out: as intense_seq but “normalized” by procedure described below.
intense_dc: differential cleavage calculated from intense out.
hits: textual output of the location and concentration of footprinting sites.
block: spreadsheet output of the location and concentration of footprinting sites.
score: graphical output of the location of footprinting sites and lowest concentration at which a footprint occurs for each drug at each site.

7. Operator can read or plot the output data, and compare to data from previous gels in the same format.

footprint2 is written in Perl, a cross-platform interpreted language, which allows rapid development. The Tk toolkit is used to provide simple graphical input dialogs. The program typically executes in under 5s, despite extensive numerical manipulations, which is a negligible fraction of the overall analysis time.

The program has the following sequence:

main:

getOptions Input files, # drugs, # lanes per drug, type of amplitude correction, # base pairs to smooth over, intensity decrease cut-off to register a footprint.

readData Read in input files

fillPix The raw data is indexed by pixel, but each lane is a different length. This routine puts all the data in each lane into npixel bins, where npixel is the number of pixels in the G+A lane.

subBackLane The background intensity in each lane is subtracted.

getSeqPix The G+A and sequence input is analyzed to produced indexed lists of sequence and pixel number seq2pix and pix2seq.

seqSmooth seq2pix and pix2seq are used to align pixel data to the sequence, and the intensity assigned to each base pairs is averaged over chosen number of adjacent base pairs.

polyFit Perform custom normalization procedure. Objective is to shift and tilt the baseline of each lane to the x-axis, and to normalize the amplitude of all peaks across all lanes for each drug. Data in each lane is binned and minimum and range in each bin found, then fit to polynomial curves, using routines in PDL extension to Perl.

subBackDrug It is necessary to shift all normalized intensities above zero before calculating the differential cleavage. This is done by drug.

diffCleave The differential cleavage is calculated.

scoreHitsBlock The footprints are assigned using the chosen intensity-decrease cut-offs.

printout Output files are produced.

As a result of the footprinting assay, it can be decided whether the compounds from the library or the discrete compound has a binding affinity to the target sequence greater than 2. If so, the compound is subjected to further testing; if no compounds are found with this affinity, further design of the molecule or library is required, and the sequence is repeated.

In alternative aspects, as noted above, the foregoing footprinting assay and analysis is performed regardless of the assay stream depicted in FIG. 1, FIG. 2 or FIG. 11. In alternative aspects, subsequent to the footprinting assay described above, the sequence of test procedures diverges, e.g., as shown in the exemplary methods illustrated in FIGS. 1 and 11.

Next Steps—Promoter Targeting Compounds

In alternative aspects of the methods of the invention, where the compounds or libraries are designed to target a transcriptional regulatory region, e.g., a promoter or enhancer, successful compounds in the footprinting analysis with sufficient affinity are subjected to assays to determine if they can interfere with or block or decrease the rate or amount of transcription. In alternative aspects, interfering with or decreasing the rate or amount of transcription includes decreasing the rate by at least about 5%, 10%, 20%, 30%, 40%, 50%, 60%, 70%, 80%, 90%, 91%, 92%, 93%, 94%, 95%, 96%, 97%, 98%, 99%, or more.

For example, in one aspect a gel shift assay is used to assess block of transcription. In one aspect, a footprinting +/−protein assay is used, and in another aspect, a ChiP (Chromatin Immunoprecipitation) assay is used. These or any equivalent assays can be used to practice the invention, and their exact order can be interchanged, e.g., a ChiP (Chromatin Immunoprecipitation) assay can be performed before a footprinting assay, or before an assay measuring the rate of transcription, and the like.

As noted above, the preparation of cells and extraction of DNA for the gel shift assay is as described for the footprinting assay. The gel shift assay itself is performed as follows:

The oligonucleotides (MWG Biotech) containing ICBs (underlined) used in electrophoretic mobility shift assays (EMSAs) are

Topo IIα ICB1 sense: 5′-CGAGTCAGGGATTGGCTGGTCTGCTTC-3′ (SEQ ID NO:3), antisense: 5′-GAAGCAGACCAGCCAAT CCCTGACTCG-3′ (SEQ ID NO:4);

ICB2 sense: 5′-GGCAAGCTACGATTGGTTCTTCTGGACG-3′ (SEQ ID NO:5), antisense: 5′-CGTCCAGAAGAACCAATCGTAGCTTGCC-3′ (SEQ ID NO:6);

ICB3 sense: 5′-CTCCCTAACCTGATTGGTTTATTCAAAC-3′ (SEQ ID NO:7), antisense: 5′-GTTTGAATAAACCAATCAGGTTAGGGAG-3′ (SEQ ID NO:8);

ICB4 sense: 5′-GAGCCCTTCTCATTGGCCAGATTCCCTG-3′ (SEQ ID NO:9), and antisense: 5′-CAGGGAATCTGGCCAATGAGAAGGGCTC-3′ (SEQ ID NO:10).

Oligonucleotides corresponding to mdr1 sense:

5′-GTGGTGAGGCTGATTGGCTGGGCAGGAA-3′ (SEQ ID NO:11), antisense:

5′-TTCCTGCCCAGCCAATCAGCCTCACCA-3′ (SEQ ID NO:12); hOGG1 sense:

5′-ACCCTGATTTCTCATTGGCGCCTCCTACCTCCTCCTCGGATTGGCTACCT-3′ (SEQ ID NO:13), antisense:

5′-AGGTAGCCAATCCGAGGAGGAGGTAGGAGGCGCCAATGAGAAATCAGGGT-3′ (SEQ ID NO:14); cdc2/cdk1 sense: 5′-CGGGCTACCCGATTGGTGAATCCGGGGC-3′ (SEQ ID NO:15), antisense: 5′-GCCCCGGATTCACCAATCGGGTAGCCCG-3′ (SEQ ID NO:16) and cyclin B1 CCAAT box 1 sense: 5′-GACCGGCAGCCGCCAATGGGAAGGGAGTG-3′ (SEQ ID NO:17), antisense: 5′-CACTCCCTTCCCATTGGCGGCTGCCGGTC-3′ (SEQ ID NO:18) and CCAAT box 2 sense: 5′-CCACGAACAGGCCAATAAGGAGGGAGCAG-3′ (SEQ ID NO:19), antisense: 5′-CTGCTCCCTCCTTATTGGCCTGTTCGTGG-3′ (SEQ ID NO:20) are also used for EMSA. Oligonucleotides containing mutated ICBs are used as specific competitors of similar sequence, except the wild-type ICB sequence is replaced by AAACC or GGTTT, in sense and antisense oligonucleotides, respectively. Sense and antisense oligonucleotides are annealed in an equimolar ratio. Double stranded oligonucleotides are 5′ end labeled with T4 kinase (NEB) using γ-³²P-ATP and subsequently purified on Bio-Gel P-6™ columns (BIO-RAD). EMSAs are essentially performed as described in Firth, Proc. Natl Acad Sci USA (1994) 91:6496-6500. Briefly, 5 μg nuclear extract in a total volume of 10 μl is incubated at 4° C. for 30 min in a buffer containing 20 mM K-Hepes pH 7.9, 1 mM MgCl₂, 0.5 mM K-EDTA, 10% glycerol, 50 mM KCl, 0.5 mM DTT, 0.5 μg poly(dI-dC), poly(dI-dC) (Pharmacia) and 1× protease inhibitor mix (COMPLETE™, Boehringer). For supershifts, antibodies against NF-YA (IgG fraction, Rocklands) are used and the pre-incubation on ice is extended for a total of 1.5 hr. Upon addition of approximately 0.1 ng radio-labeled probe the incubation is continued for 2 hours at room temperature. In competition experiments, radiolabeled probe and competitor are added simultaneously. Subsequently, 0.5 μl loading buffer (25 mM Tris-Cl pH 7.5, 0.02% BFB and 10% glycerol) is added and the samples are separated on a 4% poly-acrylamide gel in 0.5×TBE containing 2.5% glycerol at 4° C. After drying the gels the radioactive signal is visualized by exposing the gels to Kodak X-OMAT-LS™ film.

The successful compound or compounds are then further tested; if no successful compound is found, the process is repeated, starting from the design of discrete molecules or libraries. The further testing involves footprinting showing with or without protein.

The assay is performed essentially as described above but with the modification that, in this assay path, a ChiP assay or a microarray is used to determine selectivity. In one exemplary protocols for practicing the ChiP assay, immunoprecipitations are carried out essentially as described by Boyd, Proc. Natl. Acad Sci USA (1998) 95:13887-13892, with a few modifications. Cells are cultured and treated in 150 mm plates and treated with 1% formaldehyde to induce the cross-linking reaction. Treatment with 0.125 M glycine stopped the reaction and cell pellets are stored at −20° C. until analysis. In order to analyze, cells are re-suspended in lysis buffer (LB) (5 mM Pipes pH 8.0, 85 mM KCl, 0.5% NP40, 1x protease inhibitor cocktail (Sigma)) containing 0.5 mM PMSF. Subsequently, nuclei extracted using a Dounce homogenizer are re-suspended in sonication buffer (SB) (50 mM Tris HCl pH 8.0, 10 mM EDTA, 0.1% SDS, 0.5% deoxycholic acid, 1× protease inhibitor cocktail) and sonicated into 500-1,500 bp chromatin fragments. The chromatin fragments are stored at −80° C. pending further analysis. 15 μl Of protein G (Kierkegaard Perry Lab) are pre-cleared overnight with 1 μg/μl salmon testis DNA and 1 μg/μl BSA in immunoprecipitation (IP) buffer (50 mM Tris HCl pH 8.0, 10 mM EDTA, 0.1% SDS, 0.5% deoxycholic acid, 1× protease inhibitor cocktail, 150 mM LiCl). Chromatin (25-50 μl) is also pre-cleared by incubating for 2 hrs with 40 μl of protein G slurry in IP at 4° C. The pre-cleared chromatin is placed in pre-siliconated 0.5 ml PCR tubes, up to 8 μg of antibody is added (200 μl final volume) and the mixture incubated overnight at 4° C. Subsequently, 110 μl of the salmon testis DNA- and BSA-saturated protein G in IP is added to the chromatin-antibody mixture and the samples are further incubated for 2 hr at 4° C. The samples are centrifuged at 4,000 rpm for 2 min and the supernatant stored at −20° C. as a source of ‘input DNA’. The resin is washed initially at 4° C. for 30 min using 300 μl IP. Subsequently, nine more washes are carried out by re-suspending the resin in 300 μl IP and centrifuging for 2 min at 4,000 rpm. The bound DNA is then eluted from the resin by adding 100 μl of elution buffer (EB) (1% SDS, 50 mM NaHCO₃, 1.5 ng/μl salmon testis DNA) and incubating for 1 hr at 37° C. on a shaker. After centrifugation at 14,000 rpm for 2 min the supernatant and the input DNA are both incubated overnight at 65° C. with 10 μg RNase A and 200 mM NaCl in order to reverse the cross-links. Following this, the DNA is precipitated with 99% ethanol at −20° C. The pellets are collected by centrifugation at 13,000 rpm for 30 min, washed with 70% ethanol and air-dried. The protein is removed from the DNA by re-suspending the pellets in 40 μg of proteinase K, 25 μl of proteinase K buffer (1.25% SDS, 50 mM Tris pH 7.5, 25 mM EDTA) and 100 μl TE pH 7.5 and incubating at 42° C. for 2 hr. Digested protein is removed with phenol:chloroform:isoamyl alcohol (25:24: 1) and the DNA precipitated at −20° C. overnight with 30 μl 3 M sodium acetate, 1 μl 5 mg/ml tRNA and 750 μl 99% ethanol. The sample DNA pellets are re-suspended in 60 μl sterile water and the input DNA in 200 μl. The DNA is then used for PCR using 2 μl DNA/sample.

In one aspect, a compound is considered sufficiently positive in this series of test sequences for transcriptional regulatory region targeting (e.g., promoter-targeting) compounds when at least about 5%, 10%, 20%, 30%, 40%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of transcription is blocked in an assay; or, at least about 5%, 10%, 20%, 30%, 40%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of a protein is bound (e.g., “withheld” or “retarded” in a gel assay) by oligonucleotide in a gel shift or equivalent assay.

A compound that is sufficiently positive in this series of test sequences for promoter-targeting compounds is then subjected to in vitro and/or in vivo assays for the condition to be treated. These development assays are standard in the art, and are further discussed below. All successful compounds, whether emerging from the promoter-targeting stream or the coding sequence targeting-screen are further tested as thus described.

Next Steps—Coding Sequence Targeting Compounds

Turning now to the alternative aspects of the methods, or sequences, of the invention based on interaction with the coding sequence, e.g., as shown in FIG. 1 or FIG. 11, a discrete molecule or compounds that have sufficient affinity as shown in a footprinting analysis, e.g., the automated footprinting gel analysis described above, are subjected to further testing. In one aspect, if no satisfactory compounds are found, the sequence is repeated, beginning with the design of compounds or libraries.

In alternative embodiments, e.g., as shown in FIG. 1 or FIG. 11, the series of testing steps is different for the discrete compound stream as compared to the library stream. The only further assay in the discrete compound stream, for those compounds that are cross-linking agents, is a cellular cross-linking assay. In one aspect, this is conducted as follows. The details of the exemplary Single Cell Gel Electrophoresis (comet) assay to measure DNA interstrand crosslinks are described in detail, e.g., in Hartley, Clin. Cancer Res. (1999) 5:507-512; Spanswick, V. J., et al., in Brown, R., Boger-Brown U, Methods in Molecular Medicine, vol. 28: Cytotoxic Drug Resistance Mechanisms, New York: Humana Press (1999) p. 143-154. All procedures performed on the sample single cell suspension are carried out on ice and in subdued lighting. All chemicals used are obtained from Sigma Chemical Co.(Poole, U.K.) unless otherwise stated. Immediately before analysis, cells are irradiated (10 Gy) to deliver a fixed number of random DNA strand breaks. After embedding cells in 1% agarose on a precoated microscope slide, the cells are lysed for one hour in lysis buffer (100 mM disodium EDTA, 2.5 M NaCl, 10 mM Tris-HCl pH 10.5) containing 1% Triton X-100 added immediately before analysis, and then washed for one hour in distilled water, changed every 15 minutes. Slides are then incubated in alkali buffer (50 mM NaOH, 1 mM disodium EDTA, pH 12.5) for 45 minutes followed by electrophoresis in the same buffer for 25 minutes at 18 V (0.6 V/cm), 250 mA. The slides are finally rinsed in neutralizing buffer (0.5 M Tris-HCl, pH 7.5) then saline.

After drying, the slides are stained with propidium iodide (2.5 μg/mL) for 30 min then rinsed in distilled water. Images are visualized using a NIKON inverted microscope with a high-pressure mercury light source, 510-560 nm excitation filter and 590 nm barrier filter at 20× magnification. Images are captured using an on-line CCD camera and analyzed using Komet Analysis software (Kinetic Imaging, Liverpool, U.K.). For each duplicate slide, 25 cells are analyzed. The tail moment for each image is calculated using the Komet Analysis software as the product of the percentage DNA in the comet tail and the distance between the means of the head and tail distributions, based on the definition of Olive, Radiat Res. (1990) 122:86-94. Crosslinking is expressed as the percentage decrease in tail moment compared to irradiated controls calculated by the formula:

$$\% decrease in tail moment = [ 1 - ( \frac{TMdi - TMcu}{TMci - TMcu} ) ] \times 100$$

where
TMdi=tail moment of drug-treated irradiated sample
TMcu=tail moment of untreated, unirradiated control
TMci=tail moment of untreated, irradiated control

As shown in FIG. 1 or FIG. 11, in some embodiments, with respect to libraries in the coding sequence stream or compounds that are not cross-linking agents, compounds with successful affinities in the footprinting gel analysis are subjected to an in vitro transcription assay to assess their ability to block transcription, then to Q-PCR, and then to a reporter assay.

In some embodiments, this is done from a reverse transcriptase (RT) and real-time polymerase chain reaction. In one aspect, RT is carried out essentially as described in the Promega Protocols and Applications Guide, 3^{rd} Edition, 1996. Briefly, RNA is extracted from cells using the RNeasy Mini Kit (Qiagen). Samples are re-suspended in RLT buffer before homogenizing and applying to the supplied columns. The bound RNA is washed with buffer RPE and eluted in nuclease-free water. The concentration of purified RNA is determined by measuring the optical density at 260 nm. Subsequently, the reverse transcription reaction is carried out at 48° C. for 45 min using 5 μg of RNA, 4 μl AMV-RT enzyme (Promega), 2 μl RNasin—RNase Inhibitor (Promega), 8 μl RT buffer, 4 μl 10 mM dNTPs (Promega), 8 μl oligo dTs₍₁₂₋₁₈₎ (Invitrogen) and nuclease-free water in a final volume of 40 μl. AMV-RT enzyme is inactivated by heating the reaction mix at 94° C. for 2 min.

Real-Time PCR is carried out using the ABI PRISM 7000 Sequence Detection System from Applied Biosystems, UK. Respectively, the forward and reverse topo IIα primers used are: 5′-ATTGAAGACGCTGCTTCGTTATGGG-3′ (SEQ ID NO:21) and 5′-GATGGATAAAATTAATCAGCAAGCCT-3′ (SEQ ID NO:22). The probe sequence (CAGATCAGGACCAAGATGGTTCCCACATC) (SEQ ID NO:23) used for the reactions is labeled at the 5′ end with 6-FAM and TAMRA at the 3′ end. The cycling conditions used are 50° C. for 2 minutes and 95° C. for 10 minutes to allow denaturation to occur and 40 cycles of 95° C. for 15 seconds and 58° C. for 1 minute to amplify the target sequences. 1.25 μl of a GAPDH primer/probe master mix (Applied Biosystems, UK) is used as an internal control in all reactions. The reaction mix is prepared using 12 μl of the Taqman PCR master mix (Applied Biosystems, UK) and 1 μM of each primer, 0.2 μM probe and 2.5 μl of cDNA template in a final volume of 25 μl. The results are analyzed using the mathematical quantification approach described by Pfaffl (2001) and ABI User Bulletins #2 and #5 (2001). This is based on the relative expression ratio of the target gene (topo IIα) as compared to that of an internal control gene (GAPDH). Standard curves are constructed for both the internal and reference genes and slopes of these are used to ensure that both primer sets are equally efficient. The threshold cycle values (Ct) and the efficiencies of the reactions are used to compare the relative expression levels of the target gene in various samples. In order to ease comparison, levels of topo IIα RNA in untreated, exponentially growing cells are set at a value of 1 and all test samples expressed at values relative to this.

In one aspect, successful library members are subjected to quantitative PCR (QPCR), see, e.g., Jung, Clin. Chem. Lab Med. (2000) 38:833-836. The skilled artisan can select and design suitable oligonucleotide amplification primers for, e.g., QPCR. Amplification methods are also well known in the art, and include, e.g., polymerase chain reaction, PCR (see, e.g., PCR Protocols, A Guide To Methods And Applications, ed. Innis, Academic Press, N.Y. (1990) and PCR Strategies (1995), ed. Innis, Academic Press, Inc., N.Y. An exemplary quantitative PCR (QPCR) protocol that can be practiced as a part of the methods of the invention can be conducted as follows:

In one aspect, MCF7 cells are cultured in MEM supplemented with 10% FCS, 20 Mm L-Glutamine and 1% non-essential amino acids, PC3 cells are cultured in Ham's F12 supplemented with 7% FCS and 20 mM L-glutamine and DU145 cells are cultured in DMEM supplemented with 10% FCS and 20 mM L-glutamine. All cell lines are maintained at 37° C., in a 5% CO2 atmosphere and 5% relative humidity.

Cells are seeded into 6 well culture plates, 8×10⁵ cells/well. After allowing cells to adhere overnight, drug solutions in 2% DMSO (1/10 v/v) are added to the wells. 2% DMSO is included as a control. Plates are incubated for the appropriate durations at 37° C., in a 5% CO2 atmosphere and 5% relative humidity.

Cells are harvested by removal of the drug and growth media and washing with PBS. The cells are lysed in situ on the cell culture plate by the addition of 350 μl of lysis buffer RLT. Samples are then either processed immediately or stored at −20° C. to be processed as part of a batch.

In one aspect, total RNA is extracted using the RNAEASY MINIPREP™ (RNeasy Miniprep, Cat. No. 74104; Qiagen, Valencia, Calif.) column system as per the instructions included in the kit. The total RNA is eluted in a total volume of 50 μl of RNase free water in a two step procedure in which the first eluate is re-applied to the silica matrix. The RNA is quantitated using a florescent intercalator and used immediately in a reverse transcription reaction to generate cDNA. Any remaining RNA is kept at −20° C. for long term storage.

In one aspect, RNA is quantitated using the RIBO GREEN RNA QUANTITATION KIT™ (Ribo Green RNA Quantitation kit; Molecular Probes—Invitrogen, Carlsbad, Calif., Cat. No. R-11490) against a high range standard curve, as per the instructions included with the product. All total RNA is diluted by a factor of 1: 100 in RNase free TE prior to being assayed using the kit. The level of total RNA in a sample is calculated using the Prism graphical package.

Total RNA is brought to a final volume of 12 μl in RNase free dH₂O, at a final concentration of 1.4 μg/μl. The RNA is denatured by heating at 65° C. for 10 minutes in an ABI 9700 thermal cycler before being plunged on ice for two minutes. Following this, 8 μl Qiagen OMNISCRIPT™ mix (Qiagen Cat. No. 205111) containing oligo dT₆ primers (Applera UK, Cat. No. N808-0128) is then added to each of the RNA samples. cDNA synthesis is carried out at 37° C. for one hour on an ABI 9700 thermal cycler. The cDNA is stored at 4° C. for no longer than 1 month before use.

Quantitative PCR reactions are set up in a total volume of 100 μl using the following reaction mix; 50 μl of Jump Start Taq Ready Mix (Sigma Cat. No. D7440), 1 μl of ROX passive reference dye pre-diluted 1:16 in DNase free dH₂O (Sigma Cat. No. R4528), 1 μl of cDNA sample, 43 μl of DNase free dH₂O and 5 μl of each Taqman primer. With the exception of the primer sets from Applied Biosystems for the three gene targets BCL-2a, PKC alpha and Androgen Receptor (Applera UK Cat. Nos. HS00153350_ml, HS00176973_ml and HS00171172_m1, respectively) which are supplied pre-diluted, oligonucleotides corresponding to the housekeeping genes are diluted to a final concentration of 900 nM and 250 nM primers and probe respectively. All reactions are analysed in triplicate on a 96 well optical reaction plate sealed with optical adhesive covers (Applera UK Cat. Nos. 4306737 and 4311971). The reactions are performed on an ABI 7500 quantitative PCR machine using set cycling parameters of an initial denaturation step of 95° C. for two minutes followed by 45 cycles of a three temperature program involving a 95° C. denaturation step for 15 seconds, a 60° C. annealing step for 1 minute followed by a extension step of 72° C. for 1 minute.

All QPCR data is analysed as part of a relative quantitation study using both a housekeeping gene as a calibrator and untreated cells as a control population. ΔCt values are worked calculated relative to a housekeeping gene within a drug treated sample before being referenced against the identical gene in a control non-drugged cell sample to calculate the final ΔΔCt value. The fold difference in gene expression compared to control is derived using the calculation 2-^{ΔΔCt} with ΔΔCt+s and ΔΔCt−s where s is the standard deviation of the ΔΔCt value. All Ct values are extracted from raw fluorescent data using Real-Time sequence detection software (version 1.2.3) from Applied Biosystems. Where possible, the baseline threshold and estimation of crossing point (Ct) are standardised within an experimental set.

Treatment of Successful Candidates

As described above, FIGS. 1, 2 and 11 are flowcharts showing exemplary methods of the invention of applying successive assay methods to identify candidate compounds which are expected to be successful therapeutics in treating diseases, conditions and/or infections regulated (or mediated) by a target gene (including, for example, potentiating the action of another drug, or decreasing the side effects of another drug). As noted in the Figures, in alternative aspects, at any step in the process failure to find a successful compound in a particular assay will lead the practitioner to return to the design step and reconstruct a library or prepare a new discrete compound. However, compounds which are successful in each of the tests along any of the individual pathways illustrated in FIGS. 1, 2 or 11, are then considered successful candidates and are subjected to standard evaluations.

The foregoing paragraphs provide a description of exemplary methods of the invention that can be employed in each sequence of steps to identify compound candidates according to the invention. In one aspect, the successful candidate is then subjected to in vitro or in vivo assays specific for the condition to be treated. For example, in some aspects for certain cancers in vivo models are used. In the course of these models, a maximum tolerated dose is also determined. The procedures can include the following exemplary in vivo test:

LOX IMVI malignant amelanotic melanoma and OVCAR-5 ovarian adenocarcinoma cells line are purchased from the National Cancer Institute (Frederick, Md.). Animals: Nude female immunodeficient mice (aged 6-12 weeks) are routinely used (B&K Universal, Hull U.K.). All animal procedures are carried out under the 1997 UKCCCR guidelines on the welfare of animals in experimental neoplasia (Workman, et al., 1998).

Prior to undertaking chemotherapy studies for each compound a maximum tolerated dose (MTD) is defined for a single intravenous injection.

For determination of maximum tolerated dose, compounds are reconstituted at the desired dose in 5% DMA/95% physiological saline. Two mice are treated with test agent and 2 mice are treated with vehicle alone (5% DMA/95% saline), via an intravenous (i.v., or IV) tail vein injection in a volume of 0.1 ml per 10 g body weight (Prior to i.v. injection the tail vein is warmed briefly until the vein is observed to dilate).

Body weight is measured daily and behavior and general appearance monitored visually. If body weight loss is >15% over 72-hour period or if animal behavior and appearance are altered, then mice will be immediately sacrificed by Schedule 1 method (Cervical Dislocation). If no deleterious effects are seen after 14 days, then the procedure will be terminated by Schedule 1 method and the dose considered non-toxic. A dose escalation scheme (1.5-2× increase/decease on previous dose) is used.

Solid tumor propagation and transplantation is conducted under brief anesthesia (isoflurane). The mouse flank is sterilized using 70% alcohol. Using a 3 mm trocar, a tumor fragment of less than 3 mm diameter is inserted subcutaneously into the left &/or right flank. (To initiate tumor passaging, no more than 10⁷ cells in 200 ul are injected into the left and/or right flank subcutaneously).

Five times a week mice are weighed and tumor growth is measured using calipers. Once tumors have reached a considerable size (<17 mm) mice are euthanized by Schedule 1 method and tumor material removed and passaged again for chemotherapy studies or alternatively propagated to maintain the tumor in vivo.

LOX IMVI/OVCAR-5 tumor fragments are implanted subcutaneously in nude mice (as described above). Mice are treated with test compound (n=8) at a previously established single i.v MTD using 5% DMA/95% saline as a vehicle. Control mice (n=8) are treated with vehicle alone.

Treatment is commenced when tumors can be reliably measured using calipers (mean dimensions 4×4 mm) and therapeutic effects are assessed by caliper measurements of the tumor (5 times weekly). Mouse weights are also documented. Once tumors have doubled in volume, or grown beyond a length of 17 mm in any direction, animals will be killed by Schedule 1 method. Tumor volumes are determined by the formula a² x b/2 where “a” is the smaller and “b” is the larger diameter of the tumor. Graphs are plotted of relative tumor volume against time and anti-tumor activities assessed by Mann-Whitney analysis. See, e.g., Workman, et al., United Kingdom Co-Ordinating Committee on Cancer Research (UKCCCR) Guidelines for the Welfare of Animals in Experimental Neoplasia (Second Edition); Marie Suggitt, British Journal of Cancer (1998) 77:1-10.

The following describes exemplary general methods that can be used in the steps of the methods of the invention, e.g., as described above, and in FIGS. 1, 2, and 11:

Fluorescence Activated Cell Sorting (FACS). In alternative embodiments, methods of the invention incorporate use of FACS, or other fluorescence-based assays, for determining and/or validating targets identified by the methods of the invention; see, e.g., the exemplary methods illustrated in FIG. 11. One exemplary FACS protocol is: Cells are collected for FACS analysis using trypsin. If necessary, cells are fixed using a mixture of 70% ethanol (7 ml) and PBS/0.02% sodium azide (PBS-A) (1 ml) and analyzed within a week of fixation. Cells are stained using propidium iodide (Sigma). Briefly, cells are washed with PBS-A before re-suspending the cell pellet in 50 μl of 1 mg/ml propidium iodide, 25 μl of 10 mg/ml Ribonuclease A and 925 μl of PBS-A. Cells are gently mixed and incubated at 4° C. for 30 min before analyzing using flow cytometry.

Western blot analysis. In alternative embodiments, methods of the invention incorporate use of Western blots for determining and/or validating targets identified by the methods of the invention; see, e.g., the exemplary methods illustrated in FIG. 11. One exemplary Western blot analysis protocol is: 50 μg nuclear extract is denatured by heating for 3 min at 95° C. in sample buffer containing 100 mM Tris-Cl pH 6.8, 4% SDS, 10% 2-mercaptoethanol, 20% glycerol and 0.02% bromophenolblue (BFB). BIO-RAD high range SDS-PAGE molecular weight standards are used as a reference. Proteins are separated on a 7% SDS-polyacrylamide mini gel (MINI PROTEAN II™ system, BIO-RAD) and subsequently transferred (TRANS BLOT CELL™, BIO-RAD) to polyvinylidene difluoride (PVDF) membranes (IMMOBILON-P™, Millipore). Western blot analysis is performed with the IHIC8 rabbit polyclonal topoisomerase IIα antibody at a 1:5000 dilution using a ECL Western blot detection kit and protocol (Amersham) using 1% blot qualified BSA (Promega) as blocking reagents and TBS plus 0.5% Tween 20 (BDH) as a buffer. The chemiluminescent signal is visualized by exposing the blots to X-OMAT-LS™ (X-Omat-LS, Kodak) film.

The following examples are offered to illustrate, but not to limit the claimed invention.

### EXAMPLES

### Example 1

### Synthesis of Key Intermediates

The following example provides exemplary methods to synthesize intermediates of compounds that, in alternative embodiments, can be used to practice the methods of the invention.

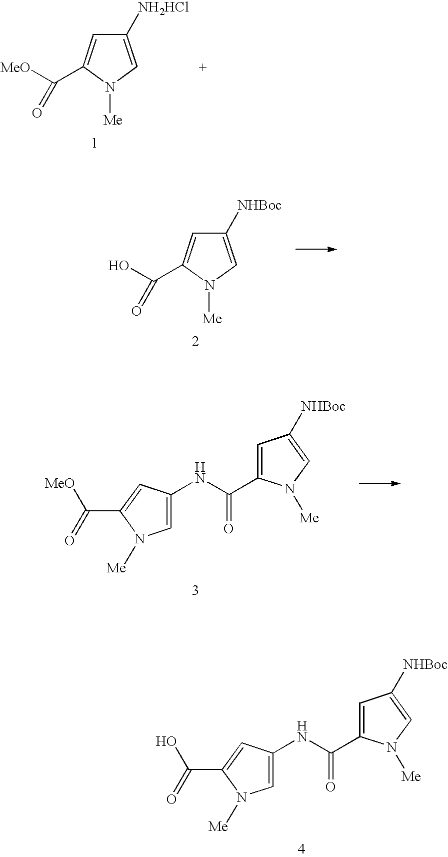

### (i) Methyl 4-[(4-tert-butoxycarbonylamino-1-methyl-1H-pyrrole-2-carbonyl)-amino]-1-methyl-1H-pyrrole-2-carboxylate (3)

The Boc protected pyrrole acid (2) (0.25 g, 1.05 mmol) and the methylpyrrole carboxylate (1)(0.20 g, 1.05 mmol, 1 equiv.) were dissolved in dry DMF (5 mL) with stirring. This solution was treated with EDCI (0.403 g, 2.1 mmol, 2 equiv.) and DMAP (0.320 g, 2.6 mmol, 2.5 equiv.) then stirred over night at room temperature. The reaction mixture was 1325 diluted with EtOAc (50 mL) and washed with 10% HCl solution (3×50 mL) and saturated NaHCO₃ solution (3×50 mL), dried over MgSO₄ and concentrated in vacuo to give an off white foam, 0.368 g (94%). Mpt 78° C. (lit 78-79° C.); ¹H NMR d₆-DMSO δ 9.85 (1H, s, N—H), 9.09 (1H, s, Boc-N—H), 7.46 (1H, s, Py-H), 6.92 (1H, s, Py-H), 6.91 (1H, s, Py-H), 6.85 (1H, s, Py-H), 3.82 (3H, s, N—CH₃), 3.75 (3H, s, N—CH₃), 3.58 (3H, s, O—CH₃), 1.48 (9H, s, Boc-H).

### (ii) 4-[(4-tert-Butyloxycarbonylamino-1-methyl-1H-pyrrole-2-carbonyl)-amino]-1-methyl-1H-pyrrole-2-carboxylic acid (4)

A stirred solution of Boc pyrrole dimer (3)(0.805 g, 2.1 mmol) in MeOH (40 mL) was treated with 1M NaOH solution (25 mL). The reaction mixture was stirred at room temperature for 18 hours. The volume was reduced in vacuo and the aqueous solution extracted with EtOAc (50 mL). The solvent was removed from the EtOAc fraction and the residue was treated with 1M NaOH solution (10 mL) for a further 3 hours. This was combined with the previous aqueous fraction and acidified to pH2-3 with 1 M HCl solution and the suspension extracted with EtOAc (3×75 mL). The organic fractions were combined, dried over MgSO₄ and concentrated in vacuo to give a yellow foam 0.781 g (100%). ¹H NMR d₆-DMSO δ 12.07 (1H, bs, OH), 9.81 (1H, s, N—H), 9.08 (1H, s, N—H), 7.40 (1H, d, J=1.9 Hz, Py-H), 6.88 (1H, s, Py-H), 6.84 (1H, s, Py-H), 6.83 (1H, s, Py-H), 3.81 (3H, s, N—CH₃), 3.80 (3H, s, N—CH₃), 1.45 (9H, s, Boc-H); ¹³C NMR d₆-DMSO δ 171.9, 161.9, 158.3, 152.8, 122.6, 122.3, 120.2 (CH), 119.4, 117.0 (CH), 108.3 (CH), 103.7 (CH), 78.3, 36.1 (CH₃), 36.1 (CH₃), 28.1 ([CH₃]₃).

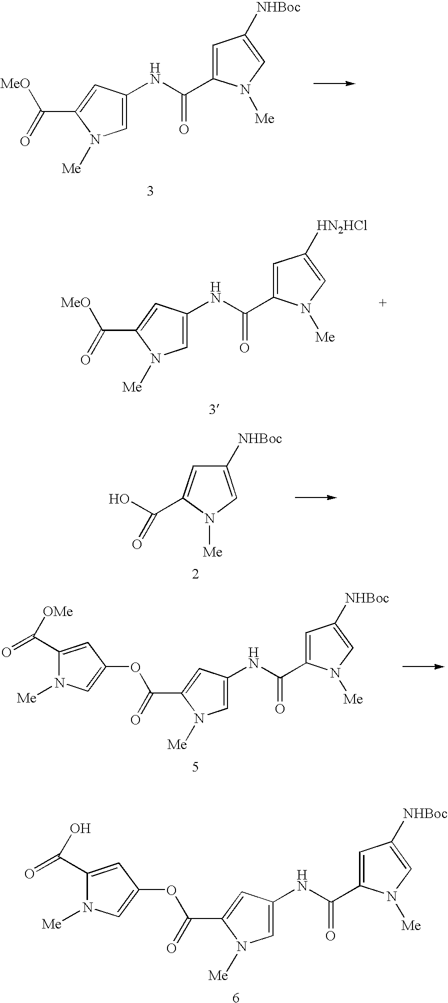

### (iii) Methyl 4-({4-[(4-tert-butoxycarbonylamino-1-methyl-1H-pyrrole-2-carbonyl)-amino]-1-methyl-1H-pyrrole-2-carbonyl}-amino)-1-methyl-1H-pyrrole-2-carboxylate (5)

The Boc protected pyrrole dimer (3) (0.25 g, 0.66 mmol) was placed in a dry round bottomed flask and treated with 4 M HCl in dioxane (5 mL). The resulting solution became cloudy over a period of 30 minutes. The solvent was removed in vacuo to give a yellow solid (3′) which was then dried under vacuum. The residue was dissolved in dry DMF (9 mL) and the Boc pyrrole acid (2) (0.176 g, 0.726 mmol, 1.1 equiv.) was added followed by EDCI (0.191 g, 0.99 mmol, 1.5 equiv.) and DMAP (0.097 g, 0.79 mmol, 1.2 equiv.). The reaction mixture was stirred at room temperature for 18 hours then diluted with EtOAc (50 mL) and washed with 1 M HCl soln (3×50 mL), then saturated NaHCO₃ solution (3×50 mL), dried over MgSO₄ then concentrated in vacuo to give a tan foam. This solid was suspended in a 1:1 mixture of MeOH and 1 M NaOH solution (40 mL) and stirred at room temp for 30 minutes. EtOAc was added and the organic layer washed with saturated NaHCO₃ solution (3×50 mL) and dried over MgSO₄. Concentration in vacuo gave an off white foam 0.160 g (48%). Mp 134° C. (lit 131-133° C.); ¹H NMR d₆-DMSO δ 9.90 (1H, s, N—H), 9.86 (1H, s, N—H), 9.13 (1H, s, Boc-N—H), 7.46 (1H, d, J=1.9 Hz, Py-H), 7.21 (1H, d, J=1.7 Hz, Py-H), 7.06 (1H, d, J=1.7 Hz, Py-H), 6.91 (1H, s, Py-H), 6.90 (1H, s, Py-H), 6.85 (1H, s, Py-H), 3.84 (6H, s, N—CH₃), 3.81 (3H, s, N—CH₃), 3.74 (3H, s, O—CH₃), 1.46 (9H, s, Boc-H).

### (iv) 4-({4-[(4-tert-butoxycarbonylamino-1-methyl-1H-pyrrole-2-carbonyl)-amino]-1-methyl-1H-pyrrole-2-carbonyl}-amino)-1-methyl-1H-pyrrole-2-carboxylic acid (6)

The Boc pyrrole trimer (5)(0.6 g, 1.2 mmol) was dissolved in MeOH (5 mL) and treated with NaOH solution (0.1 g in 5 mL H₂O). The reaction mixture was stirred overnight then heated at 60° C. for 2 hours. The MeOH was removed in vacuo and the aqueous fraction extracted with EtOAc (25 mL). The aqueous layer was adjusted to pH 2-3 with 1 M HCl solution then extracted with EtOAc (3×30 mL). The combined organic layers were dried over MgSO₄ then concentrated in vacuo to give an orange solid. The solid was suspended in Et₂O (10 mL) and collected on a filter then dried in vacuo to give an orange solid 0.431 g (74%). ¹H NMR d₆-DMSO δ 12.11 (1H, s, OH), 9.89 (1H, s, N—H), 9.86 (1H, s, N—H), 9.09 (1H, s, Boc-N—H), 7.43 (1H, d, J=1.9 Hz, Py-H), 7.22 (1H, d, J=1.7 Hz, Py-H), 7.06 (1H, d, J=1.7 Hz, Py-H), 6.90 (1H, s, Py-H), 6.86 (1H, d, J=1.9 Hz, Py-H), 6.84 (1H, s, Py-H), 3.85 (3H, s, N—CH₃), 3.83 (3H, s, N—CH₃), 3.82 (3H, s, N—CH₃), 1.46 (9H, s, Boc-H); ¹³C NMR d₆-DMSO δ 161.9, 158.4, 158.4, 152.8, 122.8, 122.7, 122.5, 122.4, 122.3, 120.2 (CH), 119.5, 118.4 (CH), 117.0 (CH), 108.4 (CH), 104.7 (CH), 103.8 (CH), 78.2, 36.1 (CH₃), 36.0 (CH₃), 28.1 ([CH₃]₃).

### (v) Methyl 4-{[4-({4-[(4-tert-butoxycarbonylamino-1-methyl-1H-pyrrole-2-carbonyl)-amino]-1-methyl-1H-pyrrole-2-carbonyl}-amino)-1-methyl-1H-pyrrole-2-carbonyl]-amino}-1-methyl-1H-pyrrole-2-carboxylate (7)

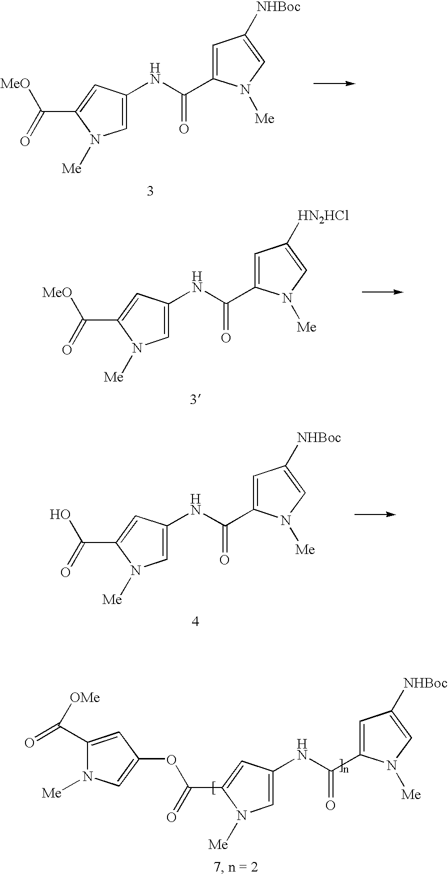

The Boc pyrrole dimer (3) (0.207 g, 0.54 mmol) in a dry round bottomed flask was treated with 4 M HCl in dioxane (5 mL) with stirring. The reaction mixture was stirred for 30 minutes during which time a precipitate (3′) formed. The solvent was removed and the residue dried in vacuo. The residue was dissolved in dry DMF (5 mL) and the Boc pyrrole dimer acid (4) (0.2 g, 0.55 mmol) was added followed by EDCI (0.159 g, 0.83 mmol, 1.5 equiv.) and DMAP (0.081 g, 0.66 mmol, 1.2 equiv.). The reaction mixture was stirred for 48 hours then diluted with EtOAc (50 mL) and washed with 10% HCl solution (3×30 mL) then saturated NaHCO₃ solution (3×30 mL). The organic layer was then dried over MgSO₄ and concentrated under vacuum to give an orange solid 0.310 g (90%). ¹H NMR d₆-DMSO δ 9.93 (2H, s, N—H), 9.86 (1H, s, N—H), 9.08 (1H, s, Boc-N—H), 7.47 (1H, d, J=1.9 Hz, Py-H), 7.23 (1H, d, J=1.8 Hz, Py-H), 7.22 (1H, d, J=1.7 Hz, Py-H), 7.07 (1H, d, J=1.8 Hz, Py-H), 7.05 (1H, d, J=1.8 Hz, Py-H), 6.91 (1H, d, J=1.9 Hz, Py-H), 6.89 (1H, d, J=1.9 Hz, Py-H), 6.84 (1H, d, J=1.7 Hz, Py-H), 3.85 (3H, s, N—CH₃), 3.84 (6H, s, N—CH₃), 3.84 (3H, s, N—CH₃), 3.81 (3H, s, N—CH₃), 3.74 (3H, s, O—CH₃), 1.46 (9H, s, Boc-H).

### (vi) Methyl 4-[(4-{[4-({4-[(4-tert-butoxycarbonylamino-1-methyl-1H-pyrrole-2-carbonyl)-amino]-1-methyl-1H-pyrrole-2-carbonyl}-amino)-1-methyl-1H-pyrrole-2-carbonyl]-amino}-1-methyl-1H-pyrrole-2-carbonyl)-amino]-1-methyl-1H-pyrrole-2-carboxylate (8)

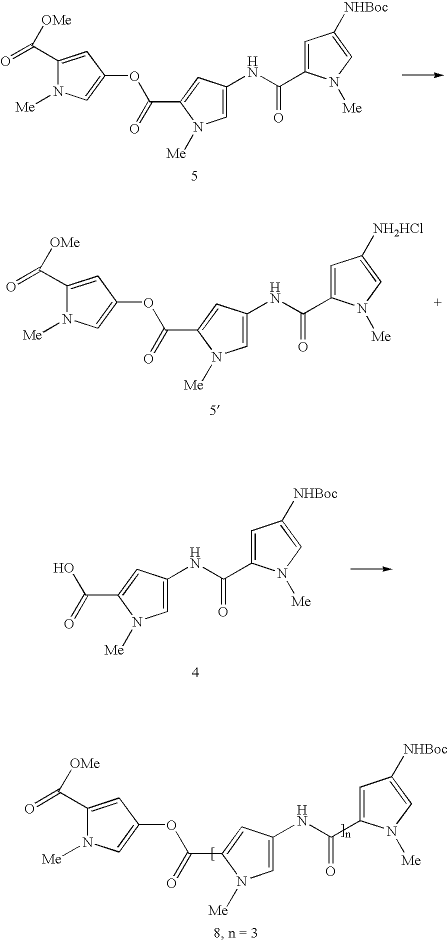

The Boc pyrrole trimer (5)(0.2 g, 0.40 mmol) in a dry round bottomed flask was treated with 4 M HCl in dioxane (5 mL). The solution was stirred for 30 minutes during which time a precipitate (5′) formed. The solvent was removed and the residue dried in vacuo. The residue was dissolved in dry DMF (2.5 mL) and the Boc pyrrole dimer acid [n] (0.144 g, 0.40 mmol, 1 equiv.) was added followed by EDCI (0.115 g, 0.60 g, 1.5 equiv.) and DMAP (0.058 g, 0.47 mmol, 1.2 equiv.). The reaction mixture was stirred for 48 hours then diluted with EtOAc (50 mL) and washed with 10% HCl solution (3×30 mL) then saturated NaHCO₃ (3×30 mL). The organic layer was dried over MgSO₄ then concentrated in vacuo to give an orange solid, 0.253 g (85%). ¹H NMR d₆-DMSO δ 9.95 (1H, s, N—H), 9.93 (2H, s, N—H), 9.86 (1H, s, N—H), 9.08 (1H, s, N—H), 7.47 (1H, d, J=1.9 Hz, Py-H), 7.25 (1H, d, J=2.1 Hz, Py-H), 7.24 (1H, d, J=2.4 Hz, Py-H), 7.23 (1H, d, J=1.7 Hz, Py-H), 7.08 (1H, d, J=1.9 Hz, Py-H), 7.07 (1H, d, J=1.9 Hz, Py-H), 7.07 (1H, d, J=1.9 Hz, Py-H), 6.91 (1H, d, J=2.0 Hz, Py-H), 3.86 (3H, s, N—CH₃), 3.85 (3H, s, N—CH₃), 3.85 (3H, s, N—CH₃), 3.84 (3H, s, N—CH₃), 3.81 (3H, s, N—CH₃), 3.74 (3H, s, O—CH₃), 1.46 (9H, s, Boc-H).

### (vii) Methyl 4-({4-[(4-{[4-({4-[(4-tert-butoxycarbonylamino-1-methyl-1H-pyrrole-2-carbonyl)-amino]-1-methyl-1H-pyrrole-2-carbonyl}-amino)-1-methyl-1H-pyrrole-2-carbonyl]-amino}-1-methyl-1H-pyrrole-2-carbonyl)-amino]-1-methyl-1H-pyrrole-2-carbonyl}-amino)-1-methyl-1H-pyrrole-2-carboxylate (9)

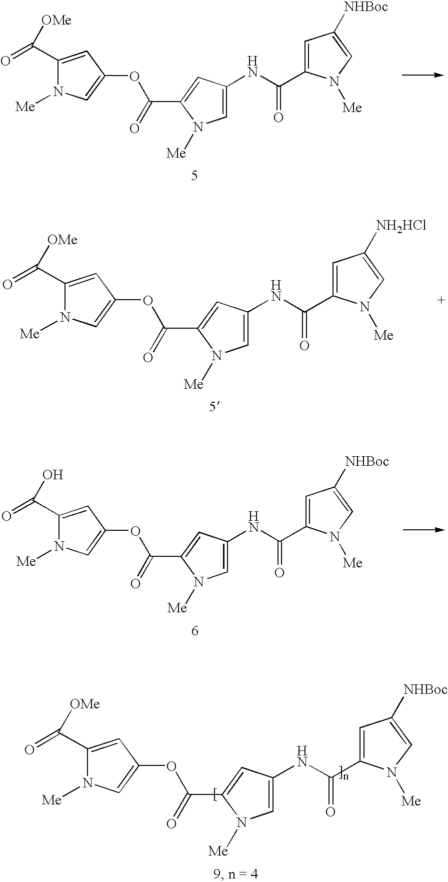

The Boc pyrrole trimer (5)(0.2 g, 0.40 mmol) in a dry round bottomed flask was treated with 4M HCl in dioxane (2.5 mL). The reaction mixture was stirred at room temperature for 30 minutes during which time a precipitate (5′) formed. The solvent was removed and the 1425 residue dried under vacuum. The residue was dissolved in dry DMF (2.5 mL) and the Boc pyrrole trimer acid (6)(0.194 g, 0.40 mmol, 1 equiv.) was added followed by EDCI (0.115 g, 0.6 mmol, 1.5 equiv.) and DMAP (0.058 g, 0.47 mmol, 1.2 equiv.). The reaction mixture was stirred for 48 hours then diluted with EtOAc (50 mL) and washed with 10% HCl solution (3×30 mL) and saturated NaHCO₃ solution (3×30 mL). The organic layer was dried 1430 over MgSO₄ then concentrated in vacuo to give an orange solid 0.185 g (54%). ¹H NMR d₆-DMSO δ 9.95 (2H, s, N—H), 9.93 (2H, s, N—H), 9.86 (1H, s, N—H), 9.08 (1H, s, Boc-N—H), 7.47 (1H, d, J=1.8 Hz, Py-H), 7.25 (1H, d, J=2.2 Hz, Py-H), 7.24 (2H, d, J=2.0 Hz, Py-H), 7.22 (1H, d, J=1.6 Hz, Py-H), 7.07 (2H, d, J=1.6 Hz, Py-H), 7.07 (1H, d, J=2.0 Hz, Py-H), 6.91 (2H, d,J=1.9 Hz, Py-H), 6.89 (1H, s, Py-H), 6.84 (1H, s, Py-H), 3.86 (3H, s, N—CH₃), 3.86 (6H, s, N—CH₃), 3.85 (3H, s, N—CH₃), 3.84 (3H, s, N—CH₃), 3.81 (3H, s, N—CH₃), 3.74 (3H, s, O—CH₃), 1.46 (9H, s, Boc-H).

### (viii) (11S. 11aS)-8-(3-Carboxy-propoxy)-7-methoxy-11-(tetrahydro-pyran-2-yloxy)-1,2,3,10,11,11a-hexahydro-5H-pyrrolo[2,1-c][1,4]benzodiazepine-10-carboxylic acid allyl ester (19)

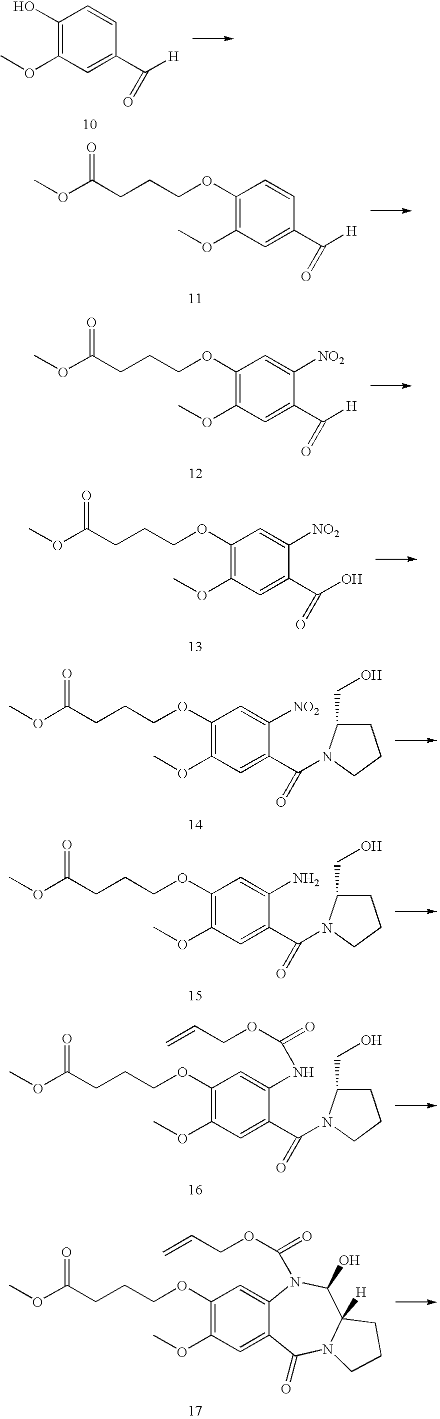

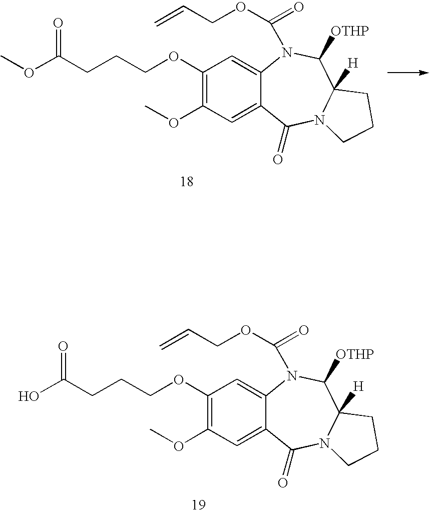

### (α) 4-(4-Formyl-2-methoxy-phenoxy)-butyric acid methyl ester (11)

A slurry of vanillin 10 g, 0.262 mol), methyl-4-bromobutyrate (50 g, 34.2 mL, 1.05 eq) and potassium carbonate (54 g, 1.5 eq) in DMF (200 mL) was stirred at room temperature overnight (16 hours). A large volume of water was added (1 L) whilst stirring. The 1445 white precipitate was filtered, washed with water and dried to yield 40, 60 g (85%). mp 73° C. ¹H NMR (CDCl₃) δ 9.80 (1H, s) 7.43 (2H, m), 6.97 (1H, d, J=8.1 Hz), 4.16 (2H, t, J=6.28 Hz), 3.92 (3H, s), 3.70 (3H, s), 2.57 (2H, t, J=7.15 Hz), 2.20 (2H, p, J=6.71 Hz); ³C NMR (CDCl₃) δ 190.9, 173.4, 153.8, 149.9, 130.1, 126.8, 111.5, 109.2, 67.8, 56.0, 51.7, 30.3, 24.2; IR (golden gate) vₘₐₓ 1728, 1678, 1582, 1508, 1469, 1426, 1398, 1262, 1174, 1133, 1015, 880, 809, 730 cm⁻¹; MS (ES⁺) m/z (relative intensity) 253 ([M+H]⁺, 100).

### (b) 4-(4-Formyl-2-methoxy-5-nitro-phenoxy)-butyric acid methyl ester (12)

A solution of the aldehyde 11 (50 g, 0.197 mol) in acetic anhydride (150 mL) was slowly added to a mixture of 70% nitric acid (900 mL) and acetic anhydride (200 mL) at 0° C. and was then left to stir for 2.5 hours at 0° C. The solution was then poured onto ice in a 5 L flask and the volume adjusted to 5 L with ice and water. The resulting light sensitive pale yellow precipitate was immediately filtered (the ester is slowly hydrolyzed at room temperature in those conditions) and washed with cold water. The product 12 was used directly in the next step. TLC analysis (50/50 EtOAc/Pet Et) proved the product pure. ¹H NMR (CDCl₃) δ 10.4 (2H, s), 7.61 (1H, s), 7.4 (1H, s), 4.21 (2H, t, J=6.2 Hz), 4.00 (3H, s), 3.71 (2H, s), 2.58 (2H, t, J=7.1 Hz), 2.23 (2H, p, J=6.3 Hz); ¹³C NMR (CDCl₃) δ 188.5, 172.8, 152.7, 151.0, 143.5, 124.7, 110.1, 108.2, 68.4, 56.4, 51.3, 29.7, 23.8; MS (ES⁺) m/z (relative intensity) 298 ([M+H]⁺, 100).

### (c) 5-Methoxy-4-(3-methoxycarbonyl-propoxy)-2-nitro-benzoic acid (13)

The slightly wet nitroaldehyde 12 (80 g, wet) was dissolved in acetone (500 mL) in a 2 L flask fitted with a condenser and a mechanical stirrer. A hot solution of 10% potassium permanganate (50 g in 500 mL of water) was quickly added via a dropping funnel (in 5 to 10 minutes). Halfway through the addition the solution began to reflux violently and until the end of the addition. The solution was allowed to stir and cool down for an hour and was then filtered through celite and the brown residue was washed with 1 L of hot water. The filtrate was transferred in a large flask and a solution of sodium bisulfite (80 g in 500 mL 1 N HCl) was added. The final volume was adjusted to 3 L by addition of water, and the pH was adjusted to 1 with concentrated HCl. The product 42 precipitated and it was filtered and dried. 31 g (50% yield over 2 steps). The product was pure as proved by TLC (85/15/0.5 EtOAc/MeOH/Acetic acid). ¹H NMR (CDCl₃) δ 7.33 (1H, s), 7.19 (1H, s), 4.09 (2H, t, J=5.72 Hz), 3.91 (3H, s), 3.64 (3H, s), 2.50 (2H, t, J=6.98 Hz), 2.14 (2H, p, J=6.33 Hz); ¹³C NMR (DMSO-d₆) δ 172.8, 166.0, 151.8, 149.1, 141.3, 121.2, 111.3, 107.8, 68.1, 56.4, 51.3, 29.7, 23.8;IR (golden gate) vₘₐₓ 1736, 1701, 1602, 1535, 1415, 1275, 1220, 1054, 936, 879, 820, 655 cm⁻¹; MS (ES⁻) m/z (relative intensity) 312.01 ([M-H]⁻, 100).

### (d) 4-[4-(2-Hydroxymethyl-pyrrolidine-1-carbonyl)-2-methoxy-5-nitro-phenoxy]-butyric acid methyl ester (14)

The methyl ester 13 (30 g, 95.8 mmol) was suspended in dry DCM (300 mL) with stirring in a round-bottomed flask equipped with a drying tube. Oxalyl chloride (13.4 g, 9.20 mL, 1.1 eq) was added followed by a few drops of DMF. The mixture was stirred overnight at room temperature. Triethylamine (21.3 g, 29.3 mL, 2.2 eq), +(S)-pyrrolidine methanol (9.68 g, 9.44 mL, 1.1 eq) were dissolved in dry DCM (150 mL) under nitrogen. The solution was cooled below −30° C. The acid chloride solution was added dropwise over 6 h maintaining the temperature below −30° C. It was then left to stir overnight at room temperature. The resulting solution was extracted with 1N HCl (2×200 mL), twice with water, once with brine. It was dried with magnesium sulfate and concentrated in vacuo to give a yellow/brown oil 14 which solidified on standing. (Quantitative yield). It was used in the next step without further purification. ¹H NMR (CDCl₃) δ 7.70 (1H, s), 6.80 (1H, s), 4.40 (1H, m), 4.16 (2H, t, J=6.2 Hz), 3.97 (3H, s), 3.97-3.70 (2H, m), 3.71 (3H, s), 3.17 (2H, t, J=6.7 Hz), 2.57 (2H, t, J=7.1 Hz), 2.20 (2H, p, J=6.8 Hz), 1.90-1.70 (2H, m); ³C NMR (CDCl₃) δ 173.2, 154.8, 148.4, 109.2, 108.4, 68.4, 66.1, 61.5, 56.7, 51.7, 49.5, 30.3, 28.4, 24.4, 24.2; IR (golden gate) vₘₐₓ 3400, 2953,1734,1618, 1517,1432,1327,1271, 1219, 1170, 1051, 995, 647 cm⁻¹ MS (ES⁺) m/z (relative intensity) 397.07 ([M+H]⁺, 100); [α]²⁴_{D}=−84° (c=1, CHCl₃).

### (e) 4-[5-Amino-4-(2-hydroxymethyl-pyrrolidine-1-carbonyl)-2-methoxy-phenoxy]-butyric acid methyl ester (15)

The nitro ester 14 (38.4 g, 97 mmol) was dissolved in ethanol (2 batches of 19.2 g in 200 mL ethanol per 500 mL hydrogenation flask). 10% Pd/C was added as a slurry in ethanol (1 g per batch) and the mixture was hydrogenated in a Parr hydrogenation apparatus at 40 psi until no further hydrogen uptake was observed. Reaction completion was confirmed by TLC analysis (EtOAc) and the mixture was filtered through celite. The solvent was removed in vacuo and the amine 15 was used directly in the next step. (35.4 g, quantitative yield).

### (f) 4-[5-Allyloxycarbonylamino-4-(2-hydroxymethyl-pyrrolidine-1-carbonyl)-2-methoxy-phenoxy]-butyric acid methyl ester (16)

A batch of the amine 15 (22.5 g, 61.5 mmol) was dissolved in anhydrous DCM (300 mL) in the presence of anhydrous pyridine (10.9 mL, 134 mmol) at 0° C. Allyl chloroformate (7.17 mL, 67.5 mmol) diluted in anhydrous DCM (200 mL) was added dropwise at 0° C. The resulting solution was allowed to stir overnight at room temperature. It was then washed with cold 1 N aqueous HCl (200 ml), water (200 mL), saturated aqueous NaHCO₃ (200 mL), and brine (200 mL). The solution was then dried (MgSO₄), and the solvent was removed in vacuo to provide 16, slightly contaminated by the product of diacylation (27 g, quantitative yield). A sample was columned (EtOAc/Hexane) to provide the analytical data. ¹H NMR (CDCl₃) δ 8.78 (1H, bs), 7.75 (1H, s), 6.82 (1H, s), 5.97 (1H, m), 5.38-5.34 (1H, dd, J=1.5, 17.2 Hz), 5.27-5.24 (1H, dd, J=1.3, 10.4 Hz, 1H), 4.63 (2H, m), 4.40 (2H, bs), 4.11 (2H, t, J=6.3 Hz), 3.82 (3H, s), 3.69 (4H, m), 3.61-3.49 (2H, m), 2.54 (2H, t, J=7.4 Hz), 2.18 (2H, p, J=6.7 Hz), 1.92-1.70 (4H, m); ¹³C NMR (CDCl₃) δ 173.4, 170.9, 153.6, 150.5, 144.0, 132.5, 132.0, 118.1, 115.4, 111.6, 105.6, 67.7, 66.6, 65.8, 61.1, 60.4, 56.6, 51.7, 30.5, 28.3, 25.1, 24.3; MS (FAB⁺) m/z 50 (451, M+H); IR (golden gate) vₘₐₓ 2949, 2359, 1728, 1596, 1521, 1433, 1202, 1173, 1119, 998, 844, 652 cm⁻¹; [α]²⁶_{D}=−67° (c=0.45, CHCl₃).

### (g) 11-Hydroxy-7-methoxy-8-(3-methoxycarbonyl-propoxy)-5-oxo-2,3,11,11a-tetrahydro-1H,5H-benzo[e]pyrrolo[, 1,2-a][, 1,4]diazepine-10-carboxylic acid allyl ester (17)

Oxalyl chloride (17.87 g, 12.28 mL, 1.8 eq) in dry DCM (200 mL) was cooled to −40° C. (acetonitrile/liquid nitrogen cooling bath). A solution of dry DMSO (16.23 g, 16.07 mL, 3.6 eq) in dry DCM (200 mL) was added dropwise over 2 hours maintaining the temperature below 37° C. A white suspension formed and eventually redissolved. The crude Alloc protected amine 16 (26 g, 57.7 mmol) in dry DCM (450 mL) was added dropwise over 3 hours maintaining the temperature below −37° C. The mixture was stirred at −40° C. for a further hour.

A solution of DIPEA (32.1 g, 43.2 mL, 4.3 eq) in dry DCM (100 mL) was added dropwise over 1 hour and the reaction was allowed to come back to room temperature. The reaction mixture was extracted with a concentrated solution of citric acid in water. (pH 2 to 3 after extraction). It was then washed with water (2×400 mL) and brine (300 mL), dried (magnesium sulfate) and the solvent removed in vacuo to yield a paste which was purified by column chromatography. (70/30 EtOAc/Pet Ether) to yield 46, 17 g (62%); ¹H NMR (CDCl₃) δ7.23 (1H, s), 6.69 (1H, s), 5.80 (1H, m), 5.63 (1H, m), 5.15 (2H, d, J=12.9 Hz), 4.69-4.43 (2H, m), 4.13 (2H, m), 3.90 (4H, m), 3.68 (4H, m), 3.58-3.45 (2H, m), 2.53 (2H, t,J=7.2 Hz), 2.18-1.94 (6H, m); ¹³C NMR (CDCl₃) δ 173.4, 167.0, 156.0, 149.9, 148.7, 131.8, 128.3, 125.9, 118.1, 113.9, 110.7, 86.0, 67.9, 66.8, 60.4, 59.9, 56.1, 51.7, 46.4, 30.3, 28.7, 24.2, 23.1, 21.1; MS (ES⁺) m/z 100 (449.1, M+H); IR (golden gate) vₘₐₓ 2951, 1704, 1604, 1516, 1458, 1434, 1313, 1272, 1202, 1134, 1103, 1041, 1013, 647 cm⁻¹; [α]²⁶_{D}=+122° (c=0.2, CHCl₃).

### (h) (11aS)-7-Methoxy-8-(3-methoxycarbonyl-propoxy)-5-oxo-11-(tetrahydropyran-2-yloxy)-2,3,11,11a-tetrahydro-1H, 5H-pyrrolo[2,1-c][1,4benzodiazepine-10-carboxylic acid allyl ester (18)

Dihydropyran (4.22 mL, 46.2 mmol) was dissolved in EtOAc (30 mL). This solution was stirred 10 minutes in the presence of para-toluenesulphonic acid (catalytic quantity, 20 mg). 17 (2.0 g, 4.62 mmol) was then added in one portion to this solution and allowed to stir for 2 hours. The solution was diluted with EtOAc (70 mL) and washed with saturated aqueous NaHCO₃ (50 mL) followed by brine (50 mL). The organic layer was dried (MgSO₄), and the solvent removed under vacuum. The oily residue was dried under vacuum to remove any remaining DHP. It was proved pure by TLC (EtOAc) and 18, was retrieved in quantitative yield, 2.38 g (100%). It was used directly in the next step. ¹H NMR (CDCl₃) as a mixture of 4/5 of diastereoisomers: δ 7.24-7.21 (2H, s x 2), 6.88-6.60 (2H, s x 2), 5.89-5.73 (4H, m), 5.15-5.04 (6H, m), 4.96-4.81 (2H, m), 4.68-4.35 (4H, m), 4.12-3.98 (4H, m), 3.98-3.83 (8H, m), 3.74-3.63 (8H, m), 3.60-3.40 (8H, m), 2.56-2.50 (4H, m), 2.23-1.93 (12H, m), 1.92-1.68 (10H, m), 1.66-1.48 (20H, m); ¹³C NMR (CDCl₃) δ 173.4, 167.2, 149.1, 132.0, 114.5, 100.0, 98.4, 94.6, 91.7, 68.0, 67.7, 66.3, 63.9, 63.6, 63.3, 62.9, 56.1, 51.6, 51.5, 46.3, 46.3, 31.1, 30.9, 30.7, 30.4, 30.2, 29.0, 25.4, 25.3, 25.2, 24.2, 20.0, 19.8, 19.7; MS (ES⁺) m/z (relative intensity) 533.2 ([M+H]⁺, 100).

### (i) (11aS)-8-(3-Carboxy-propoxy)-7-methoxy-5-oxo-11-(tetrahydropyran-2-yloxy)-2,3,11,11a-tetrahydro-1H,5H-pyrrolo[2,1-c][1,4]benzodiazepine-10-carboxylic acid allyl ester (19)

The methyl ester 18 (2.2 g, 4.26 mmol) was dissolved in MeOH (30 mL). Sodium hydroxide (340 mg, 8.5 mmol) was dissolved in water (7 mL) and added to the ester solution. The reaction mixture was stirred at 70° C. for 15 min. The methanol was then removed under vacuum and water (20 mL) was added. The aqueous solution was allowed to return to room temperature and a 5% aqueous citric acid solution was added to adjust the pH to <4. The precipitate was extracted with EtOAc (100 mL). The organic layer was washed with brine 1570 (30 mL) and dried over MgSO₄. The solvent was removed under vacuum, then diethylether (50 mL) was added to the residue and removed under vacuum, then dried under vacuum to yield the pure 19 as white foam 2.10 g (98%). ¹H NMR (d₆-DMSO) as a mixture of 4/5 of diastereoisomers δ7.10 (2H, s x 2), 6.90-6.84 (2H, s x 2), 5.84-5.68 (4H, m), 5.45-4.91 (6H, m), 4.72-4.30 (4H, m), 4.09-3.93 (4H, m), 3.91-3.75 (8H, m), 3.60-3.44 (4H, m), 3.44-3.22 (8H, m), 2.46-2.33 (4H, m), 2.20-1.76 (14H, m), 1.76-1.31 (12H, m). ¹³C NMR (d₆-DMSO) δ 173.9, 173.9, 171.9, 166.1, 166.0, 149.6, 148.4, 148.3, 132.6, 116.5, 114.4, 110.5, 110.3, 99.2, 67.5, 67.4, 65.6, 65.5, 62.8, 59.4, 55.7, 45.9, 30.5, 30.2, 29.8, 29.7, 28.4, 28.3, 24.9, 24.8, 23.9, 23.8, 22.9, 22.7; MS (ES⁺) m/z (relative intensity) 519.2 ([M+H]⁺, 100). This compound was proved optically pure at C11a by reesterification (EDCI, HOBt, then MeOH), THP removal (AcOH/THF/H₂O) and chiral HPLC, as in Tercel et al., J. Med. Chem., 2003, 46, 2132-2151).

Exemplary Synthesis:

The following is an exemplary synthetic scheme for (11aS) methyl 4-[4-(7-methoxy-5-oxo-2,3,5,11a-tetrahydro-5H-pyrrolo[2,1-c][1,4]benzodiazepine-8-yloxy)-butyrylamino]-1-methyl-1H-pyrrole-2-carboxylate (21, GWL77):

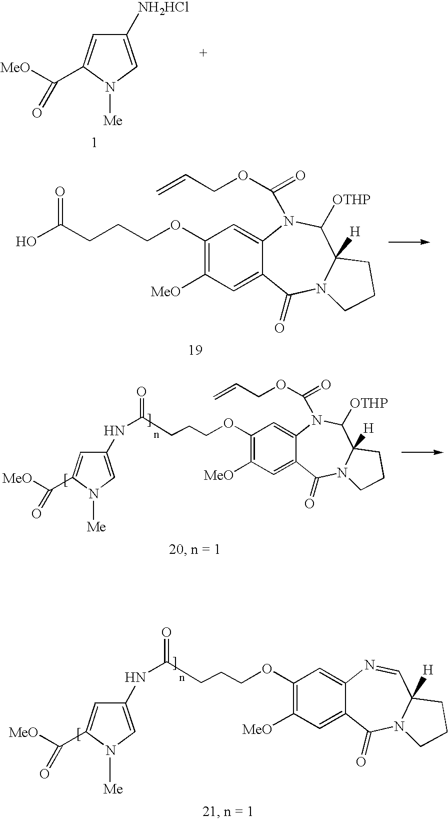

(i) A solution of pyrrole methyl ester (1) (0.055 g, 0.29 mmol) and AllocTHPPBD acid (19) (0.150 g, 0.29 mmol, 1 equiv.) dissolved in dry CH₂Cl₂ (2 mL) was treated with EDCI (0.111 g, 0.58 mmol, 2 equiv.) and DMAP (0.088 g, 0.72 mmol, 2.5 equiv.). The reaction mixture was stirred for 24 hours then the solvent was removed in vacuo and the residue diluted with EtOAc (25 mL) and washed with 1M HCl solution (3×10 mL) then saturated NaHCO₃ solution (3×10 mL). The organic fraction was dried over MgSO₄ and concentrated in vacuo, to give an off white foamy solid (20), 0.167 g (88%). Mixture of diastereomers ¹H-NMR (400 MHz) δ 9.09 (1H, s, N—H), 7.39 (1H, d, J=2.0 Hz, Py-H), 7.14 (1H, s, H-6), 7.12 (1H, s, H-6), 6.96 (1H, s, H-9), 6.76 (1H, d, J=2.0 Hz, Py-H), 5.86-5.75 (3H, m, H-11, Alloc-H), 5.13 (1H, s, pyran H-2), 5.03 (11H, m, pyran H-2), 4.51 (2H, m, Alloc-H), 4.06-3.88 (3H, m, sidechain H-1, pyran H-6), 3.87 (3H, s, O/N—CH₃), 3.87 (3H, s, O/N—CH₃), 3.86 (3H, s, O/N—CH₃), 3.74 (3H, s, OCH₃), 3.74 (3H, s, OCH₃), 3.53-3.44 (3H, m, H-11a, H-3), 2.50 (2H, m, sidechain H-3), 2.13-1.98 (6H, m, H-1,2, sidechain H-2), 1.70 (2H, m, pyran H-3), 1.49 (4H, m, pyran H-4,5).

(ii) A solution of AllocTHPPBD conjugate (20)(0.157 g, 0.24 mmol) dissolved in dry CH₂Cl₂ (2 mL) under a nitrogen atmosphere was treated with pyrrolidine (22 μL, 0.26 mmol, 1.1 equiv.) and then palladium tetrakis[triphenylphosphine] (0.014 g, 0.012 mmol, 0.05 equiv.). The reaction mixture was stirred at room temperature for 2 hours and the product purified directly by column chromatography (silica gel, eluted with CHCl₃ 96%, MeOH 4%) to give the product as a glassy solid, 0.093 g (83%). [α]^{27.2}_{D}+351°; ¹H-NMR (400 MHz) δ 9.94 (1H, s, N—H), 7.83 (1H, d, J=4.4 Hz, H-11), 7.39 (1H, d, J=2.0 Hz, Py-H), 7.39 (1H, s, H-6), 6.88 (1H, s, H-9), 6.76 (1H, d, J=2.0 Hz, Py-H), 4.17 (1H, m, H—I sidechain) 4.08 (1H, m, H-1 sidechain), 3.87 (3H, s, O/N—CH₃), 3.86 (3H, s, O/N—CH₃), 3.77 (3H, s, OCH₃), 3.72 (1H, m, H-11a), 3.65 (2H, m, sidechain H-3), 3.44 (2H, m, H-3), 2.47 (2H, m, sidechain H-1), 2.34-2.29 (2H, m, H-1), 2.09 (2H, m, sidechain H-2), 2.00 (2H, m, H-2); ¹³C-NMR (100 MHz) δ 168.8, 164.2 (C-11), 163.3, 160.7, 150.2, 146.9, 122.7, 120.4 (C-9), 119.8, 118.5, 111.2 (py-CH), 110.1 (C-6), 107.6 (py-CH), 67.7 (C—I sidechain), 55.6 (C-11a), 53.4 (CH₃), 50.9 (CH₃), 46.3 (C-3), 36.1 (CH₃), 31.9 (C-3 sidechain), 28.8 (C-1), 24.6 (C-2 sidechain), 23.6 (C-2); IR (solid) Vₘₐₓ 3296, 2937, 1702, 1596, 1580, 1451, 1255, 1196, 1097,782 cm⁻¹; Acc. Mass C₂₄H₂₈N₄O₆ calc. 469.2082 found 469.2085.

Exemplary Synthesis:

The following is an exemplary synthetic scheme for (11aS) methyl 4-({4-[4-(7-methoxy-5-oxo-2,3,5,11a-tetrahydro-5H-pyrrolo[2,1-c][1,4]benzodiazepine-8-yloxy)-butyrylamino]-1-methyl-1H-pyrrole-2-carbonyl}-amino)-1-methyl-1H-pyrrole-2-carboxylate (23, GWL78).

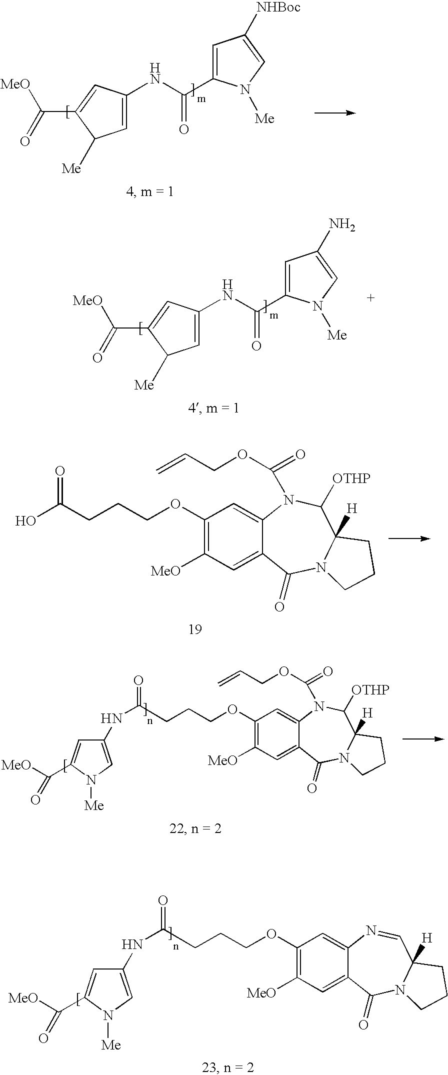

The Boc pyrrole dimer (4)(0.109 g, 0.29 mmol) was treated with 4 M HCl in dioxane (2 mL). The reaction mixture was stirred at room temperature for 30 minutes during which time a precipitate (4′) formed. The solvent was removed and the residue dried in vacuo. The residue was dissolved in dry CH₂Cl₂ and AllocTHPPBD acid (12)(0.150 g, 0.29 mmol, 1 equiv.) was added followed by EDCI (0.111 g, 0.58 mmol, 2 equiv.) and DMAP (0.088 g, 0.72 mmol, 2.5 equiv.). The reaction mixture was stirred for 24 hours then the solvent was removed in vacuo and the residue diluted with EtOAc (25 mL) and washed with 1 M HCl solution (3×10 mL) then saturated NaHCO₃ solution (3×10 mL). The organic fraction was dried over MgSO₄ and concentrated in vacuo, to give a solid, 0.232 g which was purified by column chromatography (silica gel, eluted with CHCl₃ 97%, MeOH 3%) to give a foam (22) 0.115 g, (51%). Mixture of diastereomers ¹H-NMR (400 MHz) 69.20 (2H, s, N—H), 7.33 (1H, d,J=1.8 Hz), 7.17 (1H, m, Py-H), 7.14 (1H, s, H-6), 7.13 (1H, s, H-6), 6.94 (1H, s, H-9), 6.91 (1H, m, Py-H), 6.90 (1H, m, Py-H), 6.80 (1H, m, Py-H), 5.86-5.75 (3H, m, H-11, Alloc-H), 5.04 (1H, s, pyran H-2), 4.07-3.87 (4H, s, sidechain H-3, pyran H-6), 3.86 (3H, s, O/N—CH₃), 3.86 (3H, s, O/N—CH₃), 3.85 (3H, s, O/N—CH₃), 3.77 (1H, s, OCH₃), 3.59-3.46 (3H, m, H-11a, H-3), 2.51 (2H, m, sidechain H-3), 2.15-2.02 (6H, m, H-1,2, sidechain H-2), 1.71 (2H, m, pyran H-3), 1.50 (4H, m, pyran H-4,5).

(ii) A solution of AllocTHPPBD conjugate (22)(0.093 g, 0.12 mmol) dissolved in dry CH₂Cl₂ (2 mL) under a nitrogen atmosphere was treated with pyrrolidine (11 μL, 0.13 mmol, 1.1 equiv.) and then palladium tetrakis[triphenylphosphine] (0.007 g, 0.006 mmol, 0.05 equiv.). The reaction mixture was stirred at room temperature for 2 hours and the product purified directly by column chromatography (silica gel, eluted with CHCl₃ 96%, MeOH 4%) to give the product as a glassy solid, 0.067 g (95%). [α]^{27.1}_{D}+348°; ¹H-NMR (400 MHz) δ 9.88 (1H, s, N—H), 7.78 (1H, d, J=4.3 Hz, H-11), 7.45 (1H, d, J=1.7 Hz, Py-H), 7.34 (1H, s, H-6), 7.16 (1H, d, J=1.6 Hz, Py-H), 6.90 (1H, d, J=1.9 Hz, Py-H), 6.88 (1H, d, J=1.8 Hz, Py-H), 6.83 (1H, s, H-9), 4.10 (1H, m, sidechain H-1), 3.97 (1H, m, sidechain H-1), 3.84 (6H, s, O/N—CH₃), 3.83 (3H, s, O/N—CH₃), 3.74 (3H, s, OCH₃), 3.68 (1H, m, H-11a), 3.60 (1H, m, H-3), 3.40 (1H, m, H-3), 2.44 (1H, m, sidechain H-3), 2.23 (2H, m, H-1), 2.09 (2H, m, sidechain H-2), 1.93 (2H, m, H-2); ¹³C-NMR (100 MHz) δ 168.8, 164.2 (C-11), 163.3, 160.8, 158.4, 150.2, 146.9, 140.6, 122.9, 122.5, 122.1, 120.7 (C-9), 119.8, 118.5 (py-CH), 118.3, 111.3 (py-CH), 110.1 (C-6), 108.3 (py-CH), 104.0 (py-CH), 67.8 (C-1 sidechain), 55.6 (C-11a), 53.4 (CH₃), 50.9 (CH₃), 46.4 (C-3), 36.1 (CH₃), 36.0 (CH₃), 31.9 (C-3 sidechain), 28.8 (C-1), 24.7 (C-2 sidechain), 23.6 (C-2); IR (solid) vₘₐₓ 3300, 2947, 1703, 1596, 1582, 1448, 1435, 1252, 1197, 1100, 781 cm⁻¹; Acc. Mass C₃₀H₃₄N₆O₇ calc. 591.2562 found 591.2535.

Exemplary Synthesis:

The following is an exemplary synthetic scheme for (11aS) methyl 4-{[4-({4-[4-(7-methoxy-5-oxo-2,3,5,11a-tetrahydro-5H-pyrrolo[2,1-c][1,4]benzodiazepine-8-yloxy)-butyrylamino]-1-methyl-1H-pyrrole-2-carbonyl]-amino)-1-methyl-1H-pyrrole-2-carbonyl]-amino}-1-methyl-1H-pyrrole-2-carboxylate (25, GWL79).

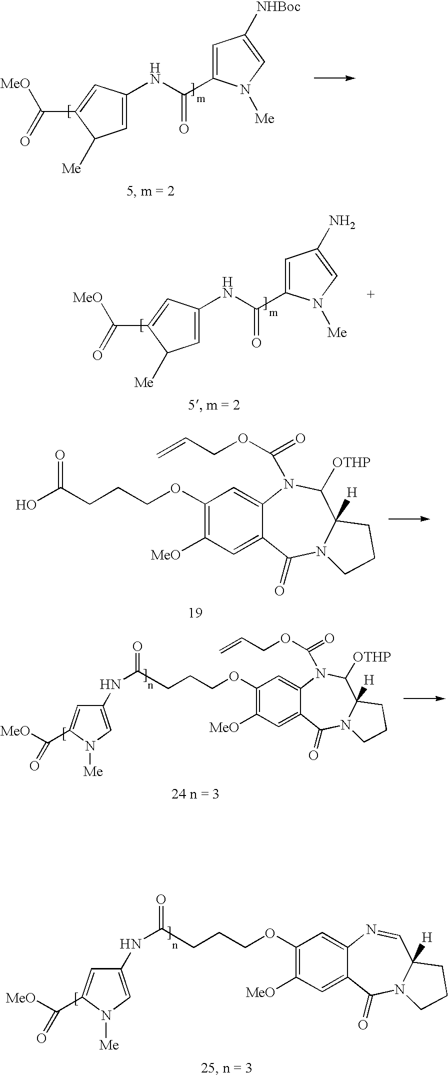

A solution of Boc pyrrole trimer (5)(0.144 g, 0.29 mmol) was treated with 4 M HCl in dioxane (2 mL). The reaction mixture was stirred at room temperature for 30 minutes during which time a precipitate (5′) formed. The solvent was removed and the residue dried in vacuo. The residue was dissolved in dry CH₂Cl₂ and AllocTHPPBD acid (19) (0.150 g, 0.29 mmol, 1 equiv.) was added followed by EDCI (0.111 g, 0.58 mmol, 2 equiv.) and DMAP (0.088 g, 0.72 mmol, 2.5 equiv.). The reaction mixture was stirred for 24 hours then the solvent was removed in vacuo and the residue diluted with EtOAc (25 mL) and washed with 1 M HCl solution (3×10 mL) then saturated NaHCO₃ solution (3×10 mL). The organic fraction was dried over MgSO₄ and concentrated in vacuo, to give an off white foamy solid (24), 0.153 g (59%). Mixture of diastereomers ¹H-NMR (400 MHz) □ 9.28 (1H, s, N—H), 9.19 (1H, s, N—H), 9.02 (1H, s, N—H), 7.50 (1H, d, J=1.7 Hz, Py-H), 7.23 (1H, d, J=1.7 Hz, Py-H), 7.16 (1H, d, J=1.7 Hz, Py-H), 7.15 (1H, s, H-6), 7.13 (1H, s, H-6), 6.99 (1H, d, J=1.7 Hz, Py-H), 6.92 (11H, d, J=1.9 Hz, Py-H), 6.91 (1H, s, H-9), 6.81 (1H, s, Py-H), 5.89-5.76 (3H, m, H-11, Alloc-H), 5.13 (1H, m, pyran H-2), 4.53 (2H, m, Alloc-H), 4.11 (3H, m, sidechain H-1, pyran H-6), 3.94 (3H, s, O/N—CH₃), 3.93 (3H, s, O/N—CH₃), 3.91 (3H, s, O/N—CH₃), 3.87 (3H, s, O/N—CH₃), 3.76 (3H, s, OCH₃), 3.57-3.45 (3H, m, H-3, H-11a), 2.49 (2H, m, sidechain H-3), 2.12-1.98 (6H, m, H-1,2, sidechain H-2), 1.69 (2H, m, pyran H-3), 1.49 (4H, m, pyran H-4,5).

(ii) A solution of AllocTHPPBD conjugate (24) (0.140 g, 0.16 mmol) dissolved in dry CH₂Cl₂ (2 mL) under a nitrogen atmosphere was treated with pyrrolidine (15 μL, 0.17 mmol, 1.1 equiv.) and then palladium tetrakis[triphenylphosphine] (0.009 g, 0.008 mmol, 0.05 equiv.). The reaction mixture was stirred at room temperature for 2 hours and the product purified directly by column chromatography (silica gel, eluted with CHCl₃ 96%, MeOH 4%) to give the product as a glassy solid, 0.076 g (68%). [α]²⁷_{D}+185°; ¹H-NMR (400 MHz) δ 9.92 (1H, s, N—H), 9.90 (1H, s, N—H), 9.88 (1H, s, N—H), 7.78 (1H, d, J=4.4 Hz, H-11), 7.47 (1H, d, J=1.9 Hz, Py-H), 7.34 (1H, s, H-6), 7.24 (1H, d, J=1.7 Hz, Py-H), 7.17 (11H, d, J=1.7 Hz, Py-H), 7.06 (1H, d, J=1.8 Hz, Py-H), 6.91 (1H, d, J=1.9 Hz, Py-H), 6.89 (1H, d, J=1.8 Hz, Py-H), 6.83 (1H, s, H-9), 4.14 (1H, m, sidechain H-1), 4.05 (1H, m, sidechain H-1), 3.85 (3H, s, O/N—CH₃), 3.84 (3H, s, O/N—CH₃), 3.84 (3H, s, O/N—CH₃), 3.83 (3H, s, O/N—CH₃), 3.74 (3H, s, OCH₃), 3.67 (1H, m, H-11a), 3.61 (1H, m, H-3), 3.40 (1H, m, H-3), 2.45 (2H, m, sidechain H-3), 2.30-2.23 (2H, m, H-1), 2.05 (2H, m, sidechain H-2), 1.95 (2H, m, H-2); ¹³C-NMR (100 MHz) δ 168.8, 164.2 (C-11), 163.3, 160.8, 158.5, 158.1, 150.2, 146.9, 140.6, 123.0, 122.7, 122.5, 122.2, 122.0, 120.7 (C-9), 119.8, 118.6 (py-CH), 118.5 (py-CH), 118.2, 111.3 (py-CH), 110.1 (C-6), 108.3 (py-H), 104.0 (py-H), 104.0 (py-H), 55.6 (C-11a), 53.4 (CH₃), 50.9 (CH₃), 46.4 (C-3), 36.2 (CH₃), 36.1 (CH₃), 36.0 (CH₃), 31.9 (C-3 sidechain), 28.8 (C-1), 24.8 (C-2 sidechain), 23.7 (C-2); IR (solid) vₘₐₓ 3300, 2946, 1702, 1594, 1579, 1433, 1249, 1199, 1104, 774;

The racaemic (racemic) version of this compound was made as follows. The BocPBD conjugate [n] (0.100 g, 0.12 mmol) dissolved in CH₂Cl₂ (2.5 mL) was treated with a mixture of TFA (2.375 mL) and H₂O (0.125 mL). The reaction mixture was stirred for 1 hour at room temperature then poured into a flask containing ice (˜20 g) and CH₂Cl₂ (20 mL). The mixture was adjusted to pH˜8 by careful addition of saturated NaHCO₃ solution (˜50 mL). The layers were separated and the aqueous phase extracted with CH₂Cl₂ (2×20 mL). The combined organic layers were dried over MgSO₄ and concentrated in vacuo to give an off-white foam, 0.083 g (97%).

Exemplary Synthesis:

The following is an exemplary synthetic scheme for (11aS) methyl 4-[(4-{[4-({4-[4-(7-methoxy-5-oxo-2,3,5,11a-tetrahydro-5H-pyrrolo[2,1-c][1,4]benzodiazepine-8-yloxy)-butyrylamino]-1-methyl-1H-pyrrole-2-carbonyl]-amino)-1-methyl-1H-pyrrole-2-carbonyl]-amino}-1-methyl-1H-pyrrole-2-carbonyl)-amino]-1-methyl-1H-pyrrole-2-carboxylate (27, GWL80):

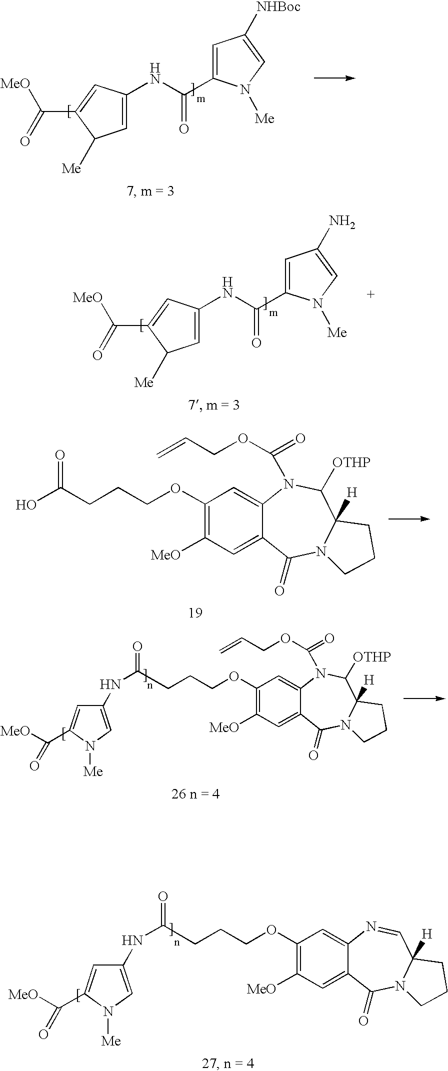

(i) A solution of Boc pyrrole tetramer (7)(0.180 g, 0.29 mmol) was treated with 4 M HCl in dioxane (2 mL). The reaction mixture was stirred at room temperature for 30 minutes during which time a precipitate (7′) formed. The solvent was removed and the residue dried in vacuo. The residue was dissolved in dry CH₂Cl₂ and AllocTHPPBD acid (19)(0.150 g, 0.29 mmol, 1 equiv.) was added followed by EDCI (0.111 g, 0.58 mmol, 2 equiv.) and DMAP **(0.088 g, 0.72 mmol, 2.5 equiv.). The reaction mixture was stirred for 24 hours then the solvent was removed in vacuo and the residue diluted with EtOAc (25 mL) and washed with 1 M HCl solution (3×10 mL) then saturated NaHCO₃ solution (3×10 mL). The organic fraction was dried over MgSO₄ and concentrated in vacuo, to give an off-white foamy solid (26), 0.068 g (23%). Mixture of diastereomers ¹H-NMR (400 MHz) δ 9.28 (1H, s, N—H), 9.25 (1H, s, N—H), 9.18 (1H, s, N—H), 9.03 (1H, s, N—H), 7.50 (1H, d, J=1.9 Hz, Py-H), 7.23 (1H, d, J=1.4 Hz, Py-H), 7.15 (1H, s, H-6), 7.14 (1H, s, H-6), 6.99 (1H, J=2.0 Hz, Py-H), 6.96 (1H, s, H-9), 6.93 (1H, d, J=1.9 Hz, Py-H), 6.90 (1H, s, Py-H), 6.83 (1H, s, Py-H), 6.81 (1H, s, Py-H), 5.87-5.77 (1H, m, H-11, Alloc-H), 5.09 (1H, m, pyran H-2), 4.62-4.42 (2H, m, Alloc-H), 4.09-3.95 (3H, m, sidechain H-1, pyran H-6), 3.94 (3H, s, O/N—CH₃), 3.91 (3H, s, O/N—CH₃), 3.87 (3H, s, O/N—CH₃), 3.74 (3H, s, OCH₃), 3.57-3.44 (3H, m, H-3,11a), 2.49 (2H, d, J=7.0 Hz, sidechain H-3), 2.13-1.99 (6H, m, H-1,2, sidechain H-2), 1.64 (2H, m, pyran H-3), 1.49 (4H, m, pyran H-4,5).

(ii) A solution of AllocTHPPBD conjugate (26)(0.065 g, 0.06 mmol) dissolved in dry CH₂Cl₂ (2 mL) under a nitrogen atmosphere was treated with pyrrolidine (5 μL, 0.07 mmol, 1.1 equiv.) and then palladium tetrakis[triphenylphosphine] (0.004 g, 0.003 mmol, 0.05 equiv.). The reaction mixture was stirred at room temperature for 2 hours and the product purified directly by column chromatography (silica gel, eluted with CHCl₃ 96%, MeOH 4%) to give the product as a glassy solid, 0.029 g (55%). [α]^{26.5}_{D}+129°; ¹H-NMR (400 MHz) δ 9.94 (1H, s, N—H), 9.93 (1H, s, N—H), 9.90 (1H, s, N—H), 9.88 (1H, s, N—H), 7.78 (1H, d, J=4.4 Hz, H-11), 7.48 (1H, d,J=1.3 Hz, Py-H), 7.35 (1H, s, H-6), 7.25 (2H, s, Py-H), 7.17 (1H, d,J=0.8 Hz, Py-H), 7.08 (1H, d, J=1.1 Hz, Py-H), 7.06 (1H, d, J=0.9 Hz, Py-H), 6.92 (1H, d, J=1.2 Hz, Py-H), 6.90 (1H, s, Py-H), 6.83 (1H, s, H-9), 4.14 (1H, m, sidechain H-1), 4.05 (1H, m, sidechain H-1), 3.86 (3H, s, O/N—CH₃), 3.84 (3H, s, O/N—CH₃), 3.83 (3H, s, O/N—CH₃), 3.75 (3H, s, OCH₃), 3.68 (1H, m, H-11a), 3.61 (1H, m, H-3), 3.37 (1H, m, H-3), 2.45 (2H, m, sidechain H-3), 2.22 (2H, m, H-1), 2.05 (2H, m, sidechain H-2), 1.94 (2H, m, H-2); ¹³C-NMR (100 MHz) δ 168.8, 164.2 (C-11), 163.3, 160.8, 158.5, 158.4, 150.2, 146.9, 140.6, 123.0, 122.7, 122.5, 122.3, 122.1, 122.0, 120.7(C-9), 119.8, 118.6 (py-CH), 118.5, 118.1, 111.3 (py-CH), 110.1 (C-6), 108.4 (py-CH), 104.8, 104.7 (py-CH), 104.0, 55.6 (C-11a), 53.4 (CH₃), 50.9 (CH₃), 46.4 (C-3), 36.1 (CH₃), 36.1 (CH₃), 31.9 (C-3 sidechain), 28.8 (C-1), 24.8 (C-2 sidechain), 23.7 (C-2); IR (solid) vₘₐₓ 3289, 2947, 1706, 1632, 1580, 1433, 1250, 1199, 1106, 772 cm⁻¹; Acc. Mass C₄₂H₄₆N₁₀O₉ calc. 835.3522 found 835.3497.

Exemplary Synthesis:

The following is an exemplary synthetic scheme for (11aS) methyl 4-({4-[(4-{[4-({4-[4-(7-methoxy-5-oxo-2,3,5,11a-tetrahydro-5H-pyrrolo[2,1-c][1,4]benzodiazepine-8-yloxy)-butyrylamino]-1-methyl-1H-pyrrole-2-carbonyl]-amino)-1-methyl-1H-pyrrole-2-carbonyl]-amino}-1-methyl-1H-pyrrole-2-carbonyl)-amino]-1-methyl-1H-pyrrole-2-carbonyl}-amino)-1-methyl-1H-pyrrole-2-carboxylate (22, GWL 81):

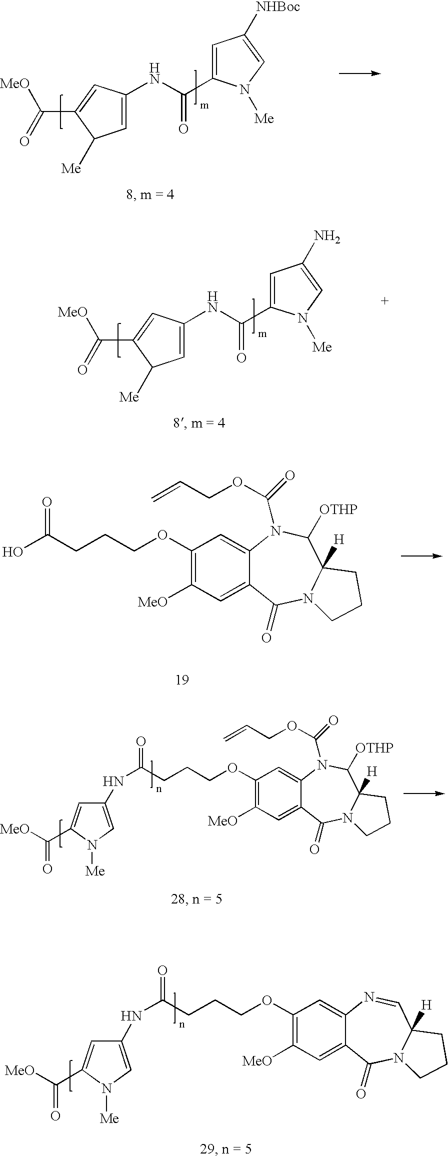

A solution of Boc pyrrole pentamer (8)(0.150 g, 0.20 mmol) was treated with 4 M HCl in dioxane (2 mL). The reaction mixture was stirred at room temperature for 30 minutes during which time a precipitate (8′) formed. The solvent was removed and the residue dried in vacuo. The residue was dissolved in dry CH₂Cl₂ and AllocTHPPBD acid (19)(0.150 g, 0.2 mmol, 1 equiv.) was added followed by EDCI (0.111 g, 0.40 mmol, 2 equiv.) and DMAP (0.088 g, 0.50 mmol, 2.5 equiv.). The reaction mixture was stirred for 24 hours then the solvent was removed in vacuo and the residue diluted with EtOAc (25 mL) and washed with 1 M HCl solution (3×10 mL) then saturated NaHCO₃ solution (3×10 mL). The organic fraction was dried over MgSO₄ and concentrated in vacuo, to give an off white foamy solid (28), 0.164 g (71%). Mixture of diastereomers ¹H-NMR (400 MHz) 69.26 (1H, s, N—H), 9.22 (1H, s, N—H), 9.20 (1H, s, N—H), 7.50 (1H, d, J=1.6 Hz, Py-H), 7.23 (3H, d, J=1.7 Hz, Py-H), 7.15 (1H, s, H-6), 6.97 (2H, m, Py-H), 6.93 (2H, d,J=1.8 Hz, Py-H), 6.90 (1H, s, H-9), 6.84 (1H, d, J=2.0 Hz, Py-H), 6.80 (1H, d, J=2.0 Hz, Py-H), 5.89-5.77 (3H, m, H-11, Alloc-H), 5.10 (1H, m, pyran H-2), 4.60-4.41 (2H, m, Alloc-H), 4.10-3.95 (3H, m, sidechain H-1, pyran H-6), 3.94 (3H, s, O/N—CH₃), 3.92 (3H, s, O/N—CH₃), 3.91 (3H, s, O/N—CH₃), 3.87 (3H, s, O/N—CH₃), 3.76 (3H, s, OCH₃), 3.54-3.43 (3H, m, H-3,11a), 2.50 (2H, in, sidechain H-3), 2.13-1.99 (6H, m, H-1,2, sidechain H-2), 1.68 (2H, m, pyran H-3), 1.48 (4H, m, pyran H-4,5).

(ii) A solution of AllocTHPPBD conjugate (28)(0.164 g, 0.14 mmol) dissolved in dry CH₂Cl₂ (2 mL) under a nitrogen atmosphere was treated with pyrrolidine (13 μL, 0.16 mmol, 1.1 equiv.) and then palladium tetrakis[triphenylphosphine] (0.008 g, 0.007 mmol, 0.05 equiv.). The reaction mixture was stirred at room temperature for 2 hours and the product purified directly by column chromatography (silica gel, eluted with CHCl₃ 96%, MeOH 4%) to give the product as a glassy solid, 0.068 g (50%). [α]^{26.7}_{D}+90°; ¹H-NMR (400 MHz) δ 9.95 (1H, s, N—H), 9.95 (1H, s, N—H), 9.94 (1H, s, N—H), 9.91 (1H, s, N—H), 9.89 (1H, s, N—H), 7.78 (1H, d, J=4.4 Hz, H-11), 7.48 (1H, d, J=1.8 Hz, Py-H), 7.35 (1H, s, H-6), 7.25 (3H, s, Py-H), 7.17 (1H, d, J=1.6 Hz, Py-H), 7.09 (1H, d, J=2.1 Hz, Py-H), 7.08 (1H, s, Py-H), 7.07 (1H, d, J=1.6 Hz, Py-H), 6.92 (1H, d, J=1.9 Hz, Py-H), 6.91 (1H, d, J=1.8 Hz, Py-H), 6.83 (1H, s, H-9), 4.14 (1H, m, sidechain H-1), 4.05 (1H, m, sidechain H-1), 3.87 (6H, s, O/N—CH₃), 3.86 (1H, s, O/N—CH₃), 3.85 (3H, s, O/N—CH₃), 3.83 (3H, s, O/N—CH₃), 3.75 (3H, s, OCH₃), 3.68 (1H, m, H-11a), 3.60 (1H, m, H-3), 3.39 (1H, m, H-3), 2.45 (2H, m, sidechain H-3), 2.26 (2H, m, H-1), 2.06 (2H, m, sidechain H-2), 1.94 (2H, m, H-2); ¹³C-NMR (100 MHz) δ 168.8, 164.2 (C-11), 163.3, 160.8, 158.5, 158.4, 150.2, 146.9, 140.6, 123.0, 122.7, 122.5, 122.3, 122.2, 122.1, 122.0, 120.7 (C-9), 118.6 (py-CH), 118.5 (py-CH), 118.2, 111.3 (py-CH), 110.1 (C-6), 108.4 (py-CH), 104.8 (py-CH), 104.8 (py-CH), 102.0, 67.8 (C—I sidechain), 55.6 (C-11a), 53.4 (CH₃), 50.9 (CH₃), 46.4 (C-3), 36.2 (CH₃), 36.1 (CH₃), 31.9 (C-3 sidechain), 28.8 (C-1), 24.8 (C-2 sidechain), 23.7 (C-2); IR (solid) vₘₐₓ 3297, 2945, 1701, 1631, 1579, 1434, 1251, 1199, 1106, 774 cm⁻¹; Acc. Mass C₄₈H₅₂N₁₂O₁₀ calc. 957.4002 found 957.4010.

Exemplary Synthesis:

The following is an exemplary synthetic scheme for (11aS) methyl 4-{[4-({4-[(4-{[4-({4-[4-(7-methoxy-5-oxo-2,3,5,11a-tetrahydro-5H-pyrrolo[2,1-c][1,4]benzodiazepine-8-yloxy)-butyrylamino]-1-methyl-1H-pyrrole-2-carbonyl]-amino)-1-methyl-1H-pyrrole-2-carbonyl]-amino}-1-methyl-1H-pyrrole-2-carbonyl)-amino]-1-methyl-1H-pyrrole-2-carbonyl}-amino)-1-methyl-1H-pyrrole-2-carbonyl]-amino}-1-methyl-1H-pyrrole-2-carboxylate (31, GWL 82):

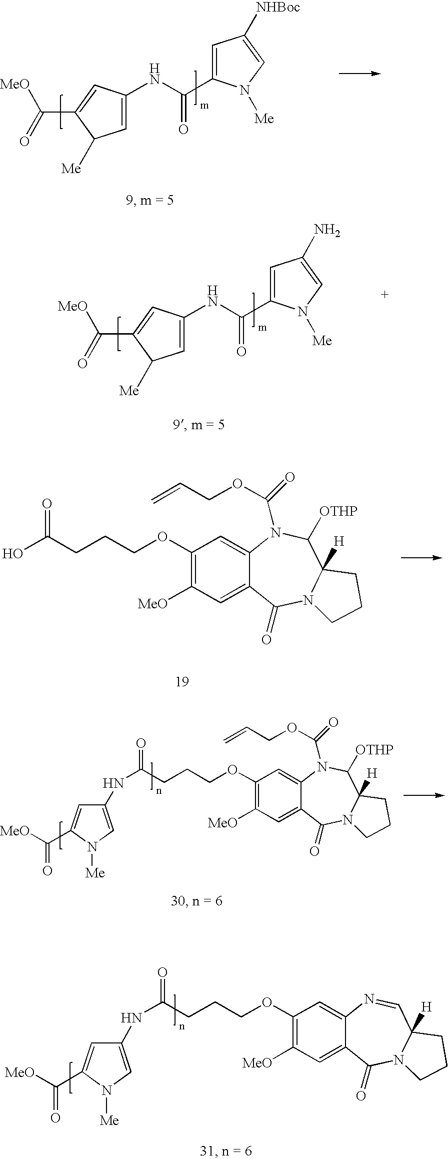

(i) A solution of Boc pyrrole hexamer (9)(0.155 g, 0.18 mmol) was treated with 4 M HCl in dioxane (2 mL). The reaction mixture was stirred at room temperature for 30 minutes during which time a precipitate (9′) formed. The solvent was removed and the residue dried in vacuo. The residue was dissolved in dry CH₂Cl₂ and AllocTHPPBD acid (19)(0.093 g, 0.18 mmol, 1 equiv.) was added followed by EDCI (0.068 g, 0.36 mmol, 2 equiv.) and DMAP (0.054 g, 0.45 mmol, 2.5 equiv.). The reaction mixture was stirred for 24 hours then the solvent was removed in vacuo and the residue diluted with EtOAc (25 mL) and washed with 1 M HCl solution (3×10 mL) then saturated NaHCO₃ solution (3×10 mL). The organic fraction was dried over MgSO₄ and concentrated in vacuo, to give an off white foamy solid (30), 0.174 g (77%). ¹H-NMR (500 MHz) δ 9.28 (1H, s, N—H), 9.25 (1H, s, N—H), 9.23 (1H, s, N—H), 9.16(1H, s, N—H),7.50 (1H, d, J=1.8 Hz, Py-H),7.24 (3H, d, J=1.5 Hz, Py-H),7.16 (1H, s, H-6), 7.14 (2H, s, H-6, Py-H), 6.99 (1H, d, J=1.7 Hz, Py-H), 6.96 (1H, s, H-9), 6.93 (4H, d, J=1.9 Hz, Py-H), 6.83 (1H, d, J=2.3 Hz, Py-H), 6.79 (1H, s, Py-H), 5.89-5.77 (3H, m, Alloc-H), 5.11 (1H, m, pyran H-2), 4.62-4.42 (2H, m, Alloc-H), 4.12-3.95 (3H, m, sidechain H-1, pyran H-6), 3.94 (3H, s, O/N—CH₃), 3.93 (3H, s, O/N—CH₃), 3.91 (3H, s, O/N—CH₃), 3.87 (3H, s, O/N—CH₃), 3.81 (3H, s, O/N—CH₃), 3.75 (3H, s, OCH₃), 3.54-3.46 (3H, m, H-3,11a), 2.49 (2H, m, sidechain H-3), 2.12-1.98 (6H, m, H-1,2, sidechain H-2), 1.68 (2H, m, pyran H-3), 1.48 (4H, m, pyran H-4,5).

(ii) A solution of AllocTHPPBD conjugate (30)(0.174 g, 0.14 mmol) dissolved in dry CH₂Cl₂ (2 mL) under a nitrogen atmosphere was treated with pyrrolidine (13′ L, 0.15 mmol, 1.1 equiv.) and then palladium tetrakis[triphenylphosphine] (0.008 g, 0.007 mmol, 0.05 equiv.). The reaction mixture was stirred at room temperature for 2 hours and the product purified directly by column chromatography (silica gel, eluted with CHCl₃ 96%, MeOH 4%) to give the product as a glassy solid, 0.084 g (57%). [α]^{27.1}_{D}+107°; ¹H-NMR (400 MHz) δ 9.96 (2H, s, N—H), 9.95 (1H, s, N—H), 9.94 (1H, s, N—H), 9.91 (1H, s, N—H), 9.89 (1H, s, N—H), 7.78 (1H, d, J=4.4 Hz, H-11), 7.35 (1H, s, H-6), 7.26 (4H, m, Py-H), 7.17 (1H, d, J=1.6 Hz, Py-H), 7.09 (2H, d, J=1.5 Hz, Py-H), 7.08 (2H, d, J=1.7 Hz, Py-H), 6.92 (1H, d, J=1.9 Hz, Py-H), 6.91 (1H, d, J=1.8 Hz, Py-H), 6.84 (1H, s, H-9), 4.14 (1H, m, sidechain H-1), 4.05 (1H, m, sidechain H-1), 3.87 (12H, s, O/N—CH₃), 3.86 (3H, s, O/N—CH₃), 3.85 (3H, s, O/N—CH₃), 3.83 (3H, s, O/N—CH₃), 3.75 (3H, s, OCH₃), 3.68 (1H, m, H-11a), 3.61 (1H, m, H-3), 3.40 (1H, m, H-3), 2.45 (2H, m, sidechain H-3), 2.29-2.23 (2H, m, H-1), 2.06 (2H, m, sidechain H-2), 1.94 (2H, m, H-2); ¹³C-NMR (100 MHz) δ 168.8, 164.3 (C-11), 163.3, 160.8, 158.5, 158.4, 150.2, 146.9, 140.6, 123.0, 122.8, 122.7, 122.5, 122.3, 122.2, 122.1, 122.0, 120.7 (C-9), 119.8, 118.5, 118.5 (py-CH), 118.1, 111.3 (py-CH), 110.1 (C-6), 108.4 (py-CH), 104.8 (py-CH), 104.8 (py-CH), 104.8 (py-CH), 104.7 (py-CH), 104.7 (py-CH), 67.8 (C-1 sidechain), 55.6 (C-11a), 53.4 (CH₃), 50.9 (CH₃), 46.4 (C-3), 36.2 (CH₃), 36.2 (CH₃), 36.1 (CH₃), 36.0 (CH₃), 35.9 (CH₃), 31.9 (C-3 sidechain), 28.8 (C-1), 24.8 (C-2 sidechain), 23.7 (C-2); IR (solid) vₘₐₓ 3300, 2945, 1701, 1634, 1581, 1433, 1250, 1200, 1106, 772 cm⁻¹; Acc. mass C₅₄H₅₈N₁₄O₁₁ calc. 1079.4482 found 1079.4542.

### Example 2

### Exemplary DNA Footprinting Assay

In alternative embodiments of the methods of the invention, nucleic acid footprinting assays are used. The following example describes an exemplary DNA footprinting assay that can be used when practicing the methods of the invention.

The sequence selectivity of the six PBD-pyrrole conjugates (GWL 77, GWL 78, GWL 79, GWL 80, GWL 81 and GWL 82) was evaluated by standard DNA footprinting on a fragment of MS2 as follows, in accordance with the technique described in Martin, Biochemistry (2005) 44:4135-4147.

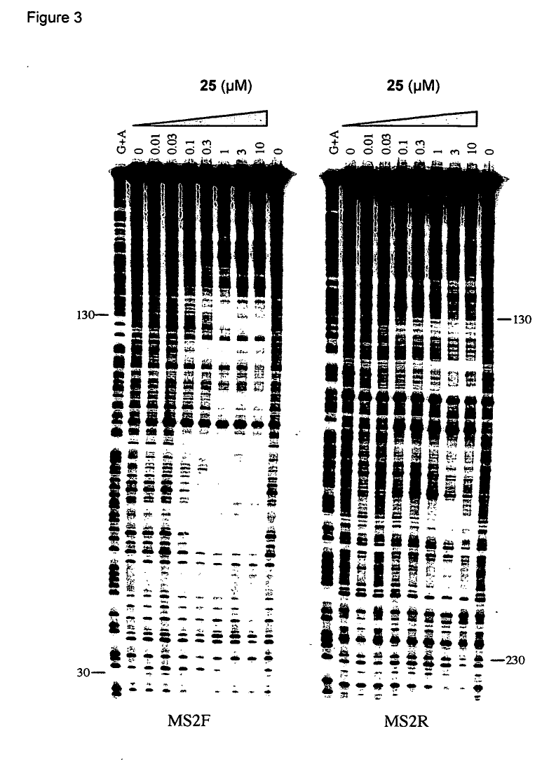

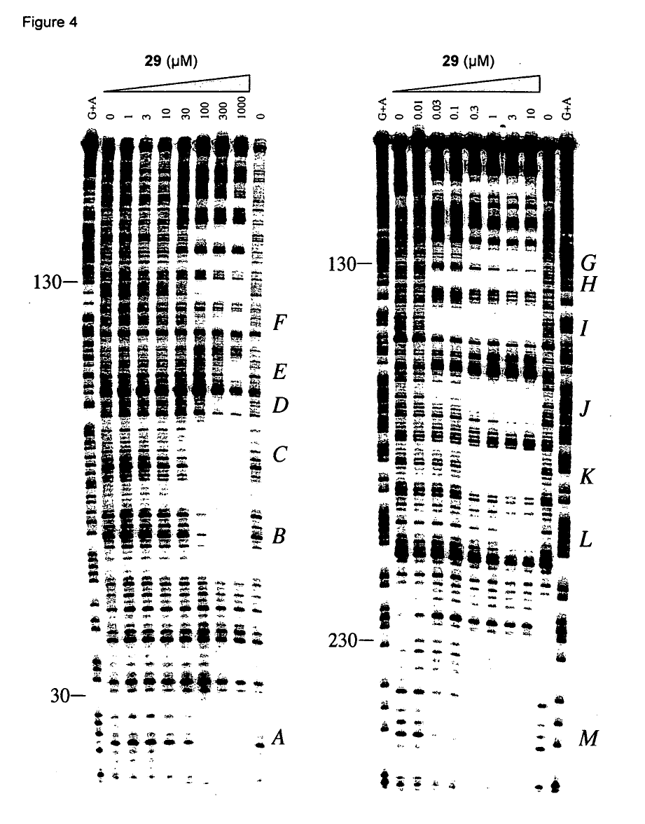

The five conjugates (GWL 77, GWL 78, GWL 79, GWL 80, GWL 81) were found to bind to the MS2 fragment at several locations. However, although there were differences in binding affinity between each compound in the set, their footprinting patterns were surprisingly similar. DNase I footprinting gels of (GWL 79), a conjugate with high TM values, on both MS2F and MS2R DNA fragments are shown in FIG. 3, and those for GWL 81 are shown in FIG. 4.

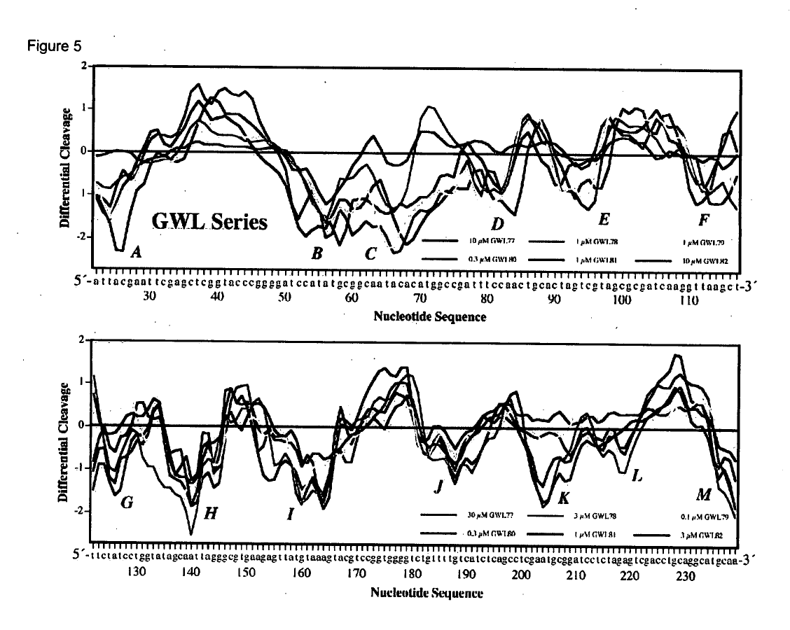

The vast majority of footprint sites are common features in the binding profiles of all six conjugates, with only a small number of sites being footprinted by a subset of the family. Even more unexpectedly, no site is footprinted by only one molecule (in fact, the fewest number of conjugates that bind at any single site is four). The differential cleavage plot in FIG. 5 provides footprinting profiles at a supramaximal concentration color-coded for each conjugate which illustrates a striking degree of overlap. Although there is no conspicuous change in footprinting patterns as the number of pyrroles units in each conjugate increases, there are changes in two other features, namely, the apparent binding affinity and the width of the footprinted site. The binding affinity of each molecule at a particular site was estimated by eye (using the individual DNase I footprint images) as the concentration of conjugate providing 50% inhibition (DNase IC₅₀) of DNase I-mediated cleavage at that site. To simplify comparison between molecules, only the most significant footprint site (5′-⁶²CAATACACA⁷⁰−3′/3′-GTTATGTGT-5′) (SEQ ID NO:24) was selected for comparison. When the binding affinity of each molecule is compared to the relative number of pyrrole units it contains, a parabolic relationship is observed. By this method, GWL 80 (four pyrroles) appears to be the strongest binder with a DNase IC₅₀ of around 30 nM. Conjugate GWL 79 (three pyrroles) and GWL 81 (five pyrroles) follow closely with affinities in the region of 30-100 nM. Conjugates GWL 78 (2 pyrroles) and GWL 81 (6 pyrroles) are poorer binders but still exhibit nanomolar affinities in the region of 100-300 nM and 300 nM, respectively. Finally, GWL 77 (one pyrrole) is a particularly weak footprinting molecule with an DNase IC₅₀ of about, or in excess of, 10 μM.

The binding characteristics of the series (GWL 77, GWL 78, GWL 79, GWL 80, GWL 81) at all thirteen sites within the MS2 DNA fragment are provided in detail in Table 2.

TABLE 2

| | Footprint Position | | | | | | | | | | | | |
|---|---|---|---|---|---|---|---|---|---|---|---|---|---|
| | A | B | C | D | E | F | G | H¹ | I | J² | K | L | M |
| GWL 77 | − | + | + | − | − | − | + | + | + | + | + | + | + |
| GWL 78 | ++ | ++ | ++ | + | − | ++ | + | +++ | ++ | +++ | +++ | ++ | ++ |
| GWL 79 | +++ | +++ | +++ | +++ | + | +++ | −³ | +++ | +++ | ++ | ++ | +++ | −⁴ |
| GWL 80 | +++ | ++ | ++ | ++ | ++ | + | ++ | +++ | ++ | ++ | ++ | ++ | +++ |
| GWL 81 | ++ | ++ | ++ | ++ | + | ++ | ++ | +++ | +++ | +++ | ++ | ++ | ++ |
| GWL 82 | ++ | ++ | ++ | ++ | + | ++ | ++ | ++ | ++ | + | − | − | + |

¹27, 29, 31 show evidence of two closely juxtaposed footprints at this position
²27, 29, 31 show evidence of two closely juxtaposed footprints at this position
^{3,4}data not suitable for analysis due to ‘smearing’ of digestion products at higher concentrations

The same site (5′-⁶²CAATACACA⁷⁰-3′) (SEQ ID NO:25) and its close neighbor 5′-⁵⁰ATCCATATGCG⁶⁰-3′ (SEQ ID NO:26) were also chosen and analyzed in order to assess the effect of increasing the size of the molecules on the length of the sequence bound. It appears that as additional pyrroles are added to the PBD there is a subsequent rise in the number of base pairs within the associated binding site. Although the precise effects on individual sites cannot be ascertained, the positive correlation is suggestive of larger tracts of DNA becoming bound by molecules of increasing length, although it is not known whether it is a single molecule or more contributing to the observed effect.

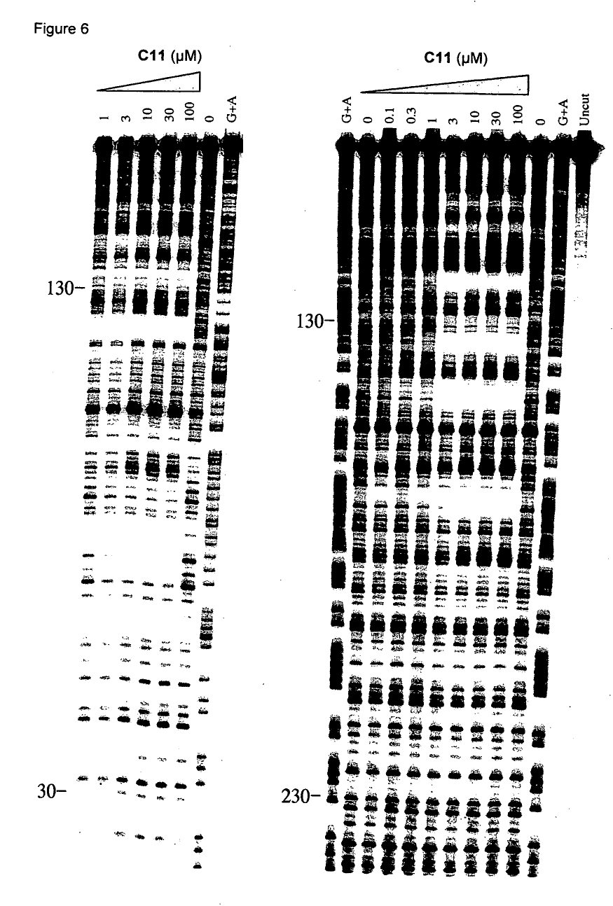

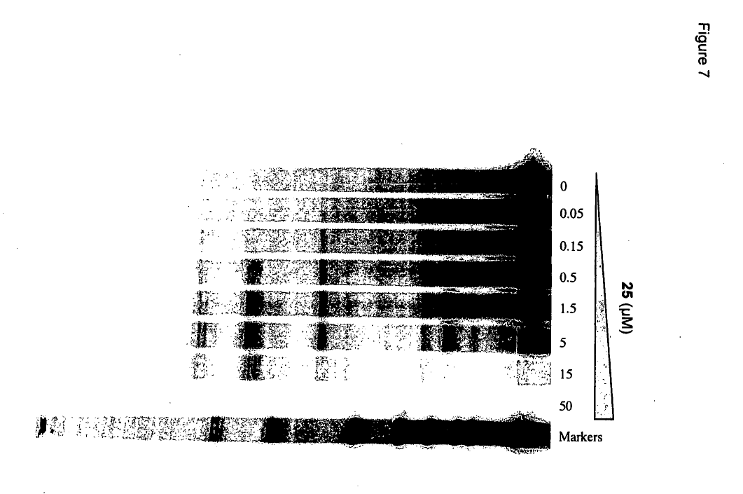

Conjugate C11 was also assessed for DNA binding by DNase I footprinting (FIG. 6). The results confirm the indication from Tm values that GWL 79 should have a better isohelical fit in the minor groove of DNA and thus a higher reactivity towards DNA. The gel in FIG. 6 indicates that C11 has an apparent binding affinity of approximately 3 μM which is 30 to 100-fold higher than that of GWL 79 (30-100 nM). Furthermore, differential cleavage analysis shows, as expected, that the actual pattern of footprints produced by C11 is almost identical to GWL 79 except for the lack of footprints at positions D, M and G (which is, in fact, footprinted by GWL 77, GWL 78, GWL 80 and GWL 81, and much weaker binding at positions K and L (binding at these sites can only be resolved by a computational method; data not shown).

### Example 3

### Exemplary In-Vitro Transcription Assay

In alternative embodiments of the methods of the invention, in vitro transcription assays are used. The following example describes an exemplary in vitro transcription assay that can be used when practicing the methods of the invention.

The conjugates GWL 77, GWL 78, GWL 79, GWL 80, GWL 81 were subjected to an in vitro transcription assay as described earlier and in Martin, C., et al., (Martin, C., et al., Biochemistry (2005) 44:4135-4147) to establish whether any members could inhibit transcription.

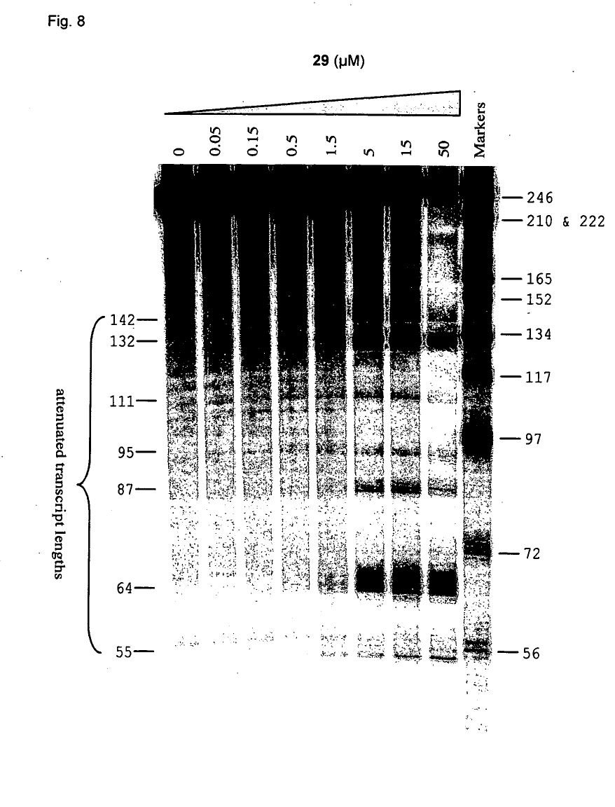

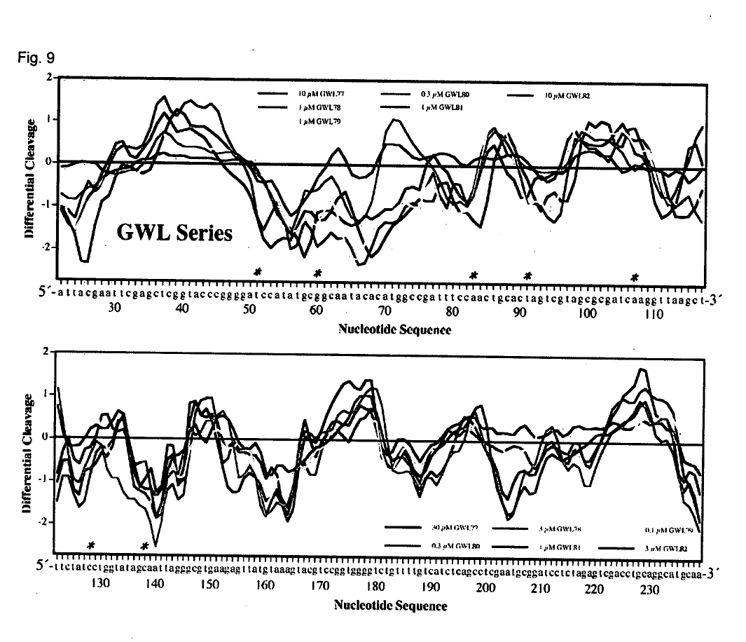

As with the DNase I footprinting results, each member produced identical T-stop patterns. Results for GWL 79 and GWL 81 are shown in FIGS. 7 and 8, respectively, and are representative of all other compounds in the series. It is significant that all seven observed T-stops localize within a few bases of the most intense footprints produced by the same compounds; the correlation is highlighted in FIG. 9 where the T-Stops are depicted as asterisks. Those with transcript lengths of 55 (51), 64 (60), 95 (91), 111 (107) and 142 (138) nucleotides are found 5′- to the likely binding sites. The remaining two T-stops are located only one or two base pairs 3′- to the nearest footprint.

In general, all compounds provide T-stops within the same concentration range, producing 50% inhibition of full-length transcript synthesis at around 5 μM. However, the use of this particular assay in determining, or even estimating, affinity constants has not been validated and therefore only sequence data can be analyzed.

In accordance with the DNase I footprinting data, C11 produces T-stops at identical positions to GWL 79 (data not shown) and the remainder of the series, with one exception; the T-stop corresponding to a 132 nt transcript. This corresponds well with the lack of footprinting around this site by C11. The range of concentrations over which C11 exerts its effect is similar to that of GWL 79, however, the use of this assay to compare effective concentration ranges has not been validated.

### Example 4

### Exemplary In vitro Cytotoxicity Assay

In alternative embodiments of the methods of the invention, in vitro, ex vivo, or in vivo cytotoxicity assays are used. The following example describes an exemplary in vitro cytotoxicity assay that can be used when practicing the methods of the invention. The method was carried out as already described, above. The results are shown in Table 3 below.

TABLE 3

| Compound | IC₅₀ (μM) |
|---|---|
| C11 | 0.346 |
| GWL 77 | 0.051 |
| GWL 78 | 0.0036 |
| GWL 79 | 0.041 |
| GWL 80 | 0.047 |
| GWL 81 | 0.083 |
| GWL 82 | 0.032 |

### Example 5

### Exemplary Cellular and Nuclear Penetration Assay

In alternative embodiments of the methods of the invention, in vitro, ex vivo, or in vivo cellular and nuclear penetration assays are used. The following example describes an exemplary cellular and nuclear assay that can be used when practicing the methods of the invention.

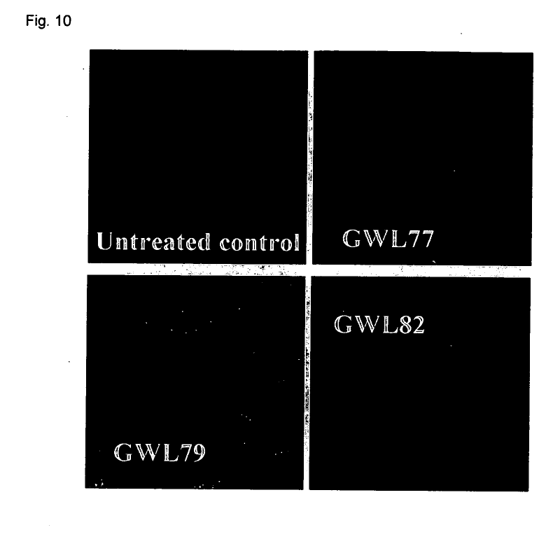

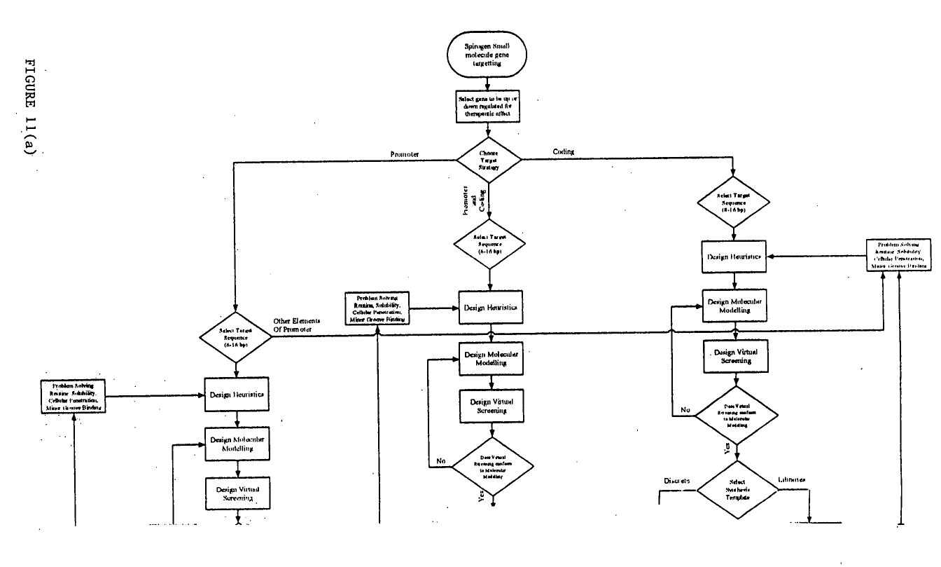

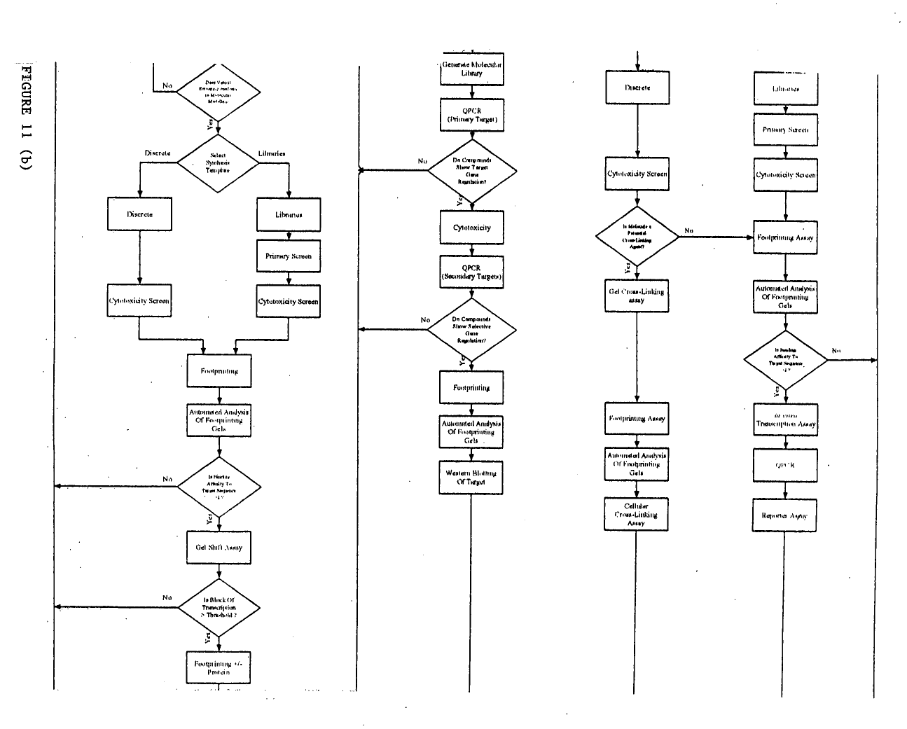

Cellular uptake and nuclear incorporation of drug into MCF-7 human mammary cells was visualized using confocal microscopy. Conjugates GWL 77, GWL78, GWL 79, GWL 80 and GWL 81 were prepared in DMSO at 20 mM and diluted in RPMI to the appropriate concentration. Freshly harvested MCF7 cells at 5×10⁴ cells/ml were placed in 200 μl of complete RPMI1640 (containing 10% FCS) into the wells of 8-well chambered cover-glasses. Cells were left overnight to adhere at 37° C. Following overnight incubation, cellular preparations were spiked with concentrations of compound at 1, 10 and 100 μM ensuring that final DMSO concentrations were <1%. At 1, 5 and 24 hours after addition of conjugates, the cells were examined using a Nikon TE2000 with UV filter set and viewed under oil immersion with the x63 objective lens. The results for conjugates GWL 77, GWL 79 and GWL 80 at 200 μM over 24 hours are shown in FIG. 10.

At the highest drug concentrations used and an exposure time of 24 hour it is clear that all compounds are taken up into MCF-7 cells. With GWL 77, GWL 78 and GWL 79 there is strong nuclear fluorescence, but with GWL 80, GWL 81 and GWL 82 the fluorescence appears more diffuse throughout the cell (which does not mean that it is not nuclear). In general the longer the conjugate the slower the uptake with GWL 77 being taken up very rapidly (<1 hour) and the others (GWL 78 and GWL 79) detectable after 3 hours. Although high concentrations of conjugates were used in these experiments, they did not appear to be detrimental to the cells over a period of 24 hours. IC₅₀ values for MCF-7 in comparison are in the range of 2 μM. The main observations are that cellular uptake is observed for all conjugates at a concentration of 200 μM over 24 hour, with clear nuclear uptake seen for GWL 77, GWL 78 and GWL 79.

A number of aspects of the invention have been described. Nevertheless, it will be understood that various modifications may be made without departing from the spirit and scope of the invention. Accordingly, other aspects are within the scope of the following claims.

1. A method to identify a compound as a therapeutic compound for treating a condition regulated or modulated by a target gene, which method comprises the steps of:
a) providing a library of compounds designed to interact with a portion of a transcriptional regulatory nucleotide sequence of the gene;
b) screening the library for members that interact with the transcriptional regulatory nucleotide sequence to obtain a first subset of sequence-interacting compounds;
c) assessing the ability of each member of the first subset to bind to the transcriptional regulatory nucleotide sequence with sufficient affinity, where the members that bind with sufficient affinity comprise a second subset; and
d) assessing each member of the second subset for ability to interfere with or block transcription of the gene to identify a candidate therapeutic that interferes with transcription of the gene, whereby a member is identified as a candidate therapeutic by its ability to interfere with transcription of the gene.

2. The method of claim 1, further comprising
(a) assessing the cytotoxicity of each member of the first subset, or each member of the second subset;
(b) the method of (a), wherein assessing the cytotoxicity of a member is determined by a method comprising an in vitro assay on a cancer cell line;
(c) confirming identification of the member as a candidate compound using an in vitro model, an in vivo model, or an in vitro model and an in vivo model;
(d) designing the library of compounds of step a) by a method comprising employing heuristics, molecular modeling, virtual (in silico) screening or a combination thereof; or
(e) the method of (c), wherein the in silico or virtual screening comprises (a) using docking libraries of purchasable compounds into a rigid DNA “receptor” employing pharmacophore screening based on known ligands and interaction cites in the minor groove, (b) de novo design by growing molecules from small fragments based on a DNA minor groove, (c) “MM-PBSA,” or, Molecular Mechanics Poisson-Boltzmann/surface area) approach, or (d) any combination thereof.

3-6. (canceled)

7. The method of claim 1, wherein
(a) the transcriptional regulatory sequence of the gene comprises a promoter nucleotide sequence of the genes;
(b) the transcriptional regulatory sequence of the gene comprises an enhancer nucleotide sequence of the gene;
(c) the screening the library for members that interact with the transcriptional regulatory nucleotide sequence of step b) is performed using an intercalator displacement/exclusion assay;
(d) assessing the ability of each member of the second subset to bind to the transcriptional regulatory nucleotide sequence with sufficient affinity in step c) is performed by a method comprising footprinting and automated analysis; or
(e) each member of the second subset in step d) is assessed by a method comprising using a gel shift assay;
(f) the method comprises identifying a compound therapeutic for breast cancer, and optionally the target gene comprises BRCA and/or Her-2/neu;
(g) the method comprises identifying a compound therapeutic for Burkitt's Lymphoma, and optionally the target gene comprises Myc;
(h) the method comprises identifying a compound therapeutic for prostate cancer, and optionally the target gene comprises c-Myc;
(i) the method comprises identifying a compound therapeutic for colon cancer, and optionally the target gene comprises MSH;
(j) the method comprises identifying a compound therapeutic for lung cancer, and optionally the target gene comprises EGFR (ErbB-1), Her 2/neu (ErbB-2); Her 3 (ErbB-3) and/or Her 4 (ErbB-4);
(k) the method comprises identifying a compound therapeutic for Chronic Myeloid Leukemia (CML), and optionally the target gene comprises BCR-ABL;
(l) the method comprises identifying a compound therapeutic for malignant melanoma, and optionally the target gene comprises CDKN2 and/or BCL-2;
(m) the target gene comprises PKA, VEGFR, VEGFR2, PDGF and/or PGGFR;
(n) the method comprises identifying a compound therapeutic for a disease or condition mediated by: cellular proliferation; cellular proliferation comprising inflammation; cellular proliferation comprising atherosclerosis; cellular proliferation comprising neovascularization or angiogenesis, or the migration, differentiation or structural organization of blood vessels; neovascularization or angiogenesis; neovascularization or angiogenesis and comprising hemangiomas, solid tumors, leukemia, metastasis, telangiectasia psoriasis scleroderma, pyogenic granuloma, myocardial angiogenesis, plaque neovascularization, coronary collaterals, ischemic limb angiogenesis, corneal diseases, rubeosis, neovascular glaucoma, diabetic retinopathy, retrolental fibroplasia, arthritis, diabetic neovascularization, macular degeneration, wound healing, peptic ulcer, fractures, keloids, vasculogenesis, hematopoiesis, ovulation, menstruation or placentation;
(o) the method comprises identifying a compound therapeutic for: an infectious disease or for a disease or condition caused or exacerbated by a microorganism; or, an acute or chronic infectious disease; or
(p) the method comprises identifying an anti-bacterial, anti-fungal, anti-protozoan, anti-yeast or an anti-viral agent.

8-11. (canceled)

12. The method of claim 1, further comprising
(a) a selectivity assay; or
(b) reiterating the method by returning to step a) and preceding to subsequent steps in the event of failure of the compound in any of steps b) to d).

13. (canceled)

14. A method to identify a compound as a candidate therapeutic for treatment of a condition modulated by a target gene, which method comprises the steps of:
a) providing a library of compounds designed to bind to a nucleotide sequence in the coding region of said gene;
b) screening said library to obtain a first subset of compounds verified to bind to said nucleotide sequence;
c) assessing the ability of each member of said second subset to bind with sufficient affinity to said nucleotide sequence to obtain a third subset;
d) assessing the members of the third subset for their ability to block transcription sufficiently; to obtain to obtain a fourth subset; and
e) assessing the specificity of each member of said fourth subset to select a candidate therapeutic that is selective.

15. The method of claim 14, further comprising
(a) assessing the cytotoxicity of said library to obtain a subset that are cytotoxic;
(b) the method of (a), wherein the cytotoxicity is determined by an in vitro assay on a cancer cell line; or
(c) confirming acceptability of the candidate compound using in vitro and in vivo models; or
(d) reiterating the method by returning to step a) and preceding to subsequent steps in the event of failure of the compound in any of steps b) to e).

16-17. (canceled)

18. The method of claim 14, wherein
(a) step a) comprises employing a combination of heuristics, molecular modeling, and/or virtual screening to design said library;
(b) step b) is performed using a method comprising an intercalator displacement/exclusion assay;
(c) step c) or step d) is performed using a method footprinting and/or automated analysis;
(d) the method comprises identifying a compound therapeutic for breast cancer, and optionally the target gene comprises BRCA and/or Her-2/neu;
(e) the method comprises identifying a compound therapeutic for Burkitt's Lymphoma, and optionally the target gene comprises Myc;
(f) the method comprises identifying a compound therapeutic for prostate cancer, and optionally the target gene comprises c-Myc;
(g) the method comprises identifying a compound therapeutic for colon cancer, and optionally the target gene comprises MSH;
(h) the method comprises identifying a compound therapeutic for lung cancer, and optionally the target gene comprises EGFR (ErbB-1), Her 2/neu (ErbB-2); Her 3 (ErbB-3) and/or Her 4 (ErbB-4);
(i) the method comprises identifying a compound therapeutic for Chronic Myeloid Leukemia (CML), and optionally the target gene comprises BCR-ABL;
(j) the method comprises identifying a compound therapeutic for malignant melanoma, and optionally the target gene comprises CDKN2 and/or BCL-2;
(k) the target gene comprises PKA, VEGFR, VEGFR2, PDGF and/or PGGFR;
(l) the method comprises identifying a compound therapeutic for a disease or condition mediated by: cellular proliferation; cellular proliferation comprising inflammation; cellular proliferation comprising atherosclerosis; cellular proliferation comprising neovascularization or angiogenesis, or the migration, differentiation or structural organization of blood vessels; neovascularization or angiogenesis; neovascularization or angiogenesis and comprising hemangiomas, solid tumors, leukemia, metastasis, telangiectasia psoriasis scleroderma, pyogenic granuloma, myocardial angiogenesis, plaque neovascularization, coronary collaterals, ischemic limb angiogenesis, corneal diseases, rubeosis, neovascular glaucoma, diabetic retinopathy, retrolental fibroplasia, arthritis, diabetic neovascularization, macular degeneration, wound healing, peptic ulcer, fractures, keloids, vasculogenesis, hematopoiesis, ovulation, menstruation or placentation;
(m) the method comprises identifying a compound therapeutic for: an infectious disease or for a disease or condition caused or exacerbated by a microorganism; or, an acute or chronic infectious disease; or
(n) the method comprises identifying an anti-bacterial, anti-fungal, anti-protozoan, anti-yeast or an anti-viral agent.

19-21. (canceled)

22. A method to identify a compound that is a candidate therapeutic for treating a condition regulated by a gene, which method comprises the steps of:
a) providing a compound designed to bind to a nucleotide sequence in the promoter region of said target gene; and
b) confirming the ability of said compound to effect crosslinking of said promoter, whereby said candidate therapeutic is identified.

23. The method of claim 22, further comprising
(a) confirming the cytotoxicity of the compound;
(b) the method of (a), wherein the cytotoxicity is determined by an in vitro assay on a cancer cell line;
(c) confirming acceptability of the candidate compound using in vitro and/or in vivo models;
or
(d) reiterating the method by returning to step a) in the event of failure of the compound in step b).

24-25. (canceled)

26. The method of claim 22, wherein
(a) step a) comprises employing a combination of heuristics, molecular modeling, and/or virtual screening, or any combination thereof, to design said library;
(b) the method comprises identifying a compound therapeutic for breast cancer, and optionally the target gene comprises BRCA and/or Her-2/neu;
(c) the method comprises identifying a compound therapeutic for Burkitt's Lymphoma, and optionally the target gene comprises Myc;
(d) the method comprises identifying a compound therapeutic for prostate cancer, and optionally the target gene comprises c-Myc;
(e) the method comprises identifying a compound therapeutic for colon cancer, and optionally the target gene comprises MSH;
(f) the method comprises identifying a compound therapeutic for lung cancer, and optionally the target gene comprises EGFR (ErbB-1), Her 2/neu (ErbB-2); Her 3 (ErbB-3) and/or Her 4 (ErbB-4);
(g) the method comprises identifying a compound therapeutic for Chronic Myeloid Leukemia (CML), and optionally the target gene comprises BCR-ABL;
(h) the method comprises identifying a compound therapeutic for malignant melanoma, and optionally the target gene comprises CDKN2 and/or BCL-2;
(i) the target gene comprises PKA, VEGFR, VEGFR2, PDGF and/or PGGFR;
(j) the method comprises identifying a compound therapeutic for a disease or condition mediated by: cellular proliferation; cellular proliferation comprising inflammation; cellular proliferation comprising atherosclerosis; cellular proliferation comprising neovascularization or angiogenesis, or the migration, differentiation or structural organization of blood vessels; neovascularization or angiogenesis; neovascularization or angiogenesis and comprising hemangiomas, solid tumors, leukemia, metastasis, telangiectasia psoriasis scleroderma, pyogenic granuloma, myocardial angiogenesis, plaque neovascularization, coronary collaterals, ischemic limb angiogenesis, corneal diseases, rubeosis, neovascular glaucoma, diabetic retinopathy, retrolental fibroplasia, arthritis, diabetic neovascularization, macular degeneration, wound healing, peptic ulcer, fractures, keloids, vasculogenesis, hematopoiesis, ovulation, menstruation or placentation;
(k) the method comprises identifying a compound therapeutic for: an infectious disease or for a disease or condition caused or exacerbated by a microorganism; or, an acute or chronic infectious disease; or
(l) the method comprises identifying an anti-bacterial, anti-fungal, anti-protozoan, anti-yeast or an anti-viral agent.

27. (canceled)

28. A method to identify a candidate compound as a therapeutic for treatment of a condition modulated by a target gene, which method comprises the steps of:
a) providing a compound designed to interact with a portion of the coding nucleotide sequence of said target gene,
b) verifying the ability of the compound to interact with the nucleotide sequence that encodes the target gene;
c) verifying the ability of the compound to block transcription; and
d) verifying selectivity of the compound as binding to the nucleotide sequence of the coding region.

29. The method of claim 28, further comprising
(a) verifying that the compound is cytotoxic;
(b) the method of (a), wherein the cytotoxicity is determined by an in vitro assay on a cancer cell line;
(c) returning to step a) and preceding to subsequent steps in the event of failure of the compound in any of steps b)-d);
(d) confirming acceptability of the candidate compound using in vitro and/or in vivo models.

30-32. (canceled)

33. The method of claim 28, wherein
(a) step a) comprises employing a combination of heuristics, molecular modeling, and virtual screening to design said library;
(b) the method comprises identifying a compound therapeutic for breast cancer, and optionally the target gene comprises BRCA and/or Her-2/neu;
(c) the method comprises identifying a compound therapeutic for Burkitt's Lymphoma, and optionally the target gene comprises Myc;
(d) the method comprises identifying a compound therapeutic for prostate cancer, and optionally the target gene comprises c-Myc;
(e) the method comprises identifying a compound therapeutic for colon cancer, and optionally the target gene comprises MSH;
(f) the method comprises identifying a compound therapeutic for lung cancer, and optionally the target gene comprises EGFR (ErbB-1), Her 2/neu (ErbB-2); Her 3 (ErbB-3) and/or Her 4 (ErbB-4);
(g) the method comprises identifying a compound therapeutic for Chronic Myeloid Leukemia (CML), and optionally the target gene comprises BCR-ABL;
(h) the method comprises identifying a compound therapeutic for malignant melanoma, and optionally the target gene comprises CDKN2 and/or BCL-2;
(i) the target gene comprises PKA, VEGFR, VEGFR2, PDGF and/or PGGFR;
(j) the method comprises identifying a compound therapeutic for a disease or condition mediated by: cellular proliferation; cellular proliferation comprising inflammation; cellular proliferation comprising atherosclerosis; cellular proliferation comprising neovascularization or angiogenesis, or the migration, differentiation or structural organization of blood vessels; neovascularization or angiogenesis; neovascularization or angiogenesis and comprising hemangiomas, solid tumors, leukemia, metastasis, telangiectasia psoriasis scleroderma, pyogenic granuloma, myocardial angiogenesis, plaque neovascularization, coronary collaterals, ischemic limb angiogenesis, corneal diseases, rubeosis, neovascular glaucoma, diabetic retinopathy, retrolental fibroplasia, arthritis, diabetic neovascularization, macular degeneration, wound healing, peptic ulcer, fractures, keloids, vasculogenesis, hematopoiesis, ovulation, menstruation or placentation;
(k) the method comprises identifying a compound therapeutic for: an infectious disease or for a disease or condition caused or exacerbated by a microorganism; or, an acute or chronic infectious disease; or
(l) the method comprises identifying an anti-bacterial, anti-fungal, anti-protozoan, anti-yeast or an anti-viral agent.

34. A method to identify a candidate compound as a therapeutic for treatment of a condition modulated by a target gene, which method comprises steps as set forth in FIG. 1, FIG. 2 or FIG. 11, or any combination thereof.

35-50. (canceled)

51. A method for identifying a small molecule compound to up-regulate or down-regulate a target gene for a therapeutic effect, the method comprising the steps of:
(a) selecting a target gene to be up-regulated or down-regulated for a therapeutic effect, and identifying a primary target sequence and a secondary target sequence,
wherein the primary target sequence and/or secondary target sequence comprises (i) a transcriptional regulatory nucleotide sequence of the gene, or (ii) a protein-coding sequence of the gene;
(b) providing a library of small molecule compounds;
(c) screening the library for members that interact with the primary target sequence by measuring up-regulation or down-regulation of a transcript (message, mRNA) of the gene by quantitative PCR (QPCR) to obtain a first subset of sequence-interacting small molecule compounds;
(d) assessing the cytotoxic effect of the up-regulation or down-regulation of the transcript on a cell expressing the gene by members of the first subset of sequence-interacting small molecule compounds identified in (c) to identify a second subset of sequence-interacting small molecule compounds; and
(e) screening the second subset of sequence-interacting small molecule compounds identified in (d) to identify a third subset of sequence-interacting small molecule compounds that up-regulates or down-regulates the transcript (message, mRNA) of the gene, wherein the up-regulation or down-regulation of the transcript is determined by quantitative polymerase chain reaction (PCR) (QPCR) targeting the secondary target sequence.

52. The method of claim 51, wherein
(a) the method further comprises screening for members of the third subset of sequence-interacting small molecule compounds that bind to the transcriptional regulatory nucleotide sequence of the gene or the protein-coding sequence of the gene to identify a fourth subset of sequence-interacting small molecule compounds, wherein the binding is determined by a footprinting (DNase protection) assay, a gel shift assay or a combination thereof;
(b) the method further comprises screening for members of the fourth subset of sequence-interacting small molecule compounds by determining the level of expression of a protein encoded by the gene;
(c) the binding is determined by an antibody-based assay;
(d) the binding is determined by an antibody-based assay comprising an ELISA, an immunoblot, an immunoprecipitation or a Western blotting assay;
(e) in step (b) the library of small molecule compounds is designed to interact with the transcriptional regulatory nucleotide sequence and/or the protein-coding sequence of the gene;
(f) designing the library of compounds of step (b) comprises employing heuristics, molecular modeling, virtual (in silico) screening or a combination thereof; or
(g) the primary target sequence and/or secondary target sequence is between about 6 to 16 contiguous base pairs of the gene, or is about 5, 6, 7, 8, 9, 10, 11, 12, 13, 14, 15, 16, 17, 18, 19, or 20 or more contiguous base pairs of the gene.

53-58. (canceled)

59. A method for identifying a small molecule compound to up-regulate or down-regulate a target gene for a therapeutic effect, the method comprising the steps of:
(a) selecting a target gene to be up-regulated or down-regulated for a therapeutic effect, and identifying at least one target sequence in the gene;
(b) providing a library of small molecule compounds;
(c) screening the library for members that interact with the at least one target sequence to obtain a first subset of gene sequence-interacting small molecule compounds;
(d) assessing the cytotoxic effect on a cell expressing the gene by members of the first subset of gene sequence-interacting small molecule compounds identified in (c) to identify a second subset of gene sequence-interacting small molecule compounds; and
(e) screening the second subset of gene sequence-interacting small molecule compounds identified in (d) to identify a third subset of gene sequence-interacting small molecule compounds that interact with at least one target sequence in the gene using a footprinting assay, a gel shift assay, a ChiP (Chromatin Immunoprecipitation) assay, or any combination thereof.

60. The method of claim 59, wherein
(a) the screening of step (c) is performed using an intercalator displacement/exclusion assay;
(b) the at least one target sequence is between about 6 to 16, or between about 6 to 18, contiguous base pairs of the gene, or is about 5, 6, 7, 8, 9, 10, 11, 12, 13, 14, 15, 16, 17, 18, 19, or 20 or more contiguous base pairs of the gene;
(c) the at least one target sequence comprises (i) a transcriptional regulatory nucleotide sequence of the gene; (ii) a protein-coding sequence of the gene; or (iii) a combination thereof;
(d) the screening of step (e) comprises a footprinting assay to identify the third subset of sequence-interacting small molecule compounds, followed by a gel shift assay to identify a fourth subset of sequence-interacting small molecule compounds;
(e) the method further comprises screening the fourth subset of sequence-interacting small molecule compounds using a ChiP (Chromatin Immunoprecipitation) assay to identify a fifth subset of sequence-interacting small molecule compounds;
(f) the method further comprises using an in vitro transcription assay to identify a further subset of gene sequence-interacting small molecule compounds, wherein an increase or a decrease in the levels of transcript (message, mRNA) encoded by the gene confirms a member of the library to be a gene sequence-interacting small molecule compound;
(g) the method of (f), wherein the in vitro transcription assay assesses a subset of gene sequence-interacting small molecule compounds identified by a footprinting assay;
(h) the method of (f), wherein the method further comprises using a quantitative polymerase chain reaction (PCR) (QPCR) after the in vitro transcription assay to identify a further subset of gene sequence-interacting small molecule compounds, wherein an increase or a decrease in the levels of transcript (message, mRNA) encoded by the gene confirms a member of the library to be a gene sequence-interacting small molecule compound;
(i) the method of (h), wherein the method further comprises using a reporter assay to identify a further subset of gene sequence-interacting small molecule compounds;
(j) in step (b) the library of small molecule compounds is designed to interact with a transcriptional regulatory nucleotide sequence and/or a protein-coding sequence of the gene; or
(k) the method of (j), wherein designing the library of compounds of step (b) comprises employing heuristics, molecular modeling, virtual (in silico) screening or a combination thereof.

61-70. (canceled)

71. A method to identify a compound to up-regulate or down-regulate a target gene for a therapeutic effect, which method comprises steps as set forth in
(a) FIG. 1, FIG. 2 or FIG. 11, or any combination or subset thereof;
(b) the method of (a), wherein compound comprises a small molecule compound, a protein or an oligonucleotide;
(c) the method of (b), wherein the oligonucleotide comprises a single or double stranded oligonucleotide, or at least one synthetic nucleotide.

72-73. (canceled)
